(19) United States
(12) Patent Application Publication
(10) Pub. No.: US 2007/0135490 A1
(43) Pub. Date: Jun. 14, 2007

(54) Phenetanolamine derivatives

(76) Inventor: Keith Biggadike, Stevenage, Hertfordshire (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/595,444

(22) PCT Filed: Oct. 21, 2004
(86) PCT No.: PCT/EP04/11963

§ 371 Date: Feb. 23, 2007

(30) Foreign Application Priority Data
Oct. 24, 2003 (GB) 0324886.1

(51) Int. Cl. A01N 43/40

(52) U.S. Cl. 514/336

(57) ABSTRACT

Compounds of formula (I): 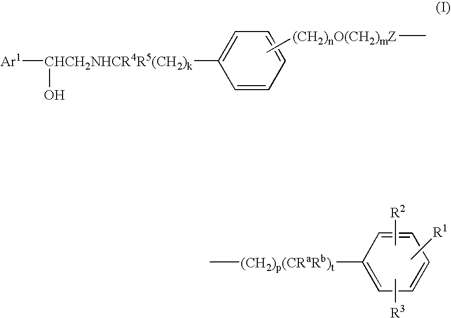
and salts, solvates, and physiologically functional derivatives thereof, useful for the prophylaxis or treatment of a clinical condition for which a selective β₂-adrenoreceptor agonist is indicated, for example asthma or chronic obstructive pulmonary disease (COPD).

The present invention is concerned with phenethanolamine derivatives, processes for their preparation, compositions containing them and their use in medicine, particularly in the prophylaxis and treatment of respiratory diseases.

Certain phenethanolamine compounds are known in the art as having selective stimulant action at β₂-adrenoreceptors and therefore having utility in the treatment of bronchial asthma and related disorders. Thus GB 2 140 800 describes phenethanolamine compounds including 4-hydroxy-α¹-[[[6-(4-phenylbutoxy)hexyl]amino]methyl]-1,3-benzenedimethanol 1-hydroxy-2-naphthalenecarboxylate (salmeterol xinafoate) which is now used clinically in the treatment of such medical conditions.

Although salmeterol and the other commercially available β₂-adrenoreceptor agonists are effective bronchodilators, the duration of action is approximately 12 hours, hence twice daily dosing is often required. There is therefore a clinical need for compounds having potent and selective stimulant action at β₂-adrenoreceptors and having an advantageous profile of action.

According to the present invention, there is provided a compound of formula (I): 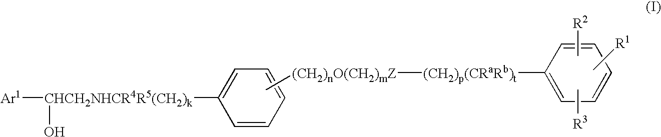
or a salt, solvate, or physiologically functional derivative thereof, wherein:

R¹ is selected from hydrogen, C₁₋₆alkyl, hydroxy, cyano, nitro, halo, C₁₋₆haloalkyl, XCO₂R⁸, —XC(O)NR⁷R⁸, —XNR⁶C(O)R⁷, —XNR⁸C(O)NR⁷R⁸, —XNR⁶C(O)NC(O)NR⁷R⁸, —XNR⁶SO₂R⁷, —XSO₂NR⁹R¹⁰, XSR⁶, XSOR⁶, XSO₂R⁶, —XNR⁷R⁸, —XNR⁶C(O)OR⁷,

or R¹ is selected from -X-aryl, -X-hetaryl, or -X-(aryloxy), each optionally substituted by 1 or 2 groups independently selected from hydroxy, C₁₋₆alkoxy, halo, C₁₋₆alkyl, C₁₋₆haloalkyl, —NR⁶C(O)R⁷, SR⁶, SOR⁶, —SO₂R⁶, —SO₂NR⁹R¹⁰, —CO₂R₃, —NR⁷R⁸, or hetaryl optionally substituted by 1 or 2 groups independently selected from hydroxy, C₁₋₆alkoxy, halo, C₁₋₆alkyl, or C₁₋₆haloalkyl;

X is —(CH₂)_{q}— or C₂₋₆alkenylene;

q is an integer from 0 to 6, preferably 0 to 4;

R⁶ and R⁷ are independently selected from hydrogen, C₁₋₆alkyl, C₃₋₇cycloalkyl, aryl, hetaryl, hetaryl(C₁₋₆alkyl)- and aryl(C₁₋₆alkyl)- and R⁶ and R⁷ are each independently optionally substituted by 1 or 2 groups independently selected from halo, C₁₋₆alkyl, C₃₋₇cycloalkyl, C₁₋₆ alkoxy, C₁₋₆haloalkyl, —NHC(O)(C₁₋₆alkyl), —SO₂(C₁₋₆alkyl), —SO₂(aryl), —CO₂H, and —CO₂(C₁₋₄alkyl), —NH₂, —NH(C₁₋₆alkyl), aryl(C₁₋₆alkyl)-, aryl(C₂₋₆alkenyl)-, aryl(C₂₋₆alkynyl)-, hetaryl(C₁₋₆alkyl)-, —NHSO₂aryl, —NH(hetarylC₁₋₆alkyl), —NHSO₂hetaryl, —NHSO₂(C₁₋₆alkyl), —NHC(O)aryl, or —NHC(O)hetaryl:

R⁸ is selected from hydrogen, C₁₋₆alkyl and C₃₋₇cycloalkyl;

or R⁷ and R⁸, together with the nitrogen atom to which they are bonded, form a 5-, 6- or 7-membered nitrogen-containing ring;

R⁹ and R¹⁰ are independently selected from hydrogen, C₁₋₆alkyl, C₃₋₇cycloalkyl, aryl, hetaryl, hetaryl(C₁₋₆alkyl)- and aryl(C₁₋₆alkyl)-, or R⁹ and R¹⁰, together with the nitrogen to which they are bonded, form a 5-, 6-, or 7-membered nitrogen containing ring; and R⁹ and R¹⁰ are each optionally substituted by one or two groups independently selected from halo, C₁₋₆alkyl, and C₃₋₇cycloalkyl, C₁₋₆haloalkyl;

R² is selected from hydrogen, hydroxy, C₁₋₆alkyl, C₁₋₆alkoxy, halo, aryl, aryl(C₁₋₆alkyl)-, C₁₋₆haloalkoxy, and C₁₋₆haloalkyl;

R³ is selected from hydrogen, hydroxy, C₁₋₆alkyl, C₁₋₆alkoxy, halo, aryl, aryl(C₁₋₆alkyl)-, C₁₋₆haloalkoxy, and C₁₋₆haloalkyl; and

R⁴ and R⁵ are independently selected from hydrogen and C₁₋₄ alkyl with the proviso that the total number of carbon atoms in R⁴ and R⁵ is not more than 4;

R^{a} and R^{b} each independently represent hydrogen or C₁₋₄alkyl;

Ar¹ is a group selected from

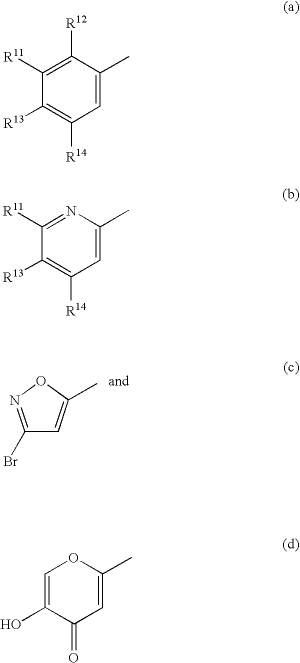

wherein R¹¹ represents hydrogen, halogen, —(CH₂)ᵣOR¹⁵, —NR¹⁵C(O)R¹⁶, —NR¹⁵SO₂R¹⁶, —SO₂NR¹⁵R¹⁶, —NR¹⁵R¹⁶, —OC(O)R¹⁷ or OC(O)NR¹⁵R¹⁶,

and R¹² represents hydrogen, halogen or C₁₋₄ alkyl;

or R¹¹ represents —NHR¹⁸ and R¹² and —NHR¹⁸ together form a 5- or 6-membered heterocyclic ring;

R¹³ represents hydrogen, halogen, —OR¹⁵ or —NR¹⁵R¹⁶;

R¹⁴ represents hydrogen, halogen, haloC₁₋₄ alkyl, —OR¹⁵, —NR¹⁵R¹⁶, —OC(O)R¹⁷ or OC(O)NR¹⁵R¹⁶;

R¹⁵ and R¹⁶ each independently represents hydrogen or C₁₋₄ alkyl, or in the groups —NR¹⁵R¹⁶, —SO₂NR¹⁵R¹⁶ and —OC(O)NR¹⁵R¹⁶, R¹⁵ and R¹⁶ independently represent hydrogen or C₁₋₄ alkyl or together with the nitrogen atom to which they are attached form a 5-, 6- or 7-membered nitrogen-containing ring,

R¹⁷ represents an aryl (eg phenyl or naphthyl) group which may be unsubstituted or substituted by one or more substituents selected from halogen, C₁₋₄ alkyl, hydroxy, C₁₋₄ alkoxy or halo C₁₋₄ alkyl; and

r is zero or an integer from 1 to 4;

Z is O, CH₂— or a single bond;

n is an integer of from 1 to 4;

m is zero or an integer of from 1 to 4;

p is zero or an integer of from 1 to 3, suitably zero;

k is an integer from 1 to 3; and

t is zero or 1.

In the compounds of formula (I), the group R¹ is suitably selected from hydrogen, C₁₋₄alkyl, hydroxy, halo, —NR⁶C(O)NR⁷R⁸, —NR⁶C(O)R⁷, —SO₂NR⁹R¹⁰, —SOR⁶, —SO₂R⁶, and —NR⁶SO₂R⁷ wherein R⁶ and R⁷ are as defined above, suitably wherein R⁶ is hydrogen and R⁷ is selected from hydrogen, C₁₋₆alkyl, C₃₋₆cycloalkyl, and aryl and is optionally substituted as described above, and R⁹ and R¹⁰ are as defined above, suitably wherein R⁹ and R¹⁰ are each independently selected from hydrogen and C₁₋₆alkyl.

Where R¹ is —XNR⁶C(O)NR⁷R⁸, R⁶ and R⁷ may, together with the —NC(O)N— portion of the group R¹ to which they are bonded, form a saturated or unsaturated ring, preferably a 5-, 6-, or 7-membered ring, for example an imidazolidine ring, such as imidazolidine-2,4-dione.

Where R¹ is —XNR⁶C(O)OR⁷, R⁶ and R⁷ may, together with the —NC(O)O— portion of the group R¹ to which they are bonded, form a saturated or unsaturated ring, preferably a 5-, 6-, or 7-membered ring, for example an oxazolidine ring, such as oxazolidine-2,4-dione.

Where R¹ is —XC(O)NR⁷R⁸ or —XNR⁶C(O)NR⁷R⁸, R⁷ and R⁸ may, together with the nitrogen to which they are bonded, form a 5-, 6-, or 7-membered nitrogen containing ring.

In the compounds of formula (I) wherein the group R¹ further contains one or more of R⁶, R⁷, R⁸, R⁹ and R¹⁰, R⁶ is suitably selected from hydrogen, C₁₋₄alkyl and C₃₋₇cycloalkyl; R⁷, R⁸, R⁹ and R¹⁰ are each suitably independently selected from hydrogen and C₁₋₄alkyl, especially hydrogen.

In the compounds of formula (I) R² and R³ are suitably independently selected from hydrogen, hydroxyl, halogen (eg. fluorine or chlorine), haloC₁₋₆-alkyl (eg. CF₃), C₁₋₆alkyl (eg. methyl), C₁₋₆alkoxy (e.g. CH₃) and haloC₁₋₆alkoxy, e.g. OCF₃.

In the compounds of formulae (I) the group R¹ is suitably attached to the para- or meta-position, in particular to the meta-position relative to the —CR^{a}R^{b}— moiety. The groups R² and R³ are suitably each independently attached to the ortho- or meta-position, in particular to the ortho position relative to the —CR^{a}R^{b}— moiety.

In one embodiment R¹ represents a substituent as defined above, other than hydrogen, attached to the meta-position relative to the —CR^{a}R^{b}— moiety, and R² and R³ each represent hydrogen.

In another embodiment R¹ represents hydrogen and R² and R³ each represent a substituent as defined above, at least one of which is other than hydrogen, and R² and R³ are each independently attached to the ortho- or meta-positions relative to the —CR^{a}R^{b}— moiety. In a particular embodiment, R² and R³ each represent halogen attached at the ortho positions. In another particular embodiment R² and R³ each represent methyl attached at the meta positions.

In the compounds of formula (I), R⁴ and R⁵ are suitably independently selected from hydrogen and methyl.

Suitably the moiety 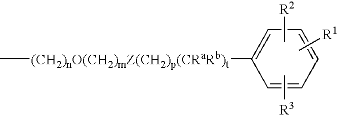
is attached to the meta position of the ‘central’ phenyl ring, relative to the —NHCR⁴R⁵CH₂— moiety.

In the compounds of formula (I) the group Ar¹ is suitably selected from groups (a) and (b) above. In said groups (a) and (b), when R¹¹ represents halogen this is suitably chlorine or fluorine. R¹⁵ and R¹⁶ suitably each independently represent hydrogen or methyl. R¹⁷ suitably represents substituted phenyl. The integer r suitably represents zero or 1. Thus for example —(CH₂)ᵣOR¹⁵ suitably represents OH or —CH₂OH; NR¹⁵C(O)R¹⁶ suitably represents —NHC(O)H; —SO₂NR¹⁵R¹⁶ suitably represents —SO₂NH₂ or SO₂NHCH₃; NR¹⁵R¹⁶ suitably represents —NH₂; —OC(O)R¹⁷ suitably represents substituted benzoyloxy eg. OC(O)—C₆H₄-(p-CH₃); and —OC(O)N R¹⁵R¹⁶ suitably represents OC(O)N(CH₃)₂.

When R¹¹ represents NHR¹⁸ and together with R¹² forms a 5- or 6-membered heterocyclic ring —NHR¹⁸—R¹²— suitably represents a group: —NH—CO—R¹⁹— where R¹⁹ is an alkyl, alkenyl or alkyloxy group; —NH—SO₂R²⁰— where R²⁰ is an alkyloxy group; —NH—R²¹— where R²¹ is an alkyl or alkenyl group optionally substituted by COOR²² where R²² is C₁₋₄ alkyl; or —NH—CO—S—;

wherein said alkyl, and alkenyl groups and moieties contain 1 or 2 carbon atoms.

Preferred groups (a) and (b) may be selected from the following groups (i) to (xxi): 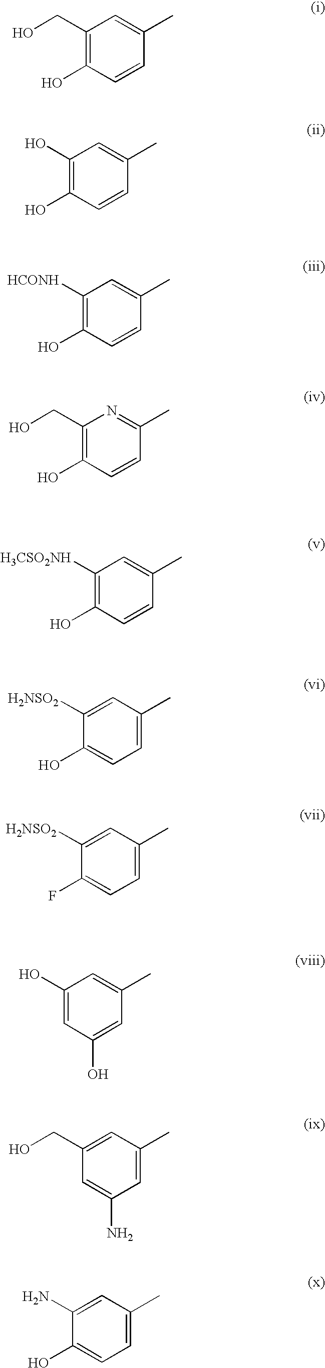 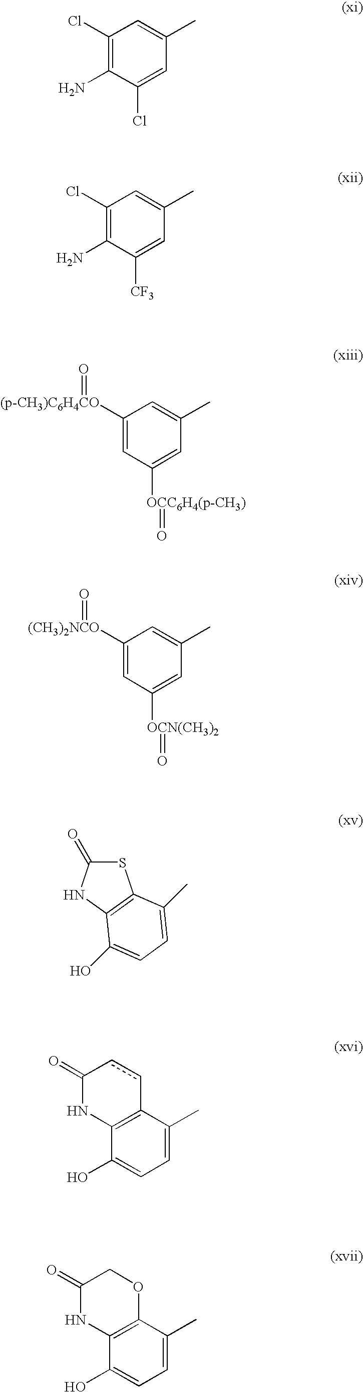 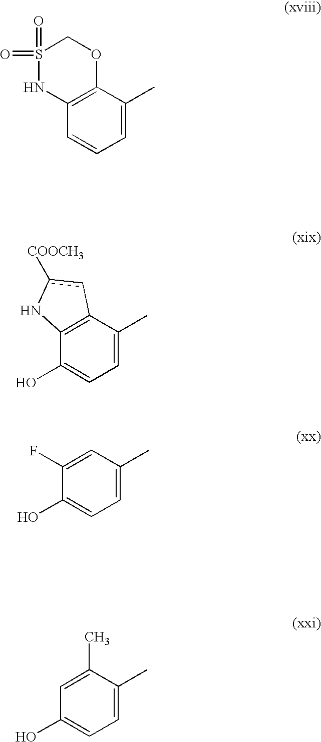
wherein the dotted line in (xvi) and (xix) denotes an optional double bond.

Most suitably Ar¹ represents a group (i).

In compounds of formula (I) when Z represents —CH₂— or a bond, —(CH₂)ₘZ(CH₂)ₚ— suitably represents an alkylene chain having from 1 to 4 carbon atoms.

According to a particular embodiment of the present invention, there is provided a compound of formula (Ia): 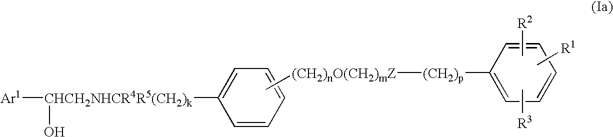
or a salt, solvate, or physiologically functional derivative thereof, wherein:

n is an integer of from 1 to 4;

m is an integer of from 2 to 4;

p is an integer of from 1 to 4, suitably 1;

k is an integer from 1 to 3;

Z is O, or CH₂—,

and Ar¹, R¹, R², R³, R⁴ and R⁵ are as defined for formula (I).

It is to be understood that references to formula (I) herein include formula (Ia) unless otherwise specified, or dictated by the context.

It is to be understood that the present invention covers all combinations of particular and preferred groups described hereinabove.

Particular compounds according to the invention include:
4-((1R)-2-{[2-(3-{[2-(Benzyloxy)ethoxy]methyl}phenyl)ethyl]amino}-1-hydroxyethyl)-2-(hydroxymethyl)phenol;
4-{(1R)-2-[(2-{3-[(Benzyloxy)methyl]phenyl}ethyl)amino]-1-hydroxyethyl}-2-(hydroxymethyl)phenol;
2-(Hydroxymethyl)-4-{(1R)-1-hydroxy-2-[(2-{3-[(3-phenylpropoxy)methy]phenyl}ethyl)amino]ethyl}phenol;
2-(Hydroxymethyl)-4-{(1R)-1-hydroxy-2-[(2-{3-[(4-phenylbutoxy)methyl]phenyl}ethyl)amino]ethyl}phenol;
4-((1R)-2-{[2-(3-{[3-(Benzyloxy)propoxy]methyl}phenyl)ethyl]amino}-1-hydroxyethyl)-2-(hydroxymethyl)phenol;
4-((1R)-2-{[2-(4-{[2-(Benzyloxy)ethoxy]methyl}phenyl)ethyl]amino}-1-hydroxyethyl)-2-(hydroxymethyl)phenol;
2-(Hydroxymethyl)-4-{(1R)-1-hydroxy-2-[(2-{3-[(2-phenylethoxy)methyl]phenyl}ethyl)amino]ethyl}phenol;
4-((1R)-2-{[2-(3-{[(2,6-Dichlorobenzyl)oxy]methyl}phenyl)ethyl]amino}-1-hydroxyethyl)-2-(hydroxymethyl)phenol;
4-((1R)-1-Hydroxy-2-{[2-(3-{[2-(2-methoxyphenyl)ethoxy]methyl}phenyl)ethyl]amino}ethyl)-2-(hydroxymethyl)phenol;
4-((1R)-1-Hydroxy-2-{[2-(3-{[2-(3-methoxyphenyl)ethoxy]methyl}phenyl)ethyl]amino}ethyl)-2-(hydroxymethyl)phenol;
4-((1R)-1-Hydroxy-2-{[2-(3-{[2-(4-methoxyphenyl)ethoxy]methyl}phenyl)ethyl]amino}ethyl)-2-(hydroxymethyl)phenol;
3-[4-({3-[2-({(2R)-2-Hydroxy-2-[4-hydroxy-3-(hydroxymethyl)phenyl]ethyl}amino)ethyl]benzyl}oxy)butyl]benzenesulfonamide;
3-{[2-({3-[2-({(2R)-2-hydroxy-2-[4-hydroxy-3-(hydroxymethyl)phenyl]ethyl}amino)ethyl]benzyl}oxy)ethoxy]methyl}benzonitrile;
4-[(1R)-2-({2-[3-({2-[(2,6-dichlorobenzyl)oxy]ethoxy}methyl)phenyl]ethyl}amino)-1-hydroxyethyl]-2-(hydroxymethyl)phenol;
4-[(1R)-2-({2-[3-({2-[(3-fluorobenzyl)oxy]ethoxy}methyl)phenyl]ethyl}amino)-1-hydroxyethyl]-2-(hydroxymethyl)phenol;
4-[(1R)-2-({2-[3-({2-[(3,5-dimethylbenzyl)oxy]ethoxy}methyl)phenyl]ethyl}amino)-1-hydroxyethyl]-2-(hydroxymethyl)phenol;
4-[(1R)-1-hydroxy-2-({2-[3-({2-[(3-methoxybenzyl)oxy]ethoxy}methyl)phenyl]ethyl}amino)ethyl]-2-(hydroxymethyl)phenol;
2-(hydroxymethyl)-4-{(1R)-1-hydroxy-2-[(2-{3-[(2-{[3-(trifluoromethoxy)benzyl]oxy}ethoxy)methyl]phenyl}ethyl)amino]ethyl}phenol;
4-((1R)-1-hydroxy-2-{[2-(3-{[4-(3-hydroxyphenyl)butoxy]methyl}phenyl)ethyl]amino}ethyl)-2-(hydroxymethyl)phenol;
4-[3-({3-[2-({(2R)-2-hydroxy-2-[4-hydroxy-3-(hydroxymethyl)phenyl]ethyl}amino)ethyl]benzyl}oxy)propyl]benzonitrile;
4-[4-({3-[2-({(2R)-2-hydroxy-2-[4-hydroxy-3-(hydroxymethyl)phenyl]ethyl}amino)ethyl]benzyl}oxy)butyl]benzonitrile;
3-[3-({3-[2-({(2R)-2-hydroxy-2-[4-hydroxy-3-(hydroxymethyl)phenyl]ethyl}amino)ethyl]benzyl}oxy)propyl]benzonitrile;
2-(hydroxymethyl)4-[(1R)-1-hydroxy-2-({2-[3-({3-[4-(methylsulfonyl)phenyl]propoxy}methyl)phenyl]ethyl}amino)ethyl]phenol;
2-(hydroxymethyl)-4-[(1R)-1-hydroxy-2-({2-[3-({[4-(methylsulfonyl)benzyl]oxy}methyl)phenyl]ethyl}amino)ethyl]phenol;
4-((1R)-1-hydroxy-2-{[2-(3-{[2-(2-hydroxyphenyl)ethoxy]methyl}phenyl)ethyl]amino}ethyl)-2-(hydroxymethyl)phenol;
4-((1R)-1-hydroxy-2-{[2-(3-{[(4-hydroxybenzyl)oxy]methyl}phenyl)ethyl]amino}ethyl)-2-(hydroxymethyl)phenol;
4-((1R)-1-hydroxy-2-{[2-(3-{[3-(3-hydroxyphenyl)propoxy]methyl}phenyl)ethyl]amino}ethyl)-2-(hydroxymethyl)phenol;
4-[(1R)-2-({2-[3-({4-[4-(cyclopentylsulfonyl)phenyl]butoxy}methyl)phenyl]ethyl}amino)-1-hydroxyethyl]-2-(hydroxymethyl)phenol;
4-[(1R)-2-({2-[3-({3-[4-(cyclopentylsulfonyl)phenyl]propoxy}methyl)phenyl]ethyl}amino)-1-hydroxyethyl]-2-(hydroxymethyl)phenol;
4-[(1R)-2-({2-[3-({3-[3-(cyclopentylsulfonyl)phenyl]propoxy}methyl)phenyl]ethyl}amino)-1-hydroxyethyl]-2-(hydroxymethyl)phenol;
4-[(1R)-1-hydroxy-2-({2-[3-({2-[(3-hydroxybenzyl)oxy]ethoxy}methyl)phenyl]ethyl}amino)ethyl]-2-(hydroxymethyl)phenol;
4-{(1R)-2-[(2-{3-[(2-{[3-(cyclopentylsulfonyl)benzyl]oxy}ethoxy)methyl]phenyl}ethyl)amino]-1-hydroxyethyl}-2-(hydroxymethyl)phenol;
4-{(1R)-2-[(2-{3-[(2-{[3-(cyclopentylsulfinyl)benzyl]oxy}ethoxy)methyl]phenyl}ethyl)amino]-1-hydroxyethyl}-2-(hydroxymethyl)phenol;
4-[(1R)-2-({2-[3-({[3-(cyclopentylsulfonyl)benzyl]oxy}methyl)phenyl]ethyl}amino)-1-hydroxyethyl]-2-(hydroxymethyl)phenol;
4-[(1R)-2-({2-[3-({4-[3-(cyclopentylsulfinyl)phenyl]butoxy}methyl)phenyl]ethyl}amino)-1-hydroxyethyl]-2-(hydroxymethyl)phenol;
3-[4-({3-[2-({(2R)-2-hydroxy-2-[4-hydroxy-3-(hydroxymethyl)phenyl]ethyl}amino)ethyl]benzyl}oxy)butyl]benzonitrile;
2-(hydroxymethyl)-4-{(1R)-1-hydroxy-2-[(2-{3-[(2-phenoxyethoxy)methyl]phenyl}ethyl)amino]ethyl}phenol;
4-((1R)-2-{[2-(3-{[2-(3-fluorophenyl)ethoxy]methyl}phenyl)ethyl]amino}-1-hydroxyethyl)-2-(hydroxymethyl)phenol;
4-((1R)-2-{[2-(3-{[2-(4-fluorophenyl)ethoxy]methyl}phenyl)ethyl]amino}-1-hydroxyethyl)-2-(hydroxymethyl)phenol;
4-((1R)-2-{[2-(3-{[2-(2-fluorophenyl)ethoxy]methyl}phenyl)ethyl]amino}-1-hydroxyethyl)-2-(hydroxymethyl)phenol;
3-[({3-[2-({(2R)-2-hydroxy-2-[4-hydroxy-3-(hydroxymethyl)phenyl]ethyl}amino)ethyl]benzyl}oxy)methyl]benzonitrile;
4-[({3-[2-({(2R)-2-hydroxy-2-[4-hydroxy-3-(hydroxymethyl)phenyl]ethyl}amino)ethyl]benzyl}oxy)methyl]benzonitrile;
2-(hydroxymethyl)-4-[(1R)-1-hydroxy-2-({2-[3-({[(1R)-1-phenylethyl]oxy}methyl)phenyl]ethyl}amino)ethyl]phenol;
2-(hydroxymethyl)-4-[(1R)-1-hydroxy-2-({2-[3-({[(1S)-1-phenylethyl]oxy}methyl)phenyl]ethyl}amino)ethyl]phenol;
4-((1R)-2-{[2-(3-{[(3,5-dimethylbenzyl)oxy]methyl}phenyl)ethyl]amino}-1-hydroxyethyl)-2-(hydroxymethyl)phenol;
4-((1R)-2-{[2-(3-{[(2,6-dichlorobenzyl)oxy]methyl}phenyl)ethyl]amino}-1-hydroxyethyl)-2-(hydroxymethyl)phenol;
4-((1R)-2-{[2-(3-{[(2-fluorobenzyl)oxy]methyl}phenyl)ethyl]amino}-1-hydroxyethyl)-2-(hydroxymethyl)phenol;
4-((1R)-2-{[2-(3-{[(3-fluorobenzyl)oxy]methyl}phenyl)ethyl]amino}-1-hydroxyethyl)-2-(hydroxymethyl)phenol;
4-((1R)-2-{[2-(3-{[(4-fluorobenzyl)oxy]methyl}phenyl)ethyl]amino}-1-hydroxyethyl)-2-(hydroxymethyl)phenol;
3-[4-({3-[2-({(2R)-2-Hydroxy-2-[4-hydroxy-3-(hydroxymethyl)phenyl]ethyl}amino)ethyl]benzyl}oxy)butyl]benzamide;
3-{[2-({3-[2-({(2R)-2-hydroxy-2-[4-hydroxy-3-(hydroxymethyl)phenyl]ethyl}amino)ethyl]benzyl}oxy)ethoxy]methyl}benzamide;
3-[({3-[2-({(2R)-2-hydroxy-2-[4-hydroxy-3-(hydroxymethyl)phenyl]ethyl}amino)ethyl]benzyl}oxy)methyl]benzamide;
4-[({3-[2-({(2R)-2-hydroxy-2-[4-hydroxy-3-(hydroxymethyl)phenyl]ethyl}amino)ethyl]benzyl}oxy)methyl]benzamide;
3-[2-({3-[2-({(2R)-2-hydroxy-2-[4-hydroxy-3-(hydroxymethyl)phenyl]ethyl}amino)ethyl]benzyl}oxy)ethyl]benzenesulfonamide;
3-[3-({3-[2-({(2R)-2-hydroxy-2-[4-hydroxy-3-(hydroxymethyl)phenyl]ethyl}amino)ethyl]benzyl}oxy)propyl]benzenesulfonamide;
4-((1R)-2-{[2-(3-{[4-(2,6-dichlorophenyl)butoxy]methyl}phenyl)ethyl]amino}-1-hydroxyethyl)-2-(hydroxymethyl)phenol;
N-{3-[4-({3-[2-({(2R)-2-hydroxy-2-[4-hydroxy-3-(hydroxymethyl)phenyl]ethyl}amino)ethyl]benzyl}oxy)butyl]phenyl}urea;
2-(hydroxymethyl)4-((1R)-1-hydroxy-2-{[2-(3-{[2-(1-phenylethoxy)ethoxy]methyl}phenyl)ethyl]amino}ethyl)phenol;
4-[(1R)-2-({2-[3-({2-[3-(cyclopentylsulfonyl)phenyl]ethoxy}methyl)phenyl]ethyl}amino)-1-hydroxyethyl]-2-(hydroxymethyl)phenol;
4-[(1R)-2-({2-[3-({4-[3-(cyclopentylsulfonyl)phenyl]butoxy}methyl)phenyl]ethyl}amino)-1-hydroxyethyl]-2-(hydroxymethyl)phenol;
2-(hydroxymethyl)-4-[(1R)-1-hydroxy-2-({2-[3-({4-[3-(methylsulfonyl)phenyl]butoxy}methyl)phenyl]ethyl}amino)ethyl]phenol;
4-((1R)-2-{[2-(3-{[3-(2,6-dichlorophenyl) propoxy]methyl}phenyl)ethyl]amino}-1-hydroxyethyl)-2-(hydroxymethyl)phenol;
3-[({3-[2-({(2R)-2-Hydroxy-2-[4-hydroxy-3-(hydroxymethyl)phenyl]ethyl}amino)ethyl]benzyl}oxy)methyl]benzenesulfonamide.
   and salts, solvates and physiologically functional derivatives thereof.

The compounds of formula (I) include an asymmetric centre, namely the carbon atom of the 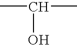
group. The present invention includes both (S) and (R) enantiomers either in substantially pure form or admixed in any proportions. Suitably, the compounds of the invention are in the form of the (R) enantiomers.

Similarly, where R⁴ and R⁵ are different groups, or where R^{a} and R^{b} are different groups the carbon atom to which they are attached is an asymmetric centre and the present invention includes both (S) and (R) enantiomers at this centre either in substantially pure form or admixed in any proportions.

Thus the compounds of formula (I) include all enantiomers and diastereoisomers as well as mixtures thereof in any proportions.

Salts and solvates of compounds of formula (I) which are suitable for use in medicine are those wherein the counterion or associated solvent is pharmaceutically acceptable. However, salts and solvates having non-pharmaceutically acceptable counterions or associated solvents are within the scope of the present invention, for example, for use as intermediates in the preparation of other compounds of formula (I) and their pharmaceutically acceptable salts, solvates, and physiologically functional derivatives.

By the term “physiologically functional derivative” is meant a chemical derivative of a compound of formula (I) having the same physiological function as the free compound of formula (I), for example, by being convertible in the body thereto. According to the present invention, examples of physiologically functional derivatives include esters.

Suitable salts according to the invention include those formed with both organic and inorganic acids or bases. Pharmaceutically acceptable acid addition salts include those formed from hydrochloric, hydrobromic, sulphuric, citric, tartaric, phosphoric, lactic, pyruvic, acetic, trifluoroacetic, triphenylacetic, sulphamic, sulphanilic, succinic, oxalic, fumaric, maleic, malic, glutamic, aspartic, oxaloacetic, methanesulphonic, ethanesulphonic, arylsulphonic (for example p-toluenesulphonic, benzenesulphonic, naphthalenesulphonic or naphthalenedisulphonic), salicylic, glutaric, gluconic, tricarballylic, cinnamic, substituted cinnamic (for example, phenyl, methyl , methoxy or halo substituted cinnamic, including 4-methyl and 4-methoxycinnamic acid), ascorbic, oleic, naphthoic, hydroxynaphthoic (for example 1- or 3-hydroxy-2-naphthoic), naphthaleneacrylic (for example naphthalene-2-acrylic), benzoic, 4-methoxybenzoic, 2- or 4-hydroxybenzoic, 4-chlorobenzoic, 4-phenylbenzoic, benzeneacrylic (for example 1,4-benzenediacrylic) and isethionic acids. Pharmaceutically acceptable base salts include ammonium salts, alkali metal salts such as those of sodium and potassium, alkaline earth metal salts such as those of calcium and magnesium and salts with organic bases such as dicyclohexyl amine and N-methyl-D-glucamine.

Pharmaceutically acceptable esters of the compounds of formula (I) may have a hydroxyl group converted to a C₁₋₆alkyl, aryl, aryl C₁₋₆alkyl, or amino acid ester.

As mentioned above, the compounds of formula (I) are selective β₂-adrenoreceptor agonists as demonstrated using functional or reporter gene readout from cell lines transfected with human beta-adrenoreceptors as described below. Certain compounds according to the present invention have demonstrated in in vitro testing a rapid onset of action combined with long duration of effect. As such, compounds of the invention may have the potential for once-daily administration.

Therefore, compounds of formula (I) and their pharmaceutically acceptable salts, solvates, and physiologically functional derivatives may be useful in the prophylaxis and treatment of clinical conditions for which a selective β₂-adrenoreceptor agonist is indicated. Such conditions include diseases associated with reversible airways obstruction such as asthma, chronic obstructive pulmonary diseases (COPD) (e.g. chronic and wheezy bronchitis, emphysema), respiratory tract infection and upper respiratory tract disease.

Other conditions which may be treated include premature labour, depression, congestive heart failure, skin diseases (e.g. inflammatory, allergic, psoriatic, and proliferative skin diseases), conditions where lowering peptic acidity is desirable (e.g. peptic and gastric ulceration) and muscle wasting disease.

Accordingly, the present invention provides a method for the prophylaxis or treatment of a clinical condition in a mammal, such as a human, for which a selective β₂-adrenoreceptor agonist is indicated, which comprises administration of a therapeutically effective amount of a compound of formula (I), or a pharmaceutically acceptable salt, solvate, or physiologically functional derivative thereof. In particular, the present invention provides such a method for the prophylaxis or treatment of a disease associated with reversible airways obstruction such as asthma, chronic obstructive pulmonary disease (COPD), respiratory tract infection or upper respiratory tract disease. In a further aspect the present invention provides such a method for the prophylaxis or treatment of a clinical condition selected from premature labour, depression, congestive heart failure, skin diseases (e.g. inflammatory, allergic, psoriatic, and proliferative skin diseases), conditions where lowering peptic acidity is desirable (e.g. peptic and gastric ulceration) or muscle wasting disease.

In the alternative, there is also provided a compound of formula (I), or a pharmaceutically acceptable salt, solvate, or physiologically functional derivative thereof for use in medical therapy, particularly, for use in the prophylaxis or treatment of a clinical condition in a mammal, such as a human, for which a selective β₂-adrenoreceptor agonist is indicated. In particular, there is provided a compound of formula (I), or a pharmaceutically acceptable salt, solvate, or physiologically functional derivative thereof for the prophylaxis or treatment of a disease associated with reversible airways obstruction such as asthma, chronic obstructive pulmonary disease (COPD), respiratory tract infection or upper respiratory tract disease. In a further aspect, there is provided a compound of formula (I), or a pharmaceutically acceptable salt, solvate, or physiologically functional derivative thereof for the prophylaxis or treatment of a clinical condition selected from premature labour, depression, congestive heart failure, skin diseases (e.g. inflammatory, allergic, psoriatic, and proliferative skin diseases), conditions where lowering peptic acidity is desirable (e.g. peptic and gastric ulceration) or muscle wasting disease.

The present invention also provides the use of a compound of formula (I), or a pharmaceutically acceptable salt, solvate, or physiologically functional derivative thereof in the manufacture of a medicament for the prophylaxis or treatment of a clinical condition for which a selective β₂-adrenoreceptor agonist is indicated, for example a disease associated with reversible airways obstruction such as asthma, chronic obstructive pulmonary disease (COPD), respiratory tract infection or upper respiratory tract disease. In a further aspect, there is provided a compound of formula (I), or a pharmaceutically acceptable salt, solvate, or physiologically functional derivative thereof in the manufacture of a medicament for the prophylaxis or treatment of a clinical condition selected from premature labour, depression, congestive heart failure, skin diseases (e.g. inflammatory, allergic, psoriatic, and proliferative skin diseases), conditions where lowering peptic acidity is desirable (e.g. peptic and gastric ulceration) and muscle wasting disease.

The amount of a compound of formula (I), or a pharmaceutically acceptable salt, solvate or physiologically functional derivative thereof which is required to achieve a therapeutic effect will, of course, vary with the particular compound, the route of administration, the subject under treatment, and the particular disorder or disease being treated. The compounds of the invention may be administered by inhalation at a dose of from 0.0005 mg to 10 mg, suitably 0.005 mg to 0.5 mg, e.g. 0.05 mg to 0.5 mg. The dose range for adult humans is generally from 0.0005 mg to 10 mg per day and suitably 0.01 mg to 1 mg per day, most suitably e.g. 0.05 mg to 0.5 mg per day.

While it is possible for the compound of formula (I), or a pharmaceutically acceptable salt, solvate, or physiologically functional derivative thereof to be administered alone, it is preferable to present it as a pharmaceutical formulation.

Accordingly, the present invention further provides a pharmaceutical formulation comprising a compound of formula (I), or a pharmaceutically acceptable salt, solvate, or physiologically functional derivative thereof, and a pharmaceutically acceptable carrier or excipient, and optionally one or more other therapeutic ingredients.

Hereinafter, the term “active ingredient” means a compound of formula (I), or a pharmaceutically acceptable salt, solvate, or physiologically functional derivative thereof.

The formulations include those suitable for oral, parenteral (including subcutaneous, intradermal, intramuscular, intravenous and intraarticular), inhalation (including fine particle dusts or mists which may be generated by means of various types of metered dose pressurised aerosols, nebulisers or insufflators), rectal and topical (including dermal, buccal, sublingual and intraocular) administration although the most suitable route may depend upon for example the condition and disorder of the recipient. The formulations may conveniently be presented in unit dosage form and may be prepared by any of the methods well known in the art of pharmacy. All methods include the step of bringing the active ingredient into association with the carrier which constitutes one or more accessory ingredients. In general the formulations are prepared by uniformly and intimately bringing into association the active ingredient with liquid carriers or finely divided solid carriers or both and then, if necessary, shaping the product into the desired formulation.

Formulations of the present invention suitable for oral administration may be presented as discrete units such as capsules, cachets or tablets each containing a predetermined amount of the active ingredient; as a powder or granules; as a solution or a suspension in an aqueous liquid or a non-aqueous liquid; or as an oil-in-water liquid emulsion or a water-in-oil liquid emulsion. The active ingredient may also be presented as a bolus, electuary or paste.

A tablet may be made by compression or moulding, optionally with one or more accessory ingredients. Compressed tablets may be prepared by compressing in a suitable machine the active ingredient in a free-flowing form such as a powder or granules, optionally mixed with a binder, lubricant, inert diluent, lubricating, surface active or dispersing agent. Moulded tablets may be made by moulding in a suitable machine a mixture of the powdered compound moistened with an inert liquid diluent. The tablets may optionally be coated or scored and may be formulated so as to provide slow or controlled release of the active ingredient therein.

Formulations for parenteral administration include aqueous and non-aqueous sterile injection solutions which may contain anti-oxidants, buffers, bacteriostats and solutes which render the formulation isotonic with the blood of the intended recipient; and aqueous and non-aqueous sterile suspensions which may include suspending agents and thickening agents. The formulations may be presented in unit-dose or multi-dose containers, for example sealed ampoules and vials, and may be stored in a freeze-dried (lyophilised) condition requiring only the addition of the sterile liquid carrier, for example saline or water-for-injection, immediately prior to use. Extemporaneous injection solutions and suspensions may be prepared from sterile powders, granules and tablets of the kind previously described.

Dry powder compositions for topical delivery to the lung by inhalation may, for example, be presented in capsules and cartridges of for example gelatine, or blisters of for example laminated aluminium foil, for use in an inhaler or insufflator. Powder blend formulations generally contain a powder mix for inhalation of the compound of the invention and a suitable powder base (carrier/diluent/excipient substance) such as mono-, di or poly-saccharides (eg. lactose or starch). Use of lactose is preferred.

Each capsule or cartridge may generally contain between 20 μg-10 mg of the compound of formula (I) or (Ia) optionally in combination with another therapeutically active ingredient. Alternatively, the compound of the invention may be presented without excipients. Packaging of the formulation may be suitable for unit dose or multi-dose delivery. In the case of multi-dose delivery, the formulation can be pre-metered (eg as in Diskus, see GB 2242134, U.S. Pat. Nos. 6,632,666, 5,860,419, 5,873,360 and 5,590,645 or Diskhaler, see GB 2178965, 2129691 and 2169265, U.S. Pat. Nos. 4,778,054, 4,811,731, 5,035,237, the disclosures of which are hereby incorporated by reference) or metered in use (eg as in Turbuhaler, see EP 69715 or in the devices described in U.S. Pat. No. 6,321,747 the disclosures of which are hereby incorporated by reference). An example of a unit-dose device is Rotahaler (see GB 2064336 and U.S. Pat. No. 4,353,656, the disclosures of which are hereby incorporated by reference). The Diskus inhalation device comprises an elongate strip formed from a base sheet having a plurality of recesses spaced along its length and a lid sheet hermetically but peelably sealed thereto to define a plurality of containers, each container having therein an inhalable formulation containing a compound of formula (I) or (Ia) suitably combined with lactose. Preferably, the strip is sufficiently flexible to be wound into a roll. The lid sheet and base sheet will preferably have leading end portions which are not sealed to one another and at least one of the said leading end portions is constructed to be attached to a winding means. Also, preferably the hermetic seal between the base and lid sheets extends over their whole width. The lid sheet may preferably be peeled from the base sheet in a longitudinal direction from a first end of the said base sheet.

Spray compositions for topical delivery to the lung by inhalation may for example be formulated as aqueous solutions or suspensions or as aerosols delivered from pressurised packs, such as a metered dose inhaler, with the use of a suitable liquefied propellant. Aerosol compositions suitable for inhalation can be either a suspension or a solution and generally contain the compound of formula (I) optionally in combination with another therapeutically active ingredient and a suitable propellant such as a fluorocarbon or hydrogen-containing chlorofluorocarbon or mixtures thereof, particularly hydrofluoroalkanes, e.g. dichlorodifluoromethane, trichlorofluoromethane, dichlorotetrafluoroethane, especially 1,1,1,2-tetrafluoroethane, 1,1,1,2,3,3,3-heptafluoro-n-propane or a mixture thereof. Carbon dioxide or other suitable gas may also be used as propellant.

The aerosol composition may be excipient free or may optionally contain additional formulation excipients well known in the art such as surfactants eg oleic acid or lecithin and cosolvents eg ethanol. Pressurised formulations will generally be retained in a canister (eg an aluminium canister) closed with a valve (eg a metering valve) and fitted into an actuator provided with a mouthpiece.

Medicaments for administration by inhalation desirably have a controlled particle size. The optimum particle size for inhalation into the bronchial system is usually 1-10 μm, preferably 2-5 μm. Particles having a size above 20 μm are generally too large when inhaled to reach the small airways. To achieve these particle sizes the particles of the active ingredient as produced may be size reduced by conventional means eg by micronisation. The desired fraction may be separated out by air classification or sieving. Preferably, the particles will be crystalline. When an excipient such as lactose is employed, generally, the particle size of the excipient will be much greater than the inhaled medicament within the present invention. When the excipient is lactose it will typically be present as milled lactose, wherein not more than 85% of lactose particles will have a MMD of 60-90 μm and not less than 15% will have a MMD of less than 15 μm.

Intranasal sprays may be formulated with aqueous or non-aqueous vehicles with the addition of agents such as thickening agents, buffer salts or acid or alkali to adjust the pH, isotonicity adjusting agents or anti-oxidants.

Solutions for inhalation by nebulation may be formulated with an aqueous vehicle with the addition of agents such as acid or alkali, buffer salts, isotonicity adjusting agents or antimicrobials. They may be sterilised by filtration or heating in an autoclave, or presented as a non-sterile product.

Formulations for rectal administration may be presented as a suppository with the usual carriers such as cocoa butter or polyethylene glycol.

Formulations for topical administration in the mouth, for example buccally or sublingually, include lozenges comprising the active ingredient in a flavoured basis such as sucrose and acacia or tragacanth, and pastilles comprising the active ingredient in a basis such as gelatin and glycerin or sucrose an acacia.

Preferred unit dosage formulations are those containing an effective dose, as hereinbefore recited, or an appropriate fraction thereof, of the active ingredient.

It should be understood that in addition to the ingredients particularly mentioned above, the formulations of this invention may include other agents conventional in the art having regard to the type of formulation in question, for example those suitable for oral administration may include flavouring agents.

The compounds and pharmaceutical formulations according to the invention may be used in combination with or include one or more other therapeutic agents, for example selected from anti-inflammatory agents, anticholinergic agents (particularly an M₁, M₂, M₁/M₂ or M₃ receptor antagonist), other β₂-adrenoreceptor agonists, antiinfective agents (e.g. antibiotics, antivirals), or antihistamines. The invention thus provides, in a further aspect, a combination comprising a compound of formula (I) or a pharmaceutically acceptable salt, solvate or physiologically functional derivative thereof together with one or more other therapeutically active agents, for example selected from an anti-inflammatory agent (for example a corticosteroid or an NSAID), an anticholinergic agent, another β₂-adrenoreceptor agonist, an antiinfective agent (e.g. an antibiotic or an antiviral), or an antihistamine. Preferred are combinations comprising a compound of formula (I) or a pharmaceutically acceptable salt, solvate or physiologically functional derivative thereof together with a corticosteroid, and/or an anticholinergic, and/or a PDE-4 inhibitor. Preferred combinations are those comprising one or two other therapeutic agents.

It will be clear to a person skilled in the art that, where appropriate, the other therapeutic ingredient(s) may be used in the form of salts, (e.g. as alkali metal or amine salts or as acid addition salts), or prodrugs, or as esters (e.g. lower alkyl esters), or as solvates (e.g. hydrates) to optimise the activity and/or stability and/or physical characteristics (e.g. solubility) of the therapeutic ingredient. It will be clear also that where appropriate, the therapeutic ingredients may be used in optically pure form.

Suitable anti-inflammatory agents include corticosteroids and NSAIDs. Suitable corticosteroids which may be used in combination with the compounds of the invention are those oral and inhaled corticosteroids and their pro-drugs which have anti-inflammatory activity. Examples include methyl prednisolone, prednisolone, dexamethasone, fluticasone propionate, 6α,9α-difluoro-17α-[(2-furanylcarbonyl)oxy]-11β-hydroxy-16α-methyl-3-oxo-androsta-1,4-diene-17β-carbothioic acid S-fluoromethyl ester, 6α,9α-difluoro-11β-hydroxy-16α-methyl-3-oxo-17α-propionyloxy-androsta-1,4-diene-17β-carbothioic acid S-(2-oxo-tetrahydro-furan-3S-yl) ester, beclomethasone esters (e.g. the 17-propionate ester or the 17,21-dipropionate ester), budesonide, flunisolide, mometasone esters (e.g. the furoate ester), triamcinolone acetonide, rofleponide, ciclesonide, butixocort propionate, RPR-106541, and ST-126. Preferred corticosteroids include fluticasone propionate, 6α,9α-difluoro-11β-hydroxy-16α-methyl-17α-[(4-methyl-1,3-thiazole-5-carbonyl)oxy]-3-oxo-androsta-1,4-diene-17β-carbothioic acid S-fluoromethyl ester and 6α,9α-difluoro-17α-[(2-furanylcarbonyl)oxy]-11β-hydroxy-16α-methyl-3-oxo-androsta-1,4-diene-17β-carbothioic acid S-fluoromethyl ester, more preferably 6α,9α-difluoro-17α-[(2-furanylcarbonyl)oxy]-11β-hydroxy-16α-methyl-3-oxoandrosta-1,4-diene-17β-carbothioic acid S-fluoromethyl ester.

Suitable NSAIDs include sodium cromoglycate, nedocromil sodium, phosphodiesterase (PDE) inhibitors (e.g. theophylline, PDE4 inhibitors or mixed PDE3/PDE4 inhibitors), leukotriene antagonists, inhibitors of leukotriene synthesis, iNOS inhibitors, tryptase and elastase inhibitors, beta-2 integrin antagonists and adenosine receptor agonists or antagonists (e.g. adenosine 2a agonists), cytokine antagonists (e.g. chemokine antagonists) or inhibitors of cytokine synthesis. Suitable other β₂-adrenoreceptor agonists include salmeterol (e.g. as the xinafoate), salbutamol (e.g. as the sulphate or the free base), formoterol (e.g. as the fumarate), fenoterol or terbutaline and salts thereof.

Of particular interest is use of the compound of formula (I) in combination with a phosphodiesterase 4 (PDE4) inhibitor or a mixed PDE3/PDE4 inhibitor. The PDE4-specific inhibitor useful in this aspect of the invention may be any compound that is known to inhibit the PDE4 enzyme or which is discovered to act as a PDE4 inhibitor, and which are only PDE4 inhibitors, not compounds which inhibit other members of the PDE family as well as PDE4. Generally it is preferred to use a PDE4 inhibitor which has an IC₅₀ ratio of about 0.1 or greater as regards the IC₅₀ for the PDE4 catalytic form which binds rolipram with a high affinity divided by the IC₅₀ for the form which binds rolipram with a low affinity. For the purposes of this disclosure, the cAMP catalytic site which binds R and S rolipram with a low affinity is denominated the “low affinity” binding site (LPDE 4) and the other form of this catalytic site which binds rolipram with a high affinity is denominated the “high affinity” binding site (HPDE 4). This term “HPDE4” should not be confused with the term “hPDE4” which is used to denote human PDE4.

A method for determining IC₅₀ ratios is set out in U.S. Pat. No. 5,998,428 which is incorporated herein in full by reference as though set out herein. See also PCT application WO 00/57599 for another description of said assay.

The preferred PDE4 inhibitors of use in this invention will be those compounds which have a salutary therapeutic ratio, i.e., compounds which preferentially inhibit CAMP catalytic activity where the enzyme is in the form that binds rolipram with a low affinity, thereby reducing the side effects which apparently are linked to inhibiting the form which binds rolipram with a high affinity. Another way to state this is that the preferred compounds will have an IC₅₀ ratio of about 0.1 or greater as regards the IC₅₀ for the PDE4 catalytic form which binds rolipram with a high affinity divided by the IC₅₀ for the form which binds rolipram with a low affinity.

A further refinement of this standard is that of one wherein the PDE4 inhibitor has an IC₅₀ ratio of about 0.1 or greater; said ratio is the ratio of the IC₅₀ value for competing with the binding of 1 nM of [³H]R-rolipram to a form of PDE4 which binds rolipram with a high affinity over the IC₅₀ value for inhibiting the PDE4 catalytic activity of a form which binds rolipram with a low affinity using 1 μM[³H]-cAMP as the substrate.

Most preferred are those PDE4 inhibitors which have an IC₅₀ ratio of greater than 0.5, and particularly those compounds having a ratio of greater than 1.0. Preferred compounds are cis 4-cyano4-(3-cyclopentyloxy4-methoxyphenyl)cyclohexan-1-carboxylic acid, 2-carbomethoxy-4-cyano-4-(3-cyclopropylmethoxy-4-difluoromethoxyphenyl)cyclohexan-1-one and cis-[4-cyano-4-(3-cyclopropylmethoxy-4-difluoromethoxyphenyl)cyclohexan-1-ol]; these are examples of compounds which bind preferentially to the low affinity binding site and which have an IC₅₀ ratio of 0.1 or greater.

Other compounds of interest include:

Compounds set out in U.S. Pat. No. 5,552,438 issued 3 Sep. 1996; this patent and the compounds it discloses are incorporated herein in full by reference. The compound of particular interest, which is disclosed in U.S. Pat. No. 5,552,438, is cis4-cyano4-[3-(cyclopentyloxy)-4-methoxyphenyl]cyclohexane-1-carboxylic acid (also known as cilomalast) and its salts, esters, pro-drugs or physical forms;

AWD-12-281 from elbion (Hofgen, N. et al. 15th EFMC Int Symp Med Chem (Sep. 6-10, Edinburgh) 1998, Abst P. 98; CAS reference No. 247584020-9); a 9-benzyladenine derivative nominated NCS-613 (INSERM); D-4418 from Chiroscience and Schering-Plough; a benzodiazepine PDE4 inhibitor identified as CI-1018 (PD-168787) and attributed to Pfizer; a benzodioxole derivative disclosed by Kyowa Hakko in WO99/16766; K-34 from Kyowa Hakko; V-11294A from Napp (Landells, L. J. et al. Eur Resp J [Annu Cong Eur Resp Soc (Sep. 19-23, Geneva) 1998] 1998, 12 (Suppl. 28): Abst P2393); roflumilast (CAS reference No 162401-32-3) and a pthalazinone (WO99/47505, the disclosure of which is hereby incorporated by reference) from Byk-Gulden; Pumafentrine, (−)-p-[(4aR*,10bS*)-9-ethoxy-1,2,3,4,4a,10b-hexahydro-8-methoxy-2-methylbenzo[c][1,6]naphthyridin-6-yl]-N,N-diisopropylbenzamide which is a mixed PDE3/PDE4 inhibitor which has been prepared and published on by Byk-Gulden, now Altana; arofylline under development by Almirall-Prodesfarma; VM554/UM565 from Vernalis; or T-440 (Tanabe Seiyaku; Fuji, K. et al. J Pharmacol Exp Ther, 1998, 284(1): 162), and T2585.

Other possible PDE-4 and mixed PDE3/PDE4 inhibitors include those listed in WO01/13953, the disclosure of which is hereby incorporated by reference.

Suitable anticholinergic agents are those compounds that act as antagonists at the muscarinic receptor, in particular those compounds which are antagonists of the M₁ and M₂ receptors. Exemplary compounds include the alkaloids of the belladonna plants as illustrated by the likes of atropine, scopolamine, homatropine, hyoscyamine; these compounds are normally administered as a salt, being tertiary amines. These drugs, particularly the salt forms, are readily available from a number of commercial sources or can be made or prepared from literature data via, to wit:
Atropine—CAS-51-55-8 or CAS-51-48-1 (anhydrous form), atropine sulfate—CAS-5908-99-6; atropine oxide—CAS-4438-22-6 or its HCl salt—CAS-4574-60-1 and methylatropine nitrate—CAS-52-88-0.
Homatropine—CAS-87-00-3, hydrobromide salt—CAS-51-56-9, methylbromide salt—CAS-80-49-9.
Hyoscyamine (d, l)—CAS-101-31-5, hydrobromide salt—CAS-306-03-6 and sulfate salt—CAS-6835-16-1.
Scopolamine—CAS-51-34-3, hydrobromide salt—CAS-6533-68-2, methylbromide salt—CAS-155-41-9.

Preferred anticholinergics include ipratropium (e.g. as the bromide), sold under the name Atrovent, oxitropium (e.g. as the bromide) and tiotropium (e.g. as the bromide) (CAS-139404-48-1). Also of interest are: methantheline (CAS-53-46-3), propantheline bromide (CAS-50-34-9), anisotropine methyl bromide or Valpin 50 (CAS-80-50-2), clidinium bromide (Quarzan, CAS-3485-62-9), copyrrolate (Robinul), isopropamide iodide (CAS-71-81-8), mepenzolate bromide (U.S. Pat. No. 2,918,408), tridihexethyl chloride (Pathilone, CAS-4310-35-4), and hexocyclium methylsulfate (Tral, CAS-1 15-63-9). See also cyclopentolate hydrochloride (CAS-5870-29-1), tropicamide (CAS-1508-75-4), trihexyphenidyl hydrochloride (CAS-144-11-6), pirenzepine (CAS-29868-97-1), telenzepine (CAS-80880-90-9), AF-DX 116, or methoctramine, and the compounds disclosed in WO01/04118, the disclosure of which is hereby incorporated by reference.

Suitable antihistamines (also referred to as H₁-receptor antagonists) include any one or more of the numerous antagonists known which inhibit H₁-receptors, and are safe for human use. All are reversible, competitive inhibitors of the interaction of histamine with H₁-receptors. The majority of these inhibitors, mostly first generation antagonists, have a core structure, which can be represented by the following formula:

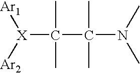

This generalized structure represents three types of antihistamines generally available: ethanolamines, ethylenediamines, and alkylamines. In addition, other first generation antihistamines include those which can be characterized as based on piperizine and phenothiazines. Second generation antagonists, which are non-sedating, have a similar structure-activity relationship in that they retain the core ethylene group (the alkylamines) or mimic the tertiary amine group with piperizine or piperidine. Exemplary antagonists are as follows:
Ethanolamines: carbinoxamine maleate, clemastine fumarate, diphenylhydramine hydrochloride, and dimenhydrinate.
Ethylenediamines: pyrilamine amleate, tripelennamine HCl, and tripelennamine citrate. Alkylamines: chloropheniramine and its salts such as the maleate salt, and acrivastine.
Piperazines: hydroxyzine HCl, hydroxyzine pamoate, cyclizine HCl, cyclizine lactate, meclizine HCl, and cetirizine HCl.
Piperidines: Astemizole, levocabastine HCl, loratadine or its descarboethoxy analogue, and terfenadine and fexofenadine hydrochloride or another pharmaceutically acceptable salt.
Azelastine hydrochloride is yet another H. receptor antagonist which may be used in combination with a PDE4 inhibitor.
Examples of preferred anti-histamines include methapyrilene and loratadine.

The invention thus provides, in a further aspect, a combination comprising a compound of formula (I) a pharmaceutically acceptable salt, solvate or physiologically functional derivative thereof together with a PDE4 inhibitor.

The invention thus provides, in a further aspect, a combination comprising a compound of formula (I) a pharmaceutically acceptable salt, solvate or physiologically functional derivative thereof together with a corticosteroid.

The invention thus provides, in a further aspect, a combination comprising a compound of formula (I) a pharmaceutically acceptable salt, solvate or physiologically functional derivative thereof together with an anticholinergic.

The invention thus provides, in a further aspect, a combination comprising a compound of formula (I) a pharmaceutically acceptable salt, solvate or physiologically functional derivative thereof together with an antihistamine.

The invention thus provides, in a further aspect, a combination comprising a compound of formula (I) a pharmaceutically acceptable salt, solvate or physiologically functional derivative thereof together with a PDE4 inhibitor and a corticosteroid.

The invention thus provides, in a further aspect, a combination comprising a compound of formula (I) a pharmaceutically acceptable salt, solvate or physiologically functional derivative thereof together with an anticholinergic and a PDE-4 inhibitor.

The combinations referred to above may conveniently be presented for use in the form of a pharmaceutical formulation and thus pharmaceutical formulations comprising a combination as defined above together with a physiologically acceptable diluent or carrier represent a further aspect of the invention.

The individual compounds of such combinations may be administered either sequentially or simultaneously in separate or combined pharmaceutical formulations. Appropriate doses of known therapeutic agents will be readily appreciated by those skilled in the art.

According to a further aspect of the invention, there is provided a process for preparing a compound of formula (I), or a salt, solvate, or physiologically functional derivative thereof which comprises a process (a), (b), (c) or (d) as defined below followed by the following steps in any order:
(i) optional removal of any protecting groups;
(ii) optional separation of an enantiomer or diastereoisomer from a mixture of enantiomers or diastereoisomers;
(iii) optional conversion of the product to a corresponding salt, solvate,
(iv) optional conversion of a group R¹, R² and/or R³ to another group R¹, R² and/or R³,
   or physiologically functional derivative thereof.

In the following description of synthetic routes, R¹, R², R³, R⁴, R⁵, Z, m, n and p are as defined for formula (I) and R¹¹, R¹², R¹³ and R¹⁴ are as defined for formula (II) below unless indicated otherwise.

In one general process (a), a compound of formula (I), may be obtained by deprotection of a protected intermediate, for example of formula (II): 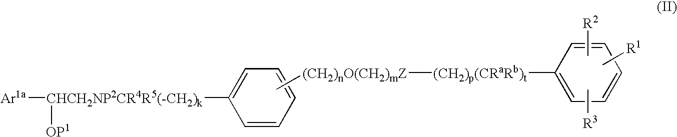
or a salt or solvate thereof, wherein R¹, R², R³, R⁴, R⁵, R^{a}, R^{b}, Z, k, m, n, p and t are as defined for the compounds of formula (I), and wherein Ar^{1a} is Ar¹ or a protected form thereof and P¹ and P² each independently represents either hydrogen or a protecting group provided that the compound of formula (II) contains at least one protecting group.

Optionally protected forms Ar^{1a} of the preferred groups Ar¹ may be selected from: 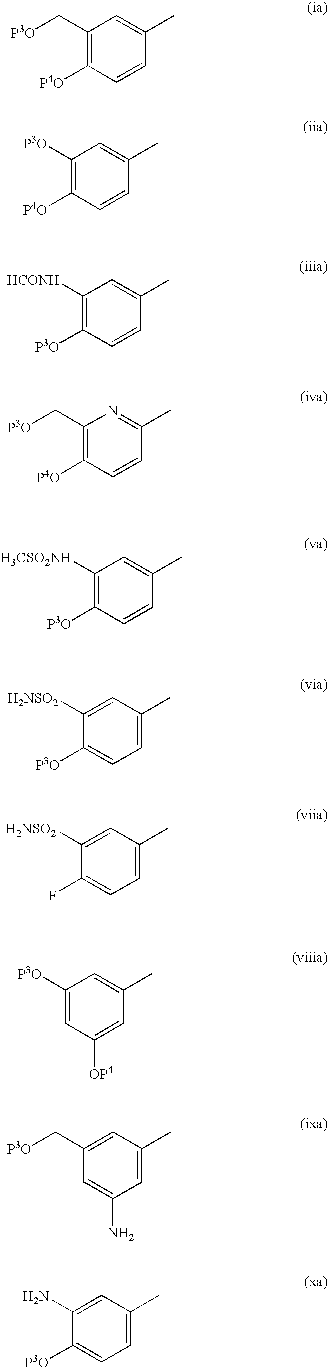 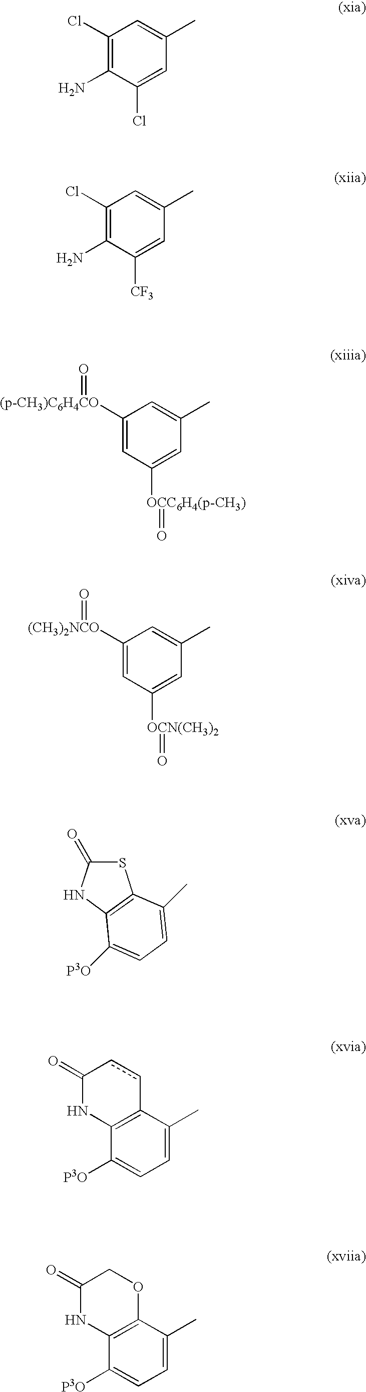 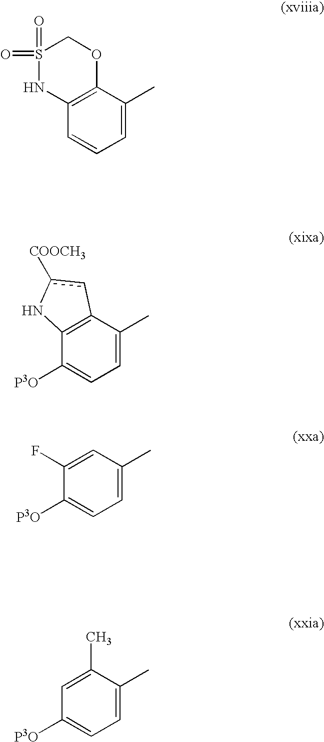
wherein P³ and P⁴ are each independently selected from hydrogen or a protecting group, and the dotted line in (xvia) and (xixa) denotes an optional double bond. It will be appreciated that when Ar¹ represents a group of structure (vii), (xi), (xii), (xiii) or (xiv) no protection of Ar¹ is required.

In one process (aa) according to the invention there is provided deprotection of a compound of formula (IIa) 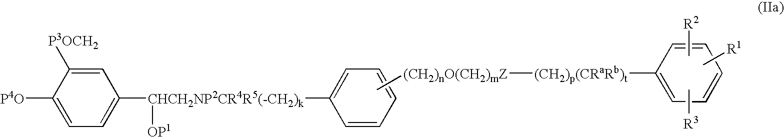
or a salt or solvate thereof, wherein R¹, R², R³, R⁴, R⁵, R^{a}, R^{b}, z, P¹, P², k, m, p and t are as defined for the compounds of formula (II), and P³ and P⁴ are each independently either hydrogen or a protecting group provided that at least one of P², P³ and P⁴ is a protecting group and P¹ is either hydrogen or a protecting group.

Suitable protecting groups P¹-P⁴ may be any conventional protecting group such as those described in “Protective Groups in Organic Synthesis” by Theodora W Greene and Peter G M Wuts, 3rd edition (John Wiley & Sons, 1999). Examples of suitable hydroxyl protecting groups represented by P³ and P⁴ are esters such as acetate ester, aralkyl groups such as benzyl, diphenylmethyl, or triphenylmethyl, and tetrahydropyranyl. Examples of suitable amino protecting groups represented by P² include benzyl, α-methylbenzyl, diphenylmethyl, triphenylmethyl, benzyloxycarbonyl, tert-butoxycarbonyl, and acyl groups such as trichloroacetyl or trifluoroacetyl.

As will be appreciated by the person skilled in the art, use of such protecting groups may include orthogonal protection of groups in the compounds of formula (II) to facilitate the selective removal of one group in the presence of another, thus enabling selective functionalisation of a single amino or hydroxyl function. For example, the —CH(OH) group may be orthogonally protected as —CH(OP¹) using, for example, a trialkylsilyl group such as triethylsilyl. A person skilled in the art will also appreciate other orthogonal protection strategies, available by conventional means as described in Theodora W Greene and Peter G M Wuts (see above).

The deprotection to yield a compound of formula (I), may be effected using conventional techniques. Thus, for example, when P³, P⁴, and/or P² is an aralkyl group, this may be cleaved by hydrogenolysis in the presence of a metal catalyst (e.g. palladium on charcoal).

When P³ and/or P⁴ is tetrahydropyranyl this may be cleaved by hydrolysis under acidic conditions. Acyl groups represented by R¹³ may be removed by hydrolysis, for example with a base such as sodium hydroxide, or a group such as trichloroethoxycarbonyl may be removed by reduction with, for example, zinc and acetic acid. Other deprotection methods may be found in Theodora W Greene and Peter G M Wuts (see above). In a particular embodiment of process (a), when Ar¹ represents a group (i) or (iv) P³ and P⁴ may together represent a protecting group as in the compound of formula (III): 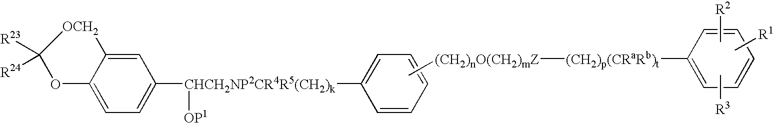
or a salt or solvate thereof, wherein R¹, R², R³, R⁴, R⁵, R^{a}, R^{b}, P¹, Z, k, m, n p and t are as defined for the compound of formula (I), and R²³ and R²⁴ are independently selected from hydrogen, C₁₋₆alkyl, or aryl or R²³ and R²⁴ together form a carbocyclic ring eg. containg from 5 to 7 carbon atoms. In a preferred aspect, both R²³ and R²⁴ are methyl, or one of R²³ and R²⁴ is hydrogen and the other is phenyl.

A compound of formula (III) may be converted to a compound of formula (I), by hydrolysis with dilute aqueous acid, for example acetic acid or hydrochloric acid in a suitable solvent or by transketalisation in an alcohol, for example ethanol, in the presence of a catalyst such as an acid (for example, toluenesulphonic acid) or a salt (such as pyridinium tosylate) at normal or elevated temperature.

It will be appreciated that the protecting groups P³, P⁴, P² and P¹ (including the cyclised protecting group formed by P³ and P⁴ as depicted in formula (III) may be removed in a single step or sequentially. The precise order in which protecting groups are removed will in part depend upon the nature of said groups and will be readily apparent to the skilled worker. Preferably, when P³ and P⁴ together form a protecting group as in formula (III) this protecting group is removed together with any protecting group on the CH(OH) moiety, followed by removal of P².

A compound of formula (II) or formula (III) wherein P¹ and P² are hydrogen may be prepared from a corresponding compound of formula (IV): 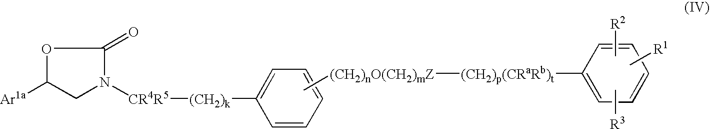
or a salt or solvate thereof, wherein R¹, R², R³, R⁴, R⁵, R^{a}, R^{b}, Ar^{1a}, Z, k, m, n, p and t are as defined for the compound of formula (II) or (III).

The conversion of a compound of formula (IV) to a compound of formula (II) or (III) may be effected by treatment with a base, for example a non-aqueous base, such as potassium trimethylsilanolate, or an aqueous base such as aqueous sodium hydroxide, in a suitable solvent such as tetrahydrofuran.

A compound of formula (IV) may be prepared by reacting a compound of formula (V): 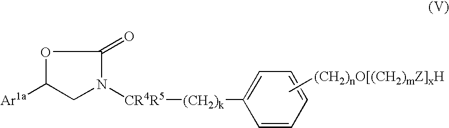
wherein Ar^{1a}, R⁴, R⁵, Z, k, n and m are as defined for formula (II) and x is zero or 1;
with a compound of formula (VI): 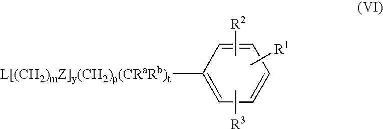
wherein R¹, R², R³, R^{a}, R^{b}, Z, m, p and t are as defined for formula (II), L is a leaving group such as halo (typically chloro, bromo or iodo) or a sulphonate eg. alkylsulphonate (typically methanesulphonate), and y represents 1 or zero such that the sum of x and y is 1. When x is 1, Z represents O.

The reaction of formula (V) and formula (VI) is advantageously effected in the presence of a base such as sodium hydride.

Compounds of formula (VI) are commercially available or may be prepared by methods well known to a person skilled in the art.

A compound of formula (V) may be prepared by coupling a compound of formula (VII): 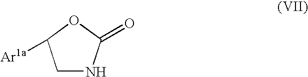
or a salt or solvate thereof, wherein Ar¹ is defined for the compound of formula (II) with a compound of formula (VIII): 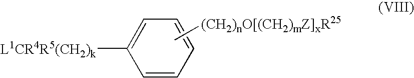
wherein R⁴, R⁵, Z, k, n and m are as defined for formula (II), x is zero or 1, L¹ is a leaving group, for example a halo group, (typically bromo or iodo) or a sulphonate such as an alkyl sulphonate (typically methanesulphonate) an aryl sulphonate (typically toluenesulphonate) or a haloalkylsulphonate (typically trifluoromethane sulphonate), and R²⁵ is a hydroxyl protecting group, such as an acyl group. The group R²⁵ may be removed by standard methods; alternatively, the R²⁵ protecting group may be left in place and the protected compound may be utilised directly in the reaction with formula (VI).

The coupling of a compound of formula (VII) with a compound of formula (VIII) may be effected in the presence of a base, such as a metal hydride, for example sodium hydride, or an inorganic base such as cesium carbonate, in an aprotic solvent, for example N,N-dimethylformamide. The protecting group R²⁵ may be removed using standard methods, using eg. potassium trimethylsilanolate or sodium hydroxide. Those skilled in the art will appreciate that when potassium silanolate is employed then it is preferable to use only 1 equivalent and mild reaction conditions (room temperature) as an excess of this reagent and high temperature will result in cleavage of the oxazolidinone ring.

A compound of formula (VII) may be prepared for example by the method described in WO02/066422.

A compound of formula (VIII) may be prepared from a compound of formula (IX): 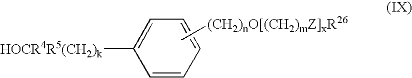
wherein R⁴, R⁵, Z, k, n and m are as defined for formula (II), x is zero or 1 and R²⁶ is a hydroxyl protecting group such as aralkyl, typically benzyl, by conventional chemistry, for example by conversion of the hydroxyl group to a mesylate which may itself be converted to bromo by addition of a salt such as tetraalkylammonium bromide in a solvent such as acetonitrile, followed by removal of the protecting group R²⁶ using standard conditions eg. hydrogenation in the presence of palladium on charcoal, and then introduction of R²⁵, for example by reaction with an acyl anhydride.

Compounds of formula (IX) wherein x is zero are known in the art or can readily be prepared by the skilled person using standard methods.

Compounds of formula (IX) wherein x is 1 may be prepared from a corresponding compound wherein x is zero by reaction with an appropriate alkylating agent.

Compounds of formulae (II) or (III) may also be prepared according to the general methods described below.

In a further process (b) a compound of formula (I), may be obtained by alkylation of an amine of formula (X): 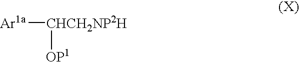
wherein Ar^{1a} is defined for compounds of formula (II) P¹ and P² are each independently either hydrogen or a protecting group, for example as described hereinabove for compounds of formula (II) and (III);
with a compound of formula (XI): 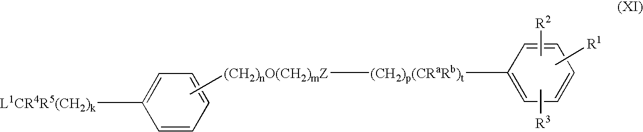
wherein R¹, R², R³, R⁴, R⁵, R^{a}, R^{b}, Z, k, n, m, p and t are as defined for formula (II), L¹ is a leaving group as herein before defined for the compound of formula (VIII); followed by removal of any protecting groups present by conventional methods as described above for the deprotection of compounds of formula (II) and (III). For speed of reaction, L¹ is preferably bromo or is converted to bromo in situ, from the corresponding compound wherein L¹ is methanesulfonate, for example by addition of tetrabutylammonium bromide to the reaction mixture. In this process P² is preferably hydrogen.

A compound of formula (I), may be formed directly (when in the compound of formula (X) P³, P⁴, P² and P¹ are each hydrogen) or via a compound of formula (II) or (III) which may or may not be isolated (when in the compound of formula (X) at least one of P³, P⁴, P² and P¹ is a protecting group).

The reaction of compounds of formulae (X) and (XI) is optionally effected in the presence of an organic base such as a trialkylamine, for example, diisopropylethylamine, and in a suitable solvent for example N,N-dimethylformamide, or acetonitrile.

Compounds of formula (X) are known in the art (for example EP-A 0947498) or may be readily prepared by a person skilled in the art, using known methods, for example as described in WO02/066422.

Further details concerning preparation of compounds (X) wherein Ar¹ is a group (v) can be found in DE3524990; concerning the preparation of compounds (X) wherein Ar¹ is a group (ii), (viii), and (xvi) in EP-A-162576; concerning the preparation of compounds (X) wherein Ar¹ is a group (iv) in EP-A-220054; concerning the preparation of compounds (X) wherein Ar¹ is a group (xi) in GB2165542 and concerning the preparation of compounds (X) wherein Ar¹ is a group (c) in GB2230523.

Compounds of formula (XI) may be prepared by general methods described hereinabove, as will be evident to a person skilled in the art, for example using methods similar to those used in the preparation of compounds (IX) and the reaction of compounds (V) and (VI).

In a further process (c) a compound of formula (I), may be prepared by reacting a compound of formula (XII): 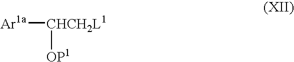
wherein Ar^{1a} as defined for compounds of formula (II) and P¹ is as hereinbefore defined and L¹ is a leaving group, with an amine of formula (XIII): 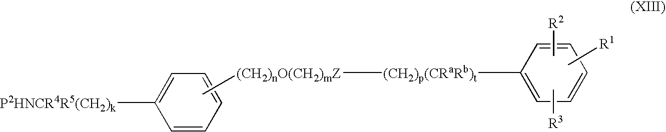
wherein R¹, R², R³, R⁴, R⁵, R^{a}, R^{b}, P², Z, k, n, m, p and t are as defined for formula (II), followed by removal of any protecting groups present by conventional methods as described above for the deprotection of compounds of formula (II).

The reaction may be effected using conventional conditions for such displacement reactions.

Compounds of formula (XII) may be prepared by methods known in the art.

Compounds of formula (XIII) may be prepared by reacting a compound of formula (XI) with an amine P²NH₂.

According to a further process (d) a compound of formula (I) wherein one of R⁴ and R⁵ represents alkyl may be prepared by reacting a compound of formula (X): 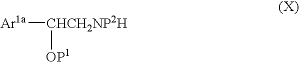
as hereinbefore defined,
with a compound of formula (XIV): 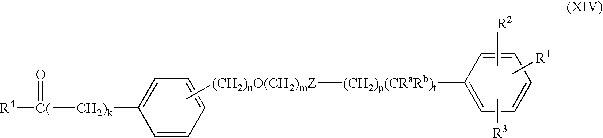
under conditions suitable to effect reductive amination, for example in the presence of a reducing agent such as a borohydride, typically tetramethylammonium (triacetoxy) borohydride.

A compound of formula (XIV) may be prepared by alkylation of a compound of formula (XV) 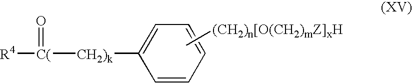
wherein x is zero or 1, with a compound of formula (VI) as hereinbefore defined using methods analogous to those described hereinbefore for the preparation of compounds of formula (IV).

Compounds of formula (XV) wherein x is zero are commerically available or may readily be prepared by conventional methods. Compounds of formula (XV) where x is 1 may be prepared from a corresponding compound wherein x is zero by appropriate alkylation.

It will be appreciated that at any convenient stage in the preparation of a compound of formula (I) one or more of the substituents R¹, R² and R³ may, if appropriate, be converted into a different substituent. Conveniently such conversion may be effected on a compound of formula (IV) prior to the deprotection stages.

Thus for example a compound wherein R¹ represents —NH₂ may be converted into a compound wherein R¹ represents XN R⁶C(O)N R⁷ R⁸ by reaction with an appropriate isocyanate or into a compound wherein R¹ represents L-XN R⁶(CO)N(CO)N R⁷ R⁸ using excess isocyanate—similarly, amide and sulfonamide derivatives may be formed by reaction with an appropriate acyl or sulfonyl chloride or anhydride. Alternatively a simple amide substituent may be prepared from the corresponding nitrile, by treatment with a base such as potassium trimethylsilanolate. Other transformations will be apparent to those skilled in the art, and may be effected by conventional reactions.

It will be appreciated that in any of the routes (a) to (d) described above, the precise order of the synthetic steps by which the various groups and moieties are introduced into the molecule may be varied. It will be within the skill of the practitioner in the art to ensure that groups or moieties introduced at one stage of the process will not be affected by subsequent transformations and reactions, and to select the order of synthetic steps accordingly.

The enantiomeric compounds of the invention may be obtained (i) by separation of the components of the corresponding racemic mixture, for example, by means of a chiral chromatography column, enzymic resolution methods, or preparing and separating suitable diastereoisomers, or (ii) by direct synthesis from the appropriate chiral intermediates by the methods described above.

Optional conversions of a compound of formula (I), to a corresponding salt may conveniently be effected by reaction with the appropriate acid or base. Optional conversion of a compound of formula (I), to a corresponding solvate or physiologically functional derivative may be effected by methods known to those skilled in the art.

According to a further aspect, the present invention provides novel intermediates for the preparation of compounds of formula (I), for example compounds of general formula (III) and (IV).

For a better understanding of the invention, the following Examples are given by way of illustration.

### SYNTHETIC EXAMPLES

Throughout the examples, the following abbreviations are used:
LCMS: Liquid Chromatography Mass Spectrometry
HPLC: High Performance Liquid Chromatography
RT: retention time
DCM: dichloromethane
EtOAc: ethyl acetate
EtOH: ethanol
DMAP: N,N-Dimethylaminopyridine
DMF: N,N-Dimethylformamide
MeOH: methanol
THF: tetrahydrofuran
TSP+ve: thermospray mass spectrum positive mode
h: hour(s)
min: minute(s)
All temperatures are given in degrees centigrade.
Flash silica gel refers to Merck Art No. 9385; silica gel refers to Merck Art No. 7734
Biotage refers to prepacked silica gel cartridges containing KP-Sil run on flash 12i chromatography module.
Solid Phase Extraction (SPE) columns are pre-packed cartridges used in parallel purifications, normally under vacuum. These are commercially available from Varian.
SCX cartridges are Ion Exchange SPE columns where the stationary phase is polymeric benzene sulfonic acid. These are used to isolate amines.

LCMS was conducted on a Supelcosil LCABZ+PLUS column (3.3 cm×4.6 mm ID) eluting with 0.1% HCO₂H and 0.01M ammonium acetate in water (solvent A) and 0.05% HCO₂H 5% water in acetonitrile (solvent B), using the following elution gradient 0.0-7 min 0% B, 0.7-4.2 min 100% B, 4.2-5.3 min 0% B, 5.3-5.5 min 0% B at a flow rate of 3 mL/min. The mass spectra were recorded on a Fisons VG Platform spectrometer using electrospray positive and negative mode (ES+ve and ES−ve).

Thermospray mass spectra were obtained on an HP 5989A spectrometer using the positive mode.

### Example 1

### 4-((1R)-2-{[2-(3-{[2-(Benzyloxy)ethoxy]methyl}phenyl)ethyl]amino}-1-hydroxyethyl)-2-(hydroxymethyl)phenol acetate

### i) 2-[2-(3-Bromophenyl)ethoxy]tetrahydro-2H-pyran

p-Toluenesulphonic acid monohydrate (0.40 g) was added to a stirred solution of 2-(3-bromophenyl)ethanol (5.471 g) and dihydropyran (4.58 g) in CH₂Cl₂ (100 ml) at 0° C. The cooling bath was removed and the reaction mixture stirred at 20° C. for 4 h. Et₃N (2 ml) was added and the mixture evaporated under reduced pressure. The residue was purified by chromatography on a Biotage (90 g) eluting with cyclohexane-Et₂O (15:1) to give the title compound (5.12 g), ES+ve 302/304 (M+NH₄)⁺

### ii) {3-[2-(Tetrahydro-2H-pyran-2-yloxy)ethyl]phenyl}methanol

A solution of n-butyl lithium in hexanes (9.5 ml, 1.6M) was added dropwise to a stirred solution of 2-[2-(3-Bromophenyl)ethoxy]tetrahydro-2H-pyran (2.5 g) in THF (40 ml) at −70° C. After 0.5 h DMF (1.1 ml) was added and the reaction allowed to warm to 20° over 2 h. Water (5 ml) was added and mixture partitioned between Et₂O and water. The aqueous phase was extracted with Et₂O (×2). The combined organic extracts were washed with brine, dried (MgSO₄) and evaporated under reduced pressure. The resiude was dissolved in MeOH (40 ml) at 0° C. and treated with sodium borohydride (0.40 g). After stirring at 20° C. for 2.5 h the reaction was recooled to 0° C. and quenched by the dropwise addition of aqueous hydrochloric acid (1M). The mixture was partitioned between EtOAc and water. The aqueous phase was extracted with EtOAc (×3). The combined organic extracts were washed with brine, dried (MgSO₄) and evaporated under reduced pressure. The residue was purified by chromatography on a Biotage (40 g) eluting with cyclohexane then cyclohexane-EtOAc (9:1 to 4:1) to give the title compound (1.30 g), ES+ve 237 (M+H)⁺

### iii) 2-[2-(3-{[2-(Benzyloxy)ethoxy]methyl{phenyl)ethoxy]tetrahydro-2H-pyran

A solution of {3-[2-(tetrahydro-2H-pyran-2-yloxy)ethyl]phenyl}methanol (0.42 g) in DMF (2 ml) was added dropwise to a stirred suspension of sodium hydride (0.13 g, 60% in oil) in DMF (2 ml) at 0° C. under an atmosphere of nitrogen. After 0.3 h a solution of benzyl 2-bromoethyl ether (0.76 g) in DMF (2 ml) was added dropwise. The reaction mixture was allowed to warm to 20° C. and stirred overnight. Water (30 ml) was added to the reaction mixture and the mixture extracted with Et₂O (2×30 ml). The combined organic extracts were washed with brine, dried (MgSO₄) and evaporated under reduced pressure. The residue was purified by chromatography on a Biotage (40 g) eluting with cyclohexane-Et₂O (3:1) to give the title compound (0.43 g), ES+ve 388 (M+NH₄)⁺

### iv) 1-{[2-(Benzyloxy)ethoxy]methyl}-3-(2-bromoethyl)benzene

Triphenylphosphine dibromide (0.83 g) was added portionwise to a stirred solution of 2-[2-(3-{[2-(benzyloxy)ethoxy]methyl}phenyl)ethoxy]tetrahydro-2H-pyran (0.39 g) in CH₂Cl₂ (10 ml) at 20° C. After 1.7 h the reaction was evaporated under reduced pressure and the residue suspended in cyclohexane (10 ml). The mixture was filtered and the residue washed with cyclohexane. The filtrate was evaporated under reduced pressure and the residue purified by chromatography on a silica SPE cartridge (10 g) eluting with cyclohexane (30 ml), CH₂Cl₂ (2×30 ml) and Et₂O (30 ml). Appropriate fractions were combined and evaporated to give the title compound (0.35 g) ES+ve 366/368 (M+NH₄)⁺

### v) (1R)-2-{[2-(3-{[2-(Benzyloxy)ethoxy]methyl}phenyl)ethyl]amino}-1-(2,2-dimethyl-4H-1,3-benzodioxin-6-yl)ethanol

(1R)-2-Amino-1-(2,2-dimethyl-4H-1,3-benzodioxin-6-yl)ethanol (0.20 g) was added to a stirred solution of 1-{[2-(benzyloxy)ethoxy]methyl}-3-(2-bromoethyl)benzene (0.162 g) in anhydrous DMF (2 ml). The reaction mixture was stirred at 20° C. for 18 h then evaporated under reduced pressure. The residue was partitioned between EtOAc (20 ml) and water (20 ml). The aqueous phase was extracted with EtOAc (20 ml) and the combined organic phases washed with brine, dried (MgSO₄) and evaporated under reduced pressure. The residue was purified by chromatography on a Biotage (8 g) eluting with CH₂Cl₂—MeOH-2M NH₃ in MeOH 150:8:1 to 75:8:1 to give the title compound (0.13 g), ES+ve 492 (MH)⁺

### vi) 4-((1R)-2-{[2-(3-{[2-(Benzyloxy)ethoxy]methyl}phenyl)ethyl]amino}-1-hydroxyethyl)-2-(hydroxymethyl)phenol acetate

A solution of (1R)-2-{[2-(3-[2-(benzyloxy)ethoxy]methyl}phenyl)ethyl]amino}-1-(2,2-dimethyl-4H-1,3-benzodioxin-6-yl)ethanol (0.12 g) in glacial acetic acid (2 ml) and water (1 ml) was heated at 80° C. for 0.5 h. The reaction mixture was evaporated under reduced pressure and the residue was purified by chromatography on a Biotage (8 g) eluting with CH₂Cl₂—MeOH-2M NH₃ in MeOH 75:8:1 to 50:8:1 to give the free base of the title compound. This was converted to the acetate salt using acetic acid to give the title compound (0.06 g). LCMS RT=2.44 min. ES+ve 452 (MH)⁺

### Example 2

### 4-{(1R)-2-[(2-{3-[(Benzyloxy)methyl]phenyl}ethyl)amino]-1-hydroxyethyl-2-(hydroxymethyl)phenol acetate

### i) 2-(2-{3-[(Benzyloxy)methyl]phenyl}ethoxy)tetrahydro-2H-pyran

Prepared using methods similar to those in Example 1 iii) ES+ve 344 (M+NH₄)⁺

### ii) 1-[(Benzyloxy)methyl]-3-(2-bromoethyl)benzene

Prepared using methods similar to those in Example 1 iv) ES+ve 322/324 (M+NH₄)⁺

### iii (1R)-2-[(2-[3-[(Benzyloxy)methyl]phenyl}ethyl)amino]-1-(2,2-dimethyl-4H-1,3-benzodioxin-6-yl)ethanol

Prepared using methods similar to those in Example 1 v) ES+ve 448 (MH)⁺

### iv) 4-{(1R)-2-[(2-{3-[(Benzyloxy)methyl]phenyl}ethyl)amino]-1-hydroxyethyl}-2-(hydroxymethyl)phenol acetate

Prepared using methods similar to those in Example 1 vi) LCMS RT=2.42 min. ES+ve 408 (MH)⁺

### Example 3

### 2-(Hydroxymethyl)-4-{(1R)-1-hydroxy-2-[(2-{3-[(3-phenylpropoxy)methyl]phenyl}ethyl)amino]ethyl}phenol acetate

### i) 2-(2-{3-[(3-Phenylpropoxy)methyl]phenyl}ethoxy)tetrahydro-2H-pyran

Prepared using methods similar to those in Example 1 iii). ES+ve 372 (M+NH₄)⁺

### ii) 1-(2-Bromoethyl)-3-[(3-phenylpropoxy)methyl]benzene

Prepared using methods similar to those in Example 1 iv) TSP+ve 350/352 (M+NH₄)⁺

### iii) (1R)-1-(2,2-Dimethyl-4H-1,3-benzodioxin-6-yl)-2-[(2-{3-[(3-phenylpropoxy)methyl]phenyl}ethyl)amino]ethanol

Prepared using methods similar to those in Example 1 v) ES+ve 476 (MH)⁺

### iv) 2-(Hydroxymethyl)-4-{(1R)-1-hydroxy-2-[(2-{3-[(3-phenylpropoxy)methyl]phenyl}ethyl)amino]ethyl}phenol acetate

Prepared using methods similar to those in Example 1 vi) LCMS RT=2.58 min. ES+ve 436 (MH)⁺

### Example 4

### 2-(Hydroxymethyl)-4-{(1R)-1-hydroxy-2-[(2-{3-[(4-phenylbutoxy)methyl]phenyl}ethyl)amino]ethyl}phenol acetate

### i) 2-(2-{3-[(4-Phenylbutoxy)methyl]phenyl}ethoxy)tetrahydro-2H-pyran

Prepared using methods similar to those in Example 1 iii) TSP+ve 386 (MH)⁺

### ii) 1-(2-Bromoethyl)-3-[(4-phenylbutoxy)methyl]benzene

Prepared using methods similar to those in Example 1 iv) TSP+ve 364/366 (M+NH₄)⁺

### iii) (1R)-1-(2,2-Dimethyl-4H-1,3-benzodioxin-6-yl)-2-[(2-{3-[(4-phenylbutoxy)methyl]phenyl}ethyl)amino]ethanol

Prepared using methods similar to those in Example 1 v) LCMS RT=2.44 min. ES+ve 490 (MH)⁺

### iv) 2-(Hydroxymethyl)-4-{(1R)-1-hydroxy-2-[(2-{3-[(4-phenylbutoxy)methyl]phenyl}ethyl)amino]ethyl}phenol acetate

Prepared using methods similar to those in Example 1 vi) LCMS RT=2.69 min. ES+ve 450 (MH)⁺

### Example 5

### 4-((1R)-2-{[2-(3-{[3-(Benzyloxy)propoxy]methyl}phenyl)ethyl]amino}-1-hydroxyethyl)-2-(hydroxymethyl)phenol acetate

### i) 2-[2-(3-{[3-(Benzyloxy)propoxy]methyl}phenyl)ethoxy]tetrahydro-2H-pyran

Prepared using methods similar to those in Example 1 iii) ES+ve 402 (M+NH₄)⁺

### ii) 1-{[3-(Benzyloxy)propoxy]methyl}-3-(2-bromoethyl)benzene

Prepared using methods similar to those in Example 1 iv) ES+ve 380/382 (M+NH₄)⁺

### iii) (1R)-2-{[2-(3-{[3-(Benzyloxy)propoxy]methyl}phenyl)ethyl]amino}-1-(2,2-dimethyl-)4H-1,3-benzodioxin-6-yl)ethanol

Prepared using methods similar to those in Example 1 v) ES+ve 506 (MH)⁺

### iv) 4-((1R)-2-{[2-(3-{[3-(Benzyloxy)propoxy]methyl}phenyl)ethyl]amino}-1-hydroxyethyl)-2-(hydroxymethyl)phenol acetate

Prepared using methods similar to those in Example 1 vi) LCMS RT=2.44 min. ES+ve 466 (MH)⁺

### Example 6

### 4-((1R)-2-{[2-(4-{[2-(Benzyloxy)ethoxy]methyl}phenyl)ethyl]amino}-1-hydroxyethyl)-2-(hydroxymethyl)phenol acetate

### i) {4-[2-(Tetrahydro-2H-pyran-2-yloxy)ethyl]phenyl}methanol

Prepared using methods similar to those in Example 1 ii) TSP+ve 254 (M+NH₄)⁺

### ii) 2-[2-(4-{[2-(Benzyloxy)ethoxy]methyl}phenyl)ethoxy]tetrahydro-2H-pyran

Prepared using methods similar to those in Example 1 iii) TSP+ve 388 (M+NH₄)⁺

### iii) 1-{[2-(Benzyloxy)ethoxy]methyl}-4-(2-bromoethyl)benzene

Prepared using methods similar to those in Example 1 iv) TSP+ve 352/354 (M+NH₄)⁺

### iv) (1R)-2-{[2-(4-{[2-(Benzyloxy)ethoxy]methyl}phenyl)ethyl]amino}-1-(2,2-dimethyl-4H-1,3-benzodioxin-6-yl)ethanol

Prepared using methods similar to those in Example 1 v) ES+ve 492 (MH)⁺

### v) 4-((1R)-2-{[2-(4-{[2-(Benzyloxy)ethoxy]methyl}phenyl)ethyl]amino}-1-hydroxyethyl)-2-(hydroxymethyl)phenol acetate

Prepared using methods similar to those in Example 1 vi) LCMS RT=2.43 min. ES+ve 452 (MH)⁺

### Example 7

### 2-(Hydroxymethyl)-4-{(1R)-1-hydroxy-2-[(2-{3-[(2-phenylethoxy)methyl]phenyl}ethyl)amino]ethyl}phenol acetate

### i) 3-[2-(Tetrahydro-2H-pyran-2-yloxy)ethyl]benzyl methanesulfonate

Methanesulfonyl chloride (0.3 ml) was added slowly to a stirred solution of {3-[2-(tetrahydro-2H-pyran-2-yloxy)ethyl]phenyl}methanol (0.71 g) and Et₃N (0.63 ml) in CH₂Cl₂ (4 ml) at 0° C. The reaction was allowed to warm to r.t. and stirred for 1 h. Water and CH₂Cl₂ were added and the phases separated using an International Sorbent Technology Phase Separator cartridge. The aqueous phase was extracted with additional CH₂Cl₂ and the combined organic phases were evaporated under reduced pressure. The residue purified by chromatography on a silica SPE cartridge (10 g) eluting with cyclohexane-ethyl acetate (100:0 to 0:100 in a stepped gradient) to give the title compound (0.79 g). ES+ve 332 (M+NH₄)⁺

### ii) 2-(2-{3-[(2-Phenylethoxy)methyl]phenyl}ethoxy)tetrahydro-2H-pyran

2-(2-Hydroxyethyl)benzene (0.119 ml) was added slowly to a stirred suspension of sodium hydride (0.06 g, 60% diposersion in oil) in DMF (2 ml) at 0° C. under an atmosphere of nitrogen. The reaction was stirred for 0.5 h then a solution of 3-[2-(tetrahydro-2H-pyran-2-yloxy)ethyl]benzyl methanesulfonate (0.47 g) in DMF (1.5 ml) was added. The reaction stirred for 2 h then quenched by the dropwise addition of water. The mixture was partitioned between EtOAc and water. The aqueous phase was extracted with EtOAc and the combined organic phases evaporated under reduced pressure. The residues was purified by chromatography on a silica SPE cartridge (10 g) eluting with cyclohexane-EtOAc (19:1) to give the title compound (0.31 g). ES+ve 358 (M+NH₄)⁺

### iii) 1-(2-Bromoethyl)-3-[(2-phenylethoxy)methyl]benzene

Carbon tetrabromide (0.42 g) was added to a stirred solution of 2-(2-{3-[(2-phenylethoxy)methyl]phenyl}ethoxy)tetrahydro-2H-pyran (0.31 g) in CH₂Cl₂ (4 ml) at <5° C. Triphenylphosphine (0.66 g) was added portionwise then the reaction mixture allowed to warm to 20° C. and stirred for 18 h. The solvent was removed by evaporation and the residue chromatographed on an SPE cartridge (10 g) eluting with cyclohexane-CH₂Cl₂ (9:1 to 7:3) to give the title compound (0.256 g). ES+ve 338 (M+NH₄)⁺

### iv) (1R)-1-(2,2-Dimethyl-4H-1,3-benzodioxin-6-yl)-2-[(2-{3-[(2-phenylethoxy)methyl]phenyl}ethyl)amino]ethanol

Prepared using methods similar to those in Example 1 ii) ES+ve 462 (MH)⁺

### v) 2-(Hydroxymethyl)-4-{(1R)-1-hydroxy-2-[(2-{3-[(2-phenylethoxy)methyl]phenyl}ethyl) amino]ethyl}phenol acetate

Prepared using methods similar to those in Example 1 iii) LCMS RT=2.43 min. ES+ve 452 (MH)⁺

### Example 8

### 4-((1R)-2-{[2-(3-{[(2,6-Dichlorobenzyl)oxy]methyl}phenyl)ethyl]amino}-1-hydroxyethyl)-2-(hydroxymethyl)phenol acetate

### i) 2-[2-(3-{[(2,6-Dichlorobenzyl)oxy]methyl}phenyl)ethoxy]tetrahydro-2H-pyran

Prepared using methods similar to those in Example 1 iii) ES+ve 412/414/416 (M+NH₄)⁺

### ii) 2-({[3-(2-Bromoethyl)benzyl]oxy}methyl]-1,3-dichlorobenzene

Prepared using methods similar to those in Example 7 iii) ES+ve 390/392/394/396 (M+NH₄)⁺

### iii) (1R)-2-{[2-(3-{[(2,6-Dichlorobenzyl)oxy]methyl}phenyl)ethyl]amino}-1-(2,2-dimethyl-4H-1,3-benzodioxin-6-yl)ethanol

Prepared using methods similar to those in Example 1 v) ES+ve 516/518/520 (MH)⁺

### iv) 4-((1R)-2-{[2-(3-{[(2,6-Dichlorobenzyl)oxy]methyl}phenyl)ethyl]amino}-1-hydroxyethyl)-2-(hydroxymethyl)phenol acetate

Prepared using methods similar to those in Example 1 vi) LCMS RT=2.58 min. ES+ve 476//478/480 (MH)⁺

### Example 9

### 4-((1R)-1-Hydroxy-2-{[2-(3-{[2-(2-methoxyphenyl)ethoxy]methyl}phenyl)ethyl]amino}ethyl)-2-(hydroxymethyl)phenol acetate

### i) 2-[2-(3-{[2-(2-Methoxyphenyl)ethoxy]methyl}phenyl)ethoxy]tetrahydro-2H-pyran

Prepared using methods similar to those in Example 7 ii) ES+ve 388 (M+NH₄)⁺

### ii) 1-(2-{[3-(2-Bromoethyl)benzyl]oxy}ethyl)-2-methoxybenzene

Prepared using methods similar to those in Example 7 iii) ES+ve 366/368 (M+NH₄)⁺

### iii) 4-((1R)-1-Hydroxy-2-{[2-(3-{[2-(2-methoxyphenyl)ethoxy]methyl}phenyl)ethyl]amino}ethyl)-2-(hydroxymethyl)phenol acetate

Prepared using methods similar to those in Example 9 iii) LCMS RT=2.58 min. ES+ve 451 (MH)⁺

### Example 10

### 4-((1R)-1-Hydroxy-2-{[2-(3l-{[2-(3-methoxyphenyl)ethoxy]methyl}phenyl)ethyl]amino}ethyl)-2-(hydroxymethyl)phenol acetate

### i) 2-[2-(3-{[2-(3-Methoxyphenyl)ethoxy]methyl}phenyl)ethoxy]tetrahydro-2H-pyran

Prepared using methods similar to those in Example 7 ii) ES+ve 388 (M+NH₄)⁺

### ii) 1-(2-Bromoethyl)-3-{[2-(3-methoxyphenyl)ethoxy]methyl}benzene

Prepared using methods similar to those in Example 7 iii) ES+ve 366/368 (M+NH₄)⁺

### iii) 4-((1R)-1-Hydroxy-2-{[2-(3-{[2-(3-methoxyphenyl)ethoxy]methyl}phenyl)ethyl]amino}ethyl)-2-(hydroxymethyl)phenol acetate

Prepared using methods similar to those in Example 9 iii) LCMS RT=2.51 min. ES+ve 464 (MH)⁺

### Example 11

### 4-((1R)-1-Hydroxy-2-{[2-(3-{[2-(4-methoxyphenyl)ethoxy]methyl}phenyl)ethyl]amino}ethyl)-2-(hydroxymethyl)phenol acetate

### i) 2-[2-(3-{[2-(4-Methoxyphenyl)ethoxy]methyl}phenyl)ethoxy]tetrahydro-2H-pyran

Prepared using methods similar to those in Example 7 ii) ES+ve 388 (M+NH₄)⁺

### ii) 1-(2-Bromoethyl)-3-{[2-(4-methoxyphenyl)ethoxy]methyl}benzene

Prepared using methods similar to those in Example 7 iii) ES+ve 366/368 (M+NH₄)⁺

### iii) 4-((1R)-1-Hydroxy-2-{[2-(3-{[2-(4-methoxyphenyl)ethoxy]methyl}phenyl)ethyl]amino}ethyl)-2-(hydroxymethyl)phenol acetate

Prepared using methods similar to those in Example 9 iii) LCMS RT=2.50 min. ES+ve 451 (MH)⁺

### Intermediates 1-39

Intermediates 1-39 (used in the preparation of examples 12-64) were prepared by one of the general methods A-E shown below, both schematically and by a representative example.
General Method A

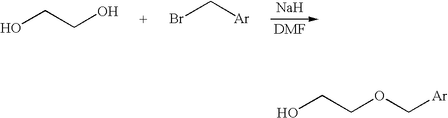

### Intermediate 1

### i) 3-[(2-Hydroxyethoxy)methyl]benzonitrile

Ethylene glycol (6.2 g) was treated with sodium hydride (60% dispersion in oil, 480 mg) and stirred for 30 min. 3-(Bromomethyl)benzonitrile (1.96 g) was added and the reaction mixture heated at 80° C. for 15 h. The reaction mixture was cooled to room temperature and quenched with water. The resultant mixture was partitioned between water and ether. The aqueous phase was extracted with ether and the combined organic phase dried and concentrated in vacuo. The residue was purified by chromatography (SPE, eluted with gradient between cyclohexane and 50% EtOAc in cyclohexane) to give the title compound (780 mg). LCMS RT=2.22 min.
General Method B

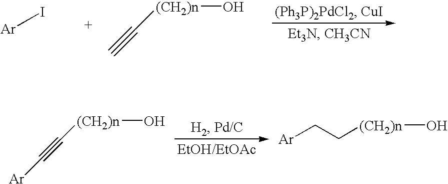

### Intermediate 2

### i) 3-(4-Hydroxybut-1-ynyl)phenyl acetate

A solution of 3-iodophenyl acetate (5.6 g) (J. Org. Chem. 1983, 48, 1542-4) in acetonitrile (100 mL) was treated triethylamine (8 mL), (Ph₃P)₂PdCl₂ (673 mg) and CuI (368 mg) and stirred at room temperature. 3-Butyn-1-ol (1.78 g) was added and the reaction mixture stirred for a further 20 h and concentrated in vacuo. The residue was purified by chromatography (SPE, gradient from cyclohexane to DCM) to give the title compound. (4.47 g) LCMS RT=2.54 min

### ii) 3-(4-Hydroxybutyl)phenyl acetate

5% Pd on Carbon (50%, wet) under nitrogen was treated with a solution of 3-(4-hydroxybut-1-ynyl)phenyl acetate (4.47 g) in ethyl acetate (100 mL) and ethanol (100 mL). The reaction mixture was flushed with nitrogen and stirred under hydrogen for 20 h. The reaction mixture was flushed with nitrogen and filtered through celite under nitrogen. The filtrate was concentrated in vacuo and the residue was purified by chromatography (SPE, gradient from cyclohexane to EtOAc) to give the title compound. (3.81 g) LCMS RT=2.64
General Method C

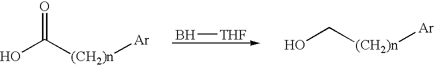

### Intermediate 3

### i) 3-[4-(Methylsulfonyl)phenyl]propan-1-ol

A solution of 3-[4-(methylsulfonyl)phenyl]propanoic acid (600 mg) in dry THF (10 mL) was treated with borane-THF (1M in THF, 4.96 mL) and the resultant solution stirred at room temperature for 2 h. The reaction mixture was quenched with water and partitioned between EtOAc and water. The organic phase was washed with 2N NaOH and dried (MgSO₄) . The organic solution was concentrated in vacuo to give the title compound. (482 mg) LCMS RT=2.02 min
General Method D

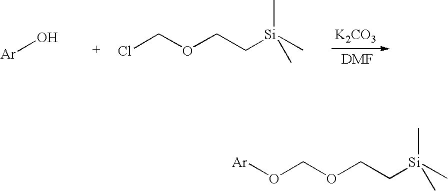

### Intermediate 4

### i) 2-(2-{[2-(Trimethylsilyl)ethoxy]methoxy}phenyl)ethanol

A solution of 2-(2-hydroxyphenyl)ethanol (69 mg) in dry DMF (10 mL) was treated with potassium carbonate (86 mg) under nitrogen. 2-(trimethylsilyl)ethoxymethy chloride (110 μL) was added and the reaction mixtures stirred at room temperature for 16 h prior to partitioning between EtOAc and water. The organic phase was washed with sat. NH₄Cl_{(aq)}, water and dried (MgSO₄) and concentrated in vacuo. The residue was purified by chromatography (SPE, gradient from cyclohexane to EtOAc) to give the title compound. (49 mg) LCMS RT=3.59 min
General Method E

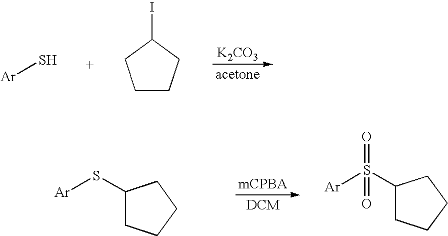

### Intermediate 5

### i) b 4-Bromophenyl cyclopentyl sulphide

To a stirred solution of 4-bromobenzenethiol (5.00 g) in N,N-dimethylformamide (100 mL) was added cyclopentyl bromide (6.34 g) and potassium carbonate (9.27 g). The mixture was allowed to stir at room temperature under nitrogen for 67 h. The reaction mixture was partitioned between 2N HCl and ethyl acetate. The organic phase was washed with brine and dried (MgSO₄). Filtration and removal of the solvent under reduced pressure gave the title compound (5.88 g). LCMS=4.28 min.

### ii) 4-Bromophenyl cyclopentyl sulfone

A stirred solution of 4-bromophenyl cyclopentyl sulphide (4.00 g) in dichloromethane (200 ml) under nitrogen was treated with meta-chloroperbenzoic acid (9.42 g, assuming 57%), and stirred at room temperature for 2 h. The reaction mixture was poured into water and washed with sodium sulphite solution (15%) until no peroxide remained. The organic phase was washed with brine and dried (MgSO₄). Filtration and removal of the solvent under reduced pressure gave the title compound (3.91 g). LCMS RT=3.15 min.

The following intermediates were prepared according to the general methods A-E above.

| Intermediate | | General | | LCMS |
|---|---|---|---|---|
| No. | Name | Method | Intermediate | RT |
| 6 | 3-[(2-Hydroxyethoxy)methyl]benzonitrile | General | | 2.22 min |
| | | Method A | | |
| 7 | 2-[(2,6-Dichlorobenzyl)oxy]ethanol | General | | 2.64 min |
| | | Method A | | |
| 8 | 2-[(3-Fluorobenzyl)oxy]ethanol | General | | 2.37 min |
| | | Method A | | |
| 9 | 2-[(3,5-Dimethylbenzyl)oxy]ethanol | General | | 2.79 min |
| | | Method A | | |
| 10 | 2-[(3-Methoxybenzyl)oxy]ethanol | General | | 2.34 min |
| | | Method A | | |
| 11 | 2-{[3-(Trifluoromethoxy)benzyl]oxy}ethanol | General | | 2.93 min |
| | | Method A | | |
| 12 | 3-(4-Hydroxybutyl)phenyl acetate | General | 2.54 min | 2.64 min |
| | | Method B | | |
| 13 | 3-(4-Hydroxybutyl)benzenesulfonamide | General | 2.16 min | 2.14 min |
| | | Method B | | |
| 14 | 4-(3-Hydroxypropyl)benzonitrile | General | 2.39 min | 2.38 min |
| | | Method B | | |
| 15 | 4-(4-Hydroxybutyl)benzonitrile | General | 2.52 min | 2.56 min |
| | | Method B | | |
| 16 | 3-(3-Hydroxypropyl)benzonitrile | General | 2.36 min | 2.42 min |
| | | Method B | | |
| 17 | 3-[4-(Methylsulfonyl)phenyl]propan-1-ol | General | | 2.02 min |
| | | Method C | | |
| 18 | [4-(Methylsulfonyl)phenyl]methanol | General | | 1.56 min |
| | | Method C | | |
| 19 | 2-(2-{[2- | General | | 3.59 min |
| | (Trimethylsilyl)ethoxy]methoxy}phenyl)ethanol | Method D | | |
| 20 | (3-{[2- | General | | 3.51 min |
| | (Trimethylsilyl)ethoxy]methoxy}phenyl)methanol | Method D | | |
| 21 | (4-{[2- | General | | 3.43 min |
| | (Trimethylsilyl)ethoxy]methoxy}phenyl)methanol | Method D | | |
| 22 | 3-(2-{[2- | General | 2.20 min | 3.61 min |
| | (Trimethylsilyl)ethoxy]methoxy}phenyl)propan- | Method C | | |
| | 1-ol | & D | | |
| 23 | 3-(3-{[2- | General | 2.09 min | 3.67 min |
| | (Trimethylsilyl)ethoxy]methoxy}phenyl)propan- | Method C | | |
| | 1-ol | & D | | |
| 24 | 4-[4-(Cyclopentylsulfonyl)phenyl]butan-1-ol | General | 2.74 min | 2.64 min |
| | | Methods | | |
| | | E & B | | |
| 25 | 3-[4-(Cyclopentylsulfonyl)phenyl]propan-1- | General | 2.67 min | 2.79 min |
| | ol | Methods | | |
| | | E & B | | |

### Intermediate 26

### 2-[(3-{[2-(Trimethylsilyl)ethoxy]methoxy}benzyl)oxy]ethanol

### i) 3-{[2-(Trimethylsilyl)ethoxy]methoxy}benzyl bromide

A solution of (3-{[2-(trimethylsilyl)ethoxy]methoxy}phenyl)methanol (4 g) in dry DCM (50 mL) was cooled to 0° C. and treated with DIPEA (4.08 mL). Methane sulphonyl chloride (1.46 mL) was added dropwise and the reaction mixture stirred at 0° C. for 2 h prior to diluting with DCM and washing with sat. NaHCO_{3 (aq)}. The organic phase was dried (MgSO₄) and concentrated in vacuo. The residue was redissolved in acetonitrile (50 mL) and treated with tetra-n-butyl ammonium bromide (9.9 g) and the reaction mixture heated at 50° C. for 2.5 h and room temperature for 16 h. The reaction mixture was concentrated in vacuo and the residue was purified by chromatography (SPE, gradient from cyclohexane to 25% Et₂O) to give the title compound. (2.43 g) LCMS RT=4.02 min

### ii) 2-[(3-{[2-(Trimethylsilyl)ethoxy]methoxy}benzyl)oxy]ethanol

Prepared similarly to General Method A. LCMS RT=3.33 min

### Intermediate 27

### 2-{[3-(Cyclopentylsulfonyl)benzyl]oxy}ethanol

### i) 1-(Hydroxymethyl)-3-(cyclopentylthio)benzene

A solution of 3-iodobenzyl alcohol (5 g) in dry N-methylpyrollidinone (50 mL) was treated with triethylamine (20 mL), 1,1′-bis(diphenylphosphine)ferrocene (710 mg) and tris(dibenzylidineacetone) dipalladium (0) (285 mg). The reaction mixture was degassed and flushed thoroughly with nitrogen. Cyclopentyl mercaptan (2.3 mL) was added and the reaction mixture heated at 70° C. for 5 h and room temperature for a further 16 h. The reaction mixture was poured onto water and extracted into EtOAc. The organic phase was washed with sat. Na₂CO₃, 2N HCl and water. The organic phase was dried (MgSO₄) and concentrated in vacuo. The residue was purified by chromatography (SPE, Gradient between cyclohexane and cyclohexane/EtOAc 1:1) to give the title compound. (4.62 g) LCMS RT=3.23 min.

### ii) 1-(Bromomethyl)-3-(cyclopentylthio)benzene

A solution of 1-(hydroxymethyl)-3-(cyclopentylthio)benzene (4.6 g) in dry DCM (100 mL) was treated with triphenylphosphine (14.5 g) and protionwise with CBr₄ (18.4 g). The reaction mixture was stirred at room temperature for 3 h prior to partitioning between EtOAc and water. The organic phase was dried (MgSO₄) and concentrated in vacuo. The residue was purified by chromatography (SPE, Gradient between cyclohexane and cyclohexane/EtOAc 1:1) to give the title compound. (1.1 g) LCMS RT=3.98 min.

### iii) 2-{[3-(Cyclopentylthio)benzyl]oxy}ethanol

Prepared similarly to General Method A. LCMS RT=3.17 min

### Intermediate 28

### i) 2-{[3-(Cyclopentylsulfinyl)benzyl]oxy}ethanol

A solution of 2-{[3-(cyclopentylthio)benzyl]oxy}ethanol (520 mg) in ethanol (15 mL) was treated with a solution of NalO₄ (1.77 g) in water (5 mL). The resultant solution was stirred at room temperature for 2 h prior to concentration in vacuo. The residue was partitioned between water and EtOAc, the organic phase washed with water, dried (MgSO₄) and concentrated in vacuo. The residue was purified by chromatography (SPE, Gradient between cyclohexane and cyclohexane/EtOAc, 1:1) to give the title compound. (201 mg) LCMS RT=2.40 min.

### ii) 2-{[3-(Cyclopentylsulfonyl)benzyl]oxy}ethanol

A solution of 2-{[3-(cyclopentylsulfinyl)benzyl]oxy}ethanol (200 mg) in dry DCM (10 mL) was cooled to 0° C. and treated with m-chloro-perbenzoic acid (246 mg). The reaction was stirred at room temperature for 0.5 h and room temperature for 2 h. The reaction mixture was partitioned between DCM and sat. sodium sulphite solution. The organic phase was washed with sat. sodium sulphite solution, dried (MgSO₄) and concentrated in vacuo. The residue was purified by chromatography (SPE, Gradient between cyclohexane and cyclohexane/EtOAc, 1:1) to give the title compound. (436 mg) LCMS RT=2.55 min.

### Intermediate 29

### [3-(Cyclopentylsulfonyl)phenyl]methanol

A solution of 1-(hydroxymethyl)-3-(cyclopentylthio)benzene (4.3 g) in dry DCM (300 mL) was cooled to 0° C. and treated with m-chloro-perbenzoic acid (15.6 g). The reaction mixture was stirred at room temperature for 2 h and room temperature for 16 h. The reaction mixture was partitioned between DCM and sat. sodium sulphite solution. The organic phase was washed with sat. sodium sulphite solution, dried (MgSO₄) and concentrated in vacuo. The residue was purified by chromatography (SPE, Gradient between cyclohexane and EtOAc) to give the title compound. (4.52 g) LCMS RT=2.43 min.

### Intermediate 30

### 4-[3-(Cyclopentylsulfinyl)phenyl]butan-1-ol

### i) [4-(3-Bromophenyl)butoxy](tert-butyl)diphenylsilane

A solution of 4-(3-bromophenyl)butan-1-ol (5 g) [WO 0266422 A1] in dry DMF (50 mL) was treated with imidazole (1.8 g) and tert-butyldiphenylsilyl chloride (7.2 g) and stirred at room temperature for 16 h. The reaction mixture was partitioned between water and EtOAc. The organic phase was washed with 2N HCl, water, sat. NH₄Cl_{(aq)}, water, dried (MgSO₄) and concentrated in vacuo. The residue was purified by chromatography (SPE, Gradient between cyclohexane and cyclohexane/EtOAc 5:1) to give the title compound. (9.67 g) LCMS RT=4.82 min

### ii) tert-Butyl{4-[3-(cyclopentylthio)phenyl]butoxy}diphenylsilane

A solution [4-(3-bromophenyl)butoxy](tert-butyl)diphenylsilane (2 g) in dry N-methylpyrollidine (15 mL) was treated with triethylamine (4 mL), 1,1′-bis(diphenylphosphine)ferrocene (284 mg) and tris(dibenzylidineacetone) dipalladium (0) (114 mg). The reaction mixture was degassed and flushed thoroughly with nitrogen. Cyclopentyl mercaptan (436 mg) was added and the reaction mixture heated at 70° C. for 3 h and room temperature for a further 16 h. The reaction mixture was poured onto water and extracted into EtOAc. The organic phase was washed with sat. Na₂CO₃, 2N HCl and water. The organic phase was dried (MgSO₄) and concentrated in vacuo. The residue was purified by chromatography (SPE, Gradient between cyclohexane and cyclohexane/DCM 5:1) to give the title compound. (1.48 g) LCMS RT=4.94 min.

### iii) tert-Butyl{4-[3-(cyclopentylsulfinyl)phenyl]butoxy}diphenylsilane

A solution of tert-butyl(4-[3-(cyclopentylthio)phenyl]butoxy}diphenylsilane (1.48 g) in ethanol (50 mL) was treated with a solution of NalO₄ (2.6 g) in water (16 mL). The resultant solution was stirred at room temperature for 3 h prior to concentration in vacuo. The residue was partitioned between water and EtOAc, the organic phase washed with water, dried (MgSO₄) and concentrated in vacuo. The residue was purified by chromatography (SPE, Gradient between cyclohexane and EtOAc) to give the title compound. (690 mg) LCMS RT=4.45 min.

### iv) 4-[3-(Cyclopentylsulfinyl)phenyl]butan-1-ol

A solution of tert-butyl{4-[3-(cyclopentylsulfinyl)phenyl]butoxy}diphenylsilane (690 mg) in dry THF (10 mL) was treated with a solution of tetra-n-butylammonium fluoride (3 mL, 1M in THF) and the resultant reaction mixture stirred at room temperature for 5 h prior to concentration in vacuo. The residue was purified by chromatography (SPE, Gradient between cyclohexane and EtOAc) to give the title compound. (362 mg) LCMS RT=2.64 min.

### Intermediate 31

### (5R)-3-{2-[3-(Bromomethyl)phenyl]ethyl}-5-(2,2-dimethyl-4H-1,3-benzodioxin-6-yl)-1,3-oxazolidin-2-one

### i) 3-[2-(Tetrahydro-2H-pyran-2-yloxy)ethyl]benzyl acetate

A solution of {3-[2-(tetrahydro-2H-pyran-2-yloxy)ethyl]phenyl}methanol (36.8 g) in DCM (200 mL) was cooled to 0° C. and treated with pyridine (14 mL). Acetic anhydride (13 mL) was added dropwise. The resultant mixture was stirred at room temperature, under nitrogen, for 16 h. The reaction mixture was partitioned between DCM (100 mL) and 2N hydrochloric acid (100 mL). The organic phase was washed with 2N hydrochloric acid (100 mL), 2N sodium bicarbonate solution (100 mL) and water (200 mL), dried (Na₂SO₄) and evaporated under reduced pressure. This was chromatographed on a Biotage cartridge (4×90 g) eluting with cyclohexane-ethyl acetate, (3:1) to give the title compound (37.23 g). LCMS RT=3.10 min

### ii) 3-(2-Hydroxyethyl)benzyl acetate

A solution of 3-[2-(tetrahydro-2H-pyran-2-yloxy)ethyl]benzyl acetate (20 g) in acetic acid (100 mL) and water (20 mL) was heated at 80° C. for 1.5 h. The reaction mixture was evaporated under reduced pressure and the residue was chromatographed on a Biotage cartridge (2×90 g) eluting with cyclohexane-ethyl acetate (3:1) to (1:1) to give the title compound (13.42 g). LCMS RT=2.30 min

### iii) 3-(2-Bromoethyl)benzyl acetate

A solution of 3-(2-hydroxyethyl)benzyl acetate (13.01 g) in DCM (100 mL) was cooled to 0° C. and treated with N,N-diisopropylethylamine (17.5 mL). Mesyl chloride (6.22 mL) was added and the reaction mixture stirred at 0° C. for 1 h. The reaction was washed with saturated sodium bicarbonate solution (150 mL). The organic phase was dried (Na₂SO₄) concentrated in vacuo. A solution of the residue in acetonitrile (130 mL) was treated with tetrabutylammonium bromide (33 g). The reaction mixture was heated at 70° C. for 1.5 h before concentrating in vacuo. The resultant oil was partitioned between diethyl ether (150 mL) and water (150 mL). The organic phase was dried (Na₂SO₄) and concentrated in vacuo. The residue was chromatographed on a Biotage cartridge (90 g) eluting with cyclohexane-diethyl ether (3:1) to give the title compound (10.29 g) LCMS RT=3.23 min.

### iv) 3-(2-{[(2R)-2-(2,2-Dimethyl-4H-1,3-benzodioxin-6-yl)-2-hydroxyethyl]amino}ethyl)benzyl acetate

A solution of 3-(2-bromoethyl)benzyl acetate (8.08 g) in anhydrous DMF (100 mL) was treated with (1R)-2-amino-1-(2,2-dimethyl-4H-1,3-benzodioxin-6-yl)ethanol (WO02/70490) (10.4 g) and N,N-diisopropylethylamine (8.1 mL). The reaction mixture was stirred at 50° C. for 18 h then evaporated under reduced pressure. The residue was partitioned between ethyl acetate (100 mL) and water (100 mL). The organic layer was washed with brine, dried (Na₂SO₄) and evaporated under reduced pressure. The residue was chromatographed on a Biotage cartridge (90 g) eluting with dichloromethane-methanol (10:1) to give the title compound (5.49) LCMS RT=2.32 min.

### v) 3-{2-[(5R)-5-(2,2-Dimethyl-4H-1,3-benzodioxin-6-yl)-2-oxo-1,3-oxazolidin-3-yl]ethyl}benzyl acetate

A solution of 3-(2-{[(2R)-2-(2,2-dimethyl-4H-1,3-benzodioxin-6-yl)-2-hydroxyethyl]amino}ethyl)benzyl acetate (5.4 g) in anhydrous THF (100 mL) was treated with 1,1′-carbonyldiimidazole (4.38 g) and stirred at room temperature for 4 h before concentrating in vacuo. The residue was partitioned between ethyl acetate (100 mL) and water (100 mL). The organic phase was washed with brine, dried (Na₂SO₄) and concentrated in vacuo. The residue was chromatographed on a Biotage cartridge (90 g) eluting with cyclohexane-ethyl acetate (2:1) to (1:1) to give the title compound (4.13 g) LCMS RT=3.17 min

### vi) (5R)-5-(2,2-Dimethyl-4H-1,3-benzodioxin-6-yl)-3-{2-[3-(hydroxymethyl)phenyl]ethyl}1,3-oxazolidin-2-one

To a solution of 3-{2-[(5R)-5-(2,2-dimethyl-4H-1,3-benzodioxin-6-yl)-2-oxo-1,3-oxazolidin-3-yl]ethyl}benzyl acetate (4.13 g) in anhydrous THF (100 mL) was added potassium trimethylsilanolate (2.5 g). The reaction mixture was stirred at room temperature for 1.5 h before adding water (80 mL) followed with ethyl acetate (80 mL).The aqueous phase was extracted with ethyl acetate and the combined organic phases washed with water and brine, dried (Na₂SO₄) and concentrated in vacuo. The residue was chromatographed on a Biotage cartridge (90 g) eluting with ethyl acetate-cyclohexane (2:1) to give the title compound (2.91 g). LCMS RT=2.94 min.

### vii) (5R)-3-{2-[3-(Bromomethyl)phenyl]ethyl}-5-(2,2-dimethyl-4H-1,3-benzodioxin-6-yl)-1,3-oxazolidin-2-one

A solution of (5R)-5-(2,2-dimethyl-4H-1,3-benzodioxin-6-yl)-3-{2-[3-(hydroxymethyl) phenyl]ethyl}-1,3-oxazolidin-2-one (2.51 g) in anhydrous DCM (100 mL) was cooled to 0° C. and treated with N,N-diisopropylethylamine (1.71 mL). Mesyl chloride (1 mL) was added and the reaction mixture stirred at 0° C. for 1.5 h.

The reaction was washed with saturated sodium bicarbonate solution (80 mL). The organic phase was dried (Na₂SO₄) concentrated in vacuo. A solution of the residue in acetonitrile (100 mL) was treated with tetrabutylammonium bromide (3.17 g). The reaction mixture was heated at 70° C. for 1.5 h before concentrating in vacuo. The resultant oil was partitioned between diethyl ether (80 mL) and water (80 mL). The organic phase was dried (Na₂SO₄) and concentrated in vacuo.

The residue was chromatographed on a Biotage cartridge (90 g) eluting with ethyl acetate-cyclohexane (1:1) to give the title compound (2.29 g) LCMS RT=3.46 min.

### Intermediate 32

### 3-(2-Hydroxyethyl)-N,N-bis{[2-(trimethylsilyl)ethoxy]methyl}benzenesulfonamide

### i) Methyl [3-(aminosulfonyl)phenyl]acetate

0.880 Ammonia solution (2 mL) was added to a stirred solution of methyl [3-(chlorosulfonyl)phenyl]acetate (Beecham EP91749A) (1.75 g) in dichloromethane (10 mL) and acetonitrile (10 mL). After two hours stirring at 21° the solution was partitioned between dichloromethane and water. The aqueous layer was extracted with further dichloromethane and the combined organic layers were washed with water, dried (MgSO₄) and evaporated. Dichloromethane was added and the white solid was collected by filtration to give the title compound (0.67 g). LCMS RT=1.97 min.

### ii) Methyl {3-[(bis{[2-(trimethylsilyl)ethoxy]methyl}amino)sulfonyl]phenyl}acetate

Methyl [3-(aminosulfonyl)phenyl]acetate (0.67 g) was stirred with sodium hydride (60% oil dispersion, (0.26 g) in DMF (15 mL) at 21° for ten minutes and then 2-(trimethylsilyl)ethoxymethyl chloride (1.04 g) was added. After two hours the solution was partitioned between pH 6.4 aqueous phosphate buffer and ethyl acetate. The aqueous layer was extracted twice more with ethyl acetate and the combined organic layers were washed with water, dried (MgSO₄) and evaporated. The residue was purified by chromatography on silica gel in mixtures of ethyl acetate in 40-60 petroleum ether to give the title compound (0.72 g). LCMS RT=4.35 min.

### iii) 3-(2-Hydroxyethyl)-N,N-bis{[2-(trimethylsilyl)ethoxy]methyl}benzenesulfonamide

Methyl {3-[(bis{[2-(trimethylsilyl)ethoxy]methyl}amino)sulfonyl]phenyl}acetate (0.72 g) was stirred in THF (10 mL) under nitrogen at 21° and a solution of lithium aluminium hydride (1M in diethyl ether, 1 mL) was added over 1 min. After 15 min, wet THF was added cautiously and the solution was partitioned between water and dichloromethane. The aqueous layer was extracted with more dichloromethane and the combined organic layers were washed with water, dried (MgSO₄) and evaporated. The residue was purified by chromatography on silica gel in mixtures of ethyl acetate in 40-60 petroleum ether to give the title compound (0.38 g). LCMS RT=4.07 min.

### Intermediate 33

### 3-(3-Hydroxypropyl)-N,N-bis{[2-(trimethylsilyl)ethoxy]methyl}benzenesulfonamide

### i) 3-(3-Hydroxyprop-1-ynyl)benzenesulfonamide

A solution of 3-bromobenzene-1-sulfonamide (944 mg) in anhydrous tetrahydrofuran (20 mL) was treated with triethylamine (10 mL) and dichlorobis(triphenylphosphine)palladium(II) (117 mg) and copper iodide (32 mg). The solution was heated to reflux prior to addition of a solution of propyn-1-ol (187 mg) in anhydrous tetrahydrofuran (5 mL). The reaction mixture was heated for 16 h and then concentrated in vacuo. The residue was purified by chromatography (SPE, Gradient between cyclohexane and EtOAc) to give the title compound (196 mg). LCMS RT=1.97 min

### ii) 3-(3-Hydroxypropyl)benzenesulfonamide

5% Palladium on Carbon (50%, wet) under nitrogen was treated with a solution of 3-(3-hydroxyprop-1-ynyl)benzenesulfonamide (196 mg) in ethanol (10 mL). The reaction mixture was flushed with nitrogen and stirred under hydrogen for 16 h. The reaction mixture was then flushed with nitrogen and filtered through celite under nitrogen. The filtrate was concentrated in vacuo and the residue was purified by chromatography (SPE, gradient from cyclohexane to EtOAc) to give the title compound (57 mg) LCMS RT=1.90 min

### iii) 3-(3-Hydroxypropyl)-N,N-bis{[2-(trimethylsilyl)ethoxy]methyl}benzenesulfonamide

3-(3-Hydroxypropyl)benzenesulfonamide (54 mg) was stirred with sodium hydride (60% dispersion in oil, 22 mg) in DMF (5 mL) at room temperature for 10 min and then 2-(trimethylsilyl)ethoxymethyl chloride (0.088 mL) was added. The reaction mixture was stirred at room temperature for 18 h. The mixture was then partitioned between pH 6.4 aqueous phosphate buffer and ethyl acetate. The aqueous was extracted with EtOAc and the combined organics were washed with water and brine, dried (MgSO₄) and evaporated in vacuo. The residue was purified by chromatography (SPE, eluted with cyclohexane-ethyl acetate, 2:1) to give the title compound (63 mg) LCMS RT=3.99 min

### Intermediate 34

### 4-(2,6-Dichlorophenyl)butan-1-ol

### i) 4-(2,6-Dichlorophenyl)but-3-yn-1-ol

A solution of 1,3-dichloro-2-iodobenzene (3.8 g) in diethylamine (100 mL) was treated with dichlorobis(triphenylphosphine)palladium(II) (364 mg) and copper iodide (199 mg) and was heated at reflux. 3-Butyn-1-ol (962 mg) was added and the reaction mixture was stirred at 80° C. for 16 h. The reaction mixture was then concentrated in vacuo. The residue was purified by chromatography (SPE, gradient from cyclohexane to dichloromethane) to give the title compound (2.2 g) LCMS RT=3.06 min

### ii) 4-(2,6-Dichlorophenyl)butan-1-ol

Platinum (IV) oxide (180 mg) under nitrogen was treated with a solution of 4-(2,6-dichlorophenyl)but-3-yn-1-ol (1.8 g) in ethanol (100 mL) and ethyl acetate (100 mL). The reaction mixture was flushed with nitrogen and treated with hydrogen and was stirred until the required amount of hydrogen had been consumed. The reaction mixture was flushed with nitrogen, filtered through Celite and concentrated in vacuo. The resultant residue was purified by chromatography (SPE, gradient from cyclohexane to ethyl acetate) to give the title compound (1.49 g). LCMS RT=3.22 min

### Intermediate 35

### N-[3-(4-Hydroxybutyl)phenyl]urea

### i) 4-(3-Aminophenyl)but-3-yn-1-ol

Prepared with 3-Iodoaniline and 3-butyn-1-ol using similar methods to those in Intermediate 33 i). LCMS RT=1.74 min

### ii) 4-(3-Aminophenyl)butan-1-ol

Prepared from 4-(3-aminophenyl)but-3-yn-1-ol using similar methods to those in Intermediate 34 ii). LCMS RT=1.61 min

### iii) 3-(4-{[tert-Butyl(dimethyl)silyl]oxy}butyl)aniline

A stirred solution of 4-(3-aminophenyl)butan-1-ol (3.66 g) in DMF (30 mL), under nitrogen, was treated with imidazole (1.66 g) and tert-butyldimethylsilyl chloride (3.5 g). Stirring was continued at room temperature for 18 h. The mixture was concentrated in vacuo and the residue partitioned between aqueous ammonium chloride (200 mL) and ethyl acetate (150 mL). The aqueous layer was extracted with ethyl acetate. The combined organics were washed with water (200 mL), dried (Na₂SO₄) and evaporated in vacuo. The residue was chromatographed on a Biotage cartridge (100 g) eluting with petroleum ether-ethyl acetate, (9:1) to give the title compound (4.6 g) LCMS RT=3.89 min

### iv) N-[3-(4-{[tert-Butyl(dimethyl)silyl]oxy}butyl)phenyl]urea

A stirred solution of 3-(4-{[tert-butyl(dimethyl)silyl]oxy}butyl)aniline (5.16 g) in anhydrous DCM (50 mL), under nitrogen, was treated dropwise with a solution of trichloroacetyl isocyanate (2.36 mL) in anhydrous DCM (6 mL). This was stirred at room temperature for 1 h before adding 2N sodium hydroxide solution (50 mL). The resultant mixture was stirred at 70° C.-80° C. for 5 h. The layers were separated and the aqueous extracted with DCM (50 mL). The combined organics were evaporated in vacuo and the resultant residue chromatographed on a Biotage cartridge (100 g) eluting with ethyl acetate-petroleum ether, (2:1) to give the title compound (5.71 g). LCMS RT=3.78 min

### v) N-[3-(4-Hydroxybutyl)phenyl]urea

A stirred solution of N-[3-(4-{[tert-butyl(dimethyl)silyl]oxy}butyl)phenyl]urea (5.67 g) in THF (50 mL) was treated with trifluoroacetic acid (18.56 mL). The reaction mixture was stirred at room temperature for 1 h and then allowed to stand at room temperature overnight. The reaction mixture was then concentrated in vacuo and the residue azeotroped with methanol. A solution of the residue in methanol (100 mL) was then heated at reflux for 20 h before concentrating in vacuo. The residue was purified by chromatography (Flashmaster, 100 g cartridge, eluting with dichloromethane-methanol, (9:1)) to give the title compound (3.38 g). LCMS RT=2.14 min

### Intermediate 36

### 2-[3-(Cyclopentylsulfonyl)phenyl]ethanol

### i) Methyl (3-mercaptophenyl)acetate

To a solution of 3-mercaptophenylacetic acid (2 g) in methanol (140 mL) was added hydrochloric acid (37%, 1.35 mL) dropwise. The reaction mixture was stirred at room temperature, under nitrogen for 17 h. The reaction mixture was concentrated in vacuo and the residue azeotroped with methanol. The residue was purified by chromatography (SPE, 50 g cartridge, eluting with cyclohexane-ethyl acetate mixture) to give the title compound (0.79 g). LCMS RT=2.76 min

### ii) Methyl [3-(cyclopentylthio)phenyl]acetate

A solution of methyl (3-mercaptophenyl)acetate (200 mg) and cyclopentyl bromide (491 mg) in anhydrous DMF(10 mL) was cooled to 0° C. Sodium hydride (60% dispersion in oil, 53.2 mg) was added portionwise. Stirring was continued at 0° C. for 30 min and was then allowed to warm to room temperature over 4 h. Water was added to the reaction followed with DCM and aqueous sodium bicarbonate solution. The organic layer washed with brine, dried (Na₂SO₄) and evaporated in vacuo. The residue was chromatographed on a Biotage cartridge (8 g) eluting with cyclohexane-ethyl acetate, (5:1) to give the title compound (185 mg) LCMS RT=3.48 min

### iii) Methyl [3-(cyclopentylsulfonyl)phenyl]acetate

To a solution of methyl [3-(cyclopentylthio)phenyl]acetate (180 mg) in dichloromethane (2 mL) at 0° C. was added 3-chloroperoxybenzoic acid (456 mg). The reaction mixture was then stirred at room temperature, under nitrogen, for 5 h. The reaction mixture was then washed with sodium bisulphite solution. The organic layer was passed through a column of Alumina (activated, neutral, Brockmann 1, standard grade ) eluting with cyclohexane-ethyl acetate, (1:1) and concentrated in vacuo to give the title compound (81.9 mg) LCMS RT=2.76 min

### iv) 2-[3-(Cyclopentylsulfonyl)phenyl]ethanol

To a solution of methyl [3-(cyclopentylsulfonyl)phenyl]acetate (81 mg) in anhydrous THF (3 mL) was added lithium aluminium hydride (1 M solution in diethyl ether, 0.172 mL) at room temperature. After 15 min THF followed with dichloromethane and water were added. The organic layer was washed with brine, dried (Na₂SO₄) and concentrated in vacuo. The resultant residue was chromatographed on a Biotage cartridge and eluted with ethyl acetate-cyclohexane, (2:1) to give the title compound (36.4 mg). LCMS RT=2.43 min ES+ve 255 (MH)⁺

### Intermediate 37

### 4-[3-(Cyclopentylsulfonyl)phenyl]butan-1-ol

### i) 1-(Cyclopentylthio)-3-iodobenzene

To a solution of 1-bromo-3-(cyclopentylthio)benzene (117.5 g) in THF (1000 mL) at −72° C. was added butyllithium (1.6M in hexanes, 328 mL). When addition was completed a solution of iodine (139 g) in THF (300 mL) was added dropwise. The reaction mixture was then allowed to warm to 0° C. Water was added cautiously and the mixture partitioned between ethyl acetate and aqueous sodium thiosulphate. The aqueous phase was extracted with ethyl acetate and the combined organics were washed with sodium thiosulphate, water and brine, dried (MgSO₄) and evaporated in vacuo to give the title compound (126.4 g). HPLC RT=2.17 min

### ii) 1-(Cyclopentylsulfonyl)-3-iodobenzene

To a solution of 1-(cyclopentylthio)-3-iodobenzene (112.1 g) in dichloromethane (1600 mL) at 0° C. was added 3-chloroperoxybenzoic acid (278 g) portionwise. After 2.25 h water followed with dichloromethane were added to the reaction mixture. The aqueous phase was extracted with dichloromethane and the combined organics were washed with 1M sodium hydroxide, sodium metabisulphite and water. This was then filtered through Celite and then washed with brine, dried (MgSO₄) and evaporated in vacuo. The resultant residue was dissolved in diethyl ether, washed with 2M sodium hydroxide, water and brine, dried (MgSO₄) and evaporated in vacuo to give the title compound (90 g). LCMS RT=3.27 min

### Intermediate 38

### 4-[3-(Methylsulfonyl)phenyl]butan-1-ol

### i) tert-Butyl(dimethyl){4-[3-(methylsulfonyl)phenyl]butoxy}silane

(But-3-enyloxy)(tert-butyl)dimethylsilane (Angew Chem, 2003, 42, 2521) (1.68 g) was stirred with 9-borabicyclo[3.3.1]nonane (0.5M in THF, 22 mL) in THF (36 mL) at 21° under nitrogen for 2.5 h. Potassium phosphate (3.87 g) in water (5.4 mL) was added followed by palladium acetate (25 mg), triphenylphosphine (48 mg) and 1-bromo-3-(methylsulfonyl)benzene (2.12 g) and stirring was continued for 20 h. The solution was partitioned between water and ethyl acetate. The aqueous layer was extracted with further ethyl acetate and the combined organic layers were washed with brine, dried (MgSO₄) and evaporated. The residue was purified by chromatography twice on silica gel in mixtures of ethyl acetate in 40-60 petroleum ether to give the impure title compound (0.65 g), nmr, 67 (CDCl₃) 7.78 (2H, br s), 7.52-7.47 (2H, m), 3.64 (2H, t, J 6 Hz), 3.06 (3H, s), 2.74 (2H, t J 7 Hz), 1.89-1.45 (4H+water, m), 0.89 (9H, s) 0.05 (6H, s).

### ii) 4-[3-(Methylsulfonyl)phenyl]butan-1-ol

tert-Butyl(dimethyl){4-[3-(methylsulfonyl)phenyl]butoxy}silane (0.62 g) was stirred with tetrabutylammonium fluoride on silica gel (6.8 g) in THF (70 mL) for a total of three days. The mixture was filtered and the filter cake was leached with ethyl acetate. The combined filtrates were evaporated and the residue was purified by chromatography on silica gel in ethyl acetate followed by 10% methanol in ethyl acetate to give the title compound (0.30 g). LCMS RT=2.21 min.

### Example 12

### Formic acid compound with 3-[4-({3-[2-({(2R)-2-Hydroxy-2-[4-hydroxy-3-(hydroxymethyl)phenyl]ethyl}amino)ethyl]benzyl}oxy)butyl]benzenesulfonamide (1:1)

### i) 3-{4-[(3-{2-[(5R)-5-(2,2-Dimethyl-4H-1,3-benzodioxin-6-yl)-2-oxo-1,3-oxazolidin-3-yl]ethyl}benzyl)oxy]butyl}benzenesulfonamide

A solution of 3-(4-hydroxybutyl)benzenesulfonamide (11.47 mg) in DCM (2 mL) was treated with NaOH_{(aq)} (40% w/v, 0.5 mL) with rapid stirring. A solution of (5R)-3-{2-[3-(bromomethyl)phenyl]ethyl}-5-(2,2dimethyl-4H-1,3-benzodioxin-6-yl)-1,3-oxazolidin-2-one (27 mg) in DCM (2 mL) was added followed by tetra-n-butylammonium sulphate (1.4 mg). The reaction mixture was heated at 43° C. for 16 h. The reaction mixture was separated by hydrophobic frit and the organic phase evaporated under nitrogen to give the title compound. LCMS RT=4.46 min

### ii) 3-[4-({3-[2-({(2R)-2-Hydroxy-2-[4-hydroxy-3-(hydroxymethyl)phenyl]ethyl}amino)ethyl]benzyl}oxy)butyl]benzenesulfonamide

A solution of 3-{4-[(3-{2-[(5R)-5-(2,2-dimethyl-4H-1,3-benzodioxin-6-yl)-2-oxo-1,3-oxazolidin-3-yl]ethyl}benzyl)oxy]butyl}benzenesulfonamide in dry THF (2 mL) was treated with potassium trimethylsilanolate (40 mg) and the reaction mixture heated to 75° C. for 1 h. The resultant solution was applied to the top of an SCX-2 ion exchange cartridge (0.5 g, preconditioned with MeOH). The cartridge was washed with MeOH (2.5 mL) and left for 1 h followed by elution with 2N NH₃ in MeOH (2.5 mL) and Mass directed preparative HPLC afforded the title compound. LCMS RT=2.34 min ES+ve m/z 529 (MH)⁺

Similarly prepared were:

| | | | Step 1 | | |
|---|---|---|---|---|---|
| Example | | Intermediate | LCMS | LCMS | ES+ve |
| No. | Name | method | RT | RT | m/z |
| 13 | Formic acid compound with_3-{[2- | Intermediate 1 | 3.47 | 2.50 | 477 |
| | ({3-[2-({(2R)-2-hydroxy-2-[4- | General | | | |
| | hydroxy-3- | Method A | | | |
| | (hydroxymethyl)phenyl]ethyl}amino)- | | | | |
| | ethyl]benzyl}oxy)ethoxy]methyl}- | | | | |
| | benzonitrile (1:1) | | | | |
| 14 | Formic acid compound with_4- | General | 3.78 | 2.75 | 520 |
| | [(1R)-2-({2-[3-({2-[(2,6- | Method A | | | |
| | dichlorobenzyl)oxy]ethoxy}methyl)- | | | | |
| | phenyl]ethyl}amino)-1- | | | | |
| | hydroxyethyl]-2- | | | | |
| | (hydroxymethyl)phenol (1:1) | | | | |
| 15 | Formic acid compound with_4- | General | 3.58 | 2.58 | 470 |
| | [(1R)-2-({2-[3-({2-[(3- | Method A | | | |
| | fluorobenzyl)oxy]ethoxy}methyl)phenyl]- | | | | |
| | ethyl}amino)-1-hydroxyethyl]- | | | | |
| | 2-(hydroxymethyl)phenol (1:1) | | | | |
| 16 | Formic acid compound with_4- | General | 3.76 | 2.72 | 4.80 |
| | [(1R)-2-({2-[3-({2-[(3,5- | Method A | | | |
| | dimethylbenzyl)oxy]ethoxy}methyl)- | | | | |
| | phenyl]ethyl}amino)-1- | | | | |
| | hydroxyethyl]-2- | | | | |
| | (hydroxymethyl)phenol (1:1) | | | | |
| 17 | Formic acid compound with_4- | General | 3.54 | 2.52 | 482 |
| | [(1R)-1-hydroxy-2-({2-[3-({2-[(3- | Method A | | | |
| | methoxybenzyl)oxy]ethoxy}methyl)- | | | | |
| | phenyl]ethyl}amino)ethyl]-2- | | | | |
| | (hydroxymethyl)phenol (1:1) | | | | |
| 18 | Formic acid compound with_2- | General | 3.76 | 2.82 | 536 |
| | (hydroxymethyl)-4-{(1R)-1- | Method A | | | |
| | hydroxy-2-[(2-{3-[(2-{[3- | | | | |
| | (trifluoromethoxy)benzyl]oxy}ethoxy)- | | | | |
| | methyl]phenyl}ethyl)amino]ethyl}- | | | | |
| | phenol (1:1) | | | | |
| 19 | Formic acid compound with_4- | Intermediate 2 | 3.72 | 2.18 | 466 |
| | ((1R)-1-hydroxy-2-{[2-(3-{[4-(3- | General | | | |
| | hydroxyphenyl)butoxy]methyl}phenyl)- | Method B | | | |
| | ethyl]amino}ethyl)-2- | | | | |
| | (hydroxymethyl)phenol (1:1) | | | | |
| 20 | Formic acid compound with_4-[3- | General | 3.59 | 2.21 | 461 |
| | ({3-[2-({(2R)-2-hydroxy-2-[4- | Method B | | | |
| | hydroxy-3- | | | | |
| | (hydroxymethyl)phenyl]ethyl}amino)- | | | | |
| | ethyl]benzyl}oxy)propyl]benzonitrile | | | | |
| | (1:1) | | | | |
| 21 | Formic acid compound with_4-[4- | General | 3.67 | 2.30 | 475 |
| | ({3-[2-({(2R)-2-hydroxy-2-[4- | Method B | | | |
| | hydroxy-3- | | | | |
| | (hydroxymethyl)phenyl]ethyl}amino)- | | | | |
| | ethyl]benzyl}oxy)butyl]benzonitrile | | | | |
| | (1:1) | | | | |
| 22 | Formic acid compound with_3-[3- | General | 3.57 | 2.21 | 461 |
| | ({3-[2-({(2R)-2-hydroxy-2-[4- | Method B | | | |
| | hydroxy-3- | | | | |
| | (hydroxymethyl)phenyl]ethyl}amino)- | | | | |
| | ethyl]benzyl}oxy)propyl]benzonitrile | | | | |
| | (1:1) | | | | |
| 23 | Formic acid compound with_2- | Intermediate 3 | 3.38 | 2.46 | 514 |
| | (hydroxymethyl)-4-[(1R)-1- | General | | | |
| | hydroxy-2-({2-[3-({3-[4- | Method C | | | |
| | (methylsulfonyl)phenyl]propoxy}methyl)- | | | | |
| | phenyl]ethyl}amino)ethyl]phenol | | | | |
| | (1:1) | | | | |
| 24 | Formic acid compound with_2- | General | 3.27 | 2.34 | 486 |
| | (hydroxymethyl)-4-[(1R)-1- | Method C | | | |
| | hydroxy-2-({2-[3-({[4- | | | | |
| | (methylsulfonyl)benzyl]oxy}methyl)- | | | | |
| | phenyl]ethyl}amino)ethyl]phenol | | | | |
| | (1:1) | | | | |
| 25 | Formic acid compound with_4- | Intermediate 4 | 4.11 | 2.44 | 438 |
| | ((1R)-1-hydroxy-2-{[2-(3-{[2-(2- | General | | | |
| | hydroxyphenyl)ethoxy]methyl}phenyl)- | Method D | | | |
| | ethyl]amino}ethyl)-2- | | | | |
| | (hydroxymethyl)phenol (1:1) | | | | |
| 26 | Formic acid compound with_4- | General | 4.06 | 2.38 | 424 |
| | ((1R)-1-hydroxy-2-{[2-(3-{[(4- | Method D | | | |
| | hydroxybenzyl)oxy]methyl}phenyl)- | | | | |
| | ethyl]amino}ethyl)-2- | | | | |
| | (hydroxymethyl)phenol (1:1) | | | | |
| 27 | Formic acid compound with_4- | General | 4.10 | 2.44 | 438 |
| | ((1R)-1-hydroxy-2-{[2-(3-{[3-(2- | Method C & D | | | |
| | hydroxyphenyl)propoxy]methyl}phenyl)- | | | | |
| | ethyl]amino}ethyl)-2- | | | | |
| | (hydroxymethyl)phenol (1:1) | | | | |
| 28 | Formic acid compound with_4- | General | .16 | 2.5 | 452 |
| | ((1R)-1-hydroxy-2-{[2-(3-{[3-(3- | Method C & D | | | |
| | hydroxyphenyl)propoxy]methyl}phenyl)- | | | | |
| | ethyl]amino}ethyl)-2- | | | | |
| | (hydroxymethyl)phenol (1:1) | | | | |
| 29 | Formic acid compound with_4- | General | 3.73 | 2.38 | 582 |
| | [(1R)-2-({2-[3-({4-[4- | Method E & B | | | |
| | (cyclopentylsulfonyl)phenyl]butoxy}- | | | | |
| | methyl)phenyl]ethyl}amino)-1- | | | | |
| | hydroxyethyl]-2- | | | | |
| | (hydroxymethyl)phenol (1:1) | | | | |
| 30 | Formic acid compound with_4- | General | 3.65 | 2.30 | 568 |
| | [(1R)-2-({2-[3-({3-[4- | Method E & B | | | |
| | (cyclopentylsulfonyl)phenyl]propoxy}- | | | | |
| | methyl)phenyl]ethyl}amino)-1- | | | | |
| | hydroxyethyl]-2- | | | | |
| | (hydroxymethyl)phenol (1:1) | | | | |
| 31 | Formic acid compound with_4- | General | 3.65 | 2.29 | 568 |
| | [(1R)-2-({2-[3-({3-[3- | Method E & B | | | |
| | (cyclopentylsulfonyl)phenyl]propoxy}- | | | | |
| | methyl)phenyl]ethyl}amino)-1- | | | | |
| | hydroxyethyl]-2- | | | | |
| | (hydroxymethyl)phenol (1:1) | | | | |
| 32 | Formic acid compound with_4- | Intermediate | 4.03 | 2.34 | 468 |
| | [(1R)-1-hydroxy-2-({2-[3-({2-[(3- | 26 | | | |
| | hydroxybenzyl)oxy]ethoxy}methyl)- | | | | |
| | phenyl]ethyl}amino)ethyl]-2- | | | | |
| | (hydroxymethyl)phenol (1:1) | | | | |
| 33 | Formic acid compound with_4- | Intermediate | 3.52 | 2.60 | 584 |
| | {(1R)-2-[(2-{3-[(2-{[3- | 28 | | | |
| | (cyclopentylsulfonyl)benzyl]oxy}ethoxy)- | | | | |
| | methyl]phenyl}ethyl)amino]-1- | | | | |
| | hydroxyethyl}-2- | | | | |
| | (hydroxymethyl)phenol (1:1) | | | | |
| 34 | 4 Formic acid compound with_4- | Intermediate | 3.41 | 2.58 | 568 |
| | {(1R)-2-[(2-{3-[(2-{[3- | 29 | | | |
| | (cyclopentylsulfinyl)benzyl]oxy}ethoxy)- | | | | |
| | methyl]phenyl}ethyl)amino]-1- | | | | |
| | hydroxyethyl}-2- | | | | |
| | (hydroxymethyl)phenol (1:1) | | | | |
| 35 | Formic acid compound with_4- | Intermediate | 3.56 | 2.18 | 540 |
| | [(1R)-2-({2-[3-({[3- | 20 | | | |
| | (cyclopentylsulfonyl)benzyl]oxy}methyl)- | | | | |
| | phenyl]ethyl}amino)-1- | | | | |
| | hydroxyethyl]-2- | | | | |
| | (hydroxymethyl)phenol (1:1) | | | | |
| 36 | Formic acid compound with_4- | Intermediate | 3.61 | 2.71 | 566 |
| | [(1R)-2-({2-[3-({4-[3- | 30 | | | |
| | (cyclopentylsulfinyl)phenyl]butoxy}- | | | | |
| | methyl)phenyl]ethyl}amino)-1- | | | | |
| | hydroxyethyl]-2- | | | | |
| | (hydroxymethyl)phenol (1:1) | | | | |
| 37 | Formic acid compound with_3-[4- | Commercial | 3.49 | 2.29 | 475 |
| | ({3-[2-({(2R)-2-hydroxy-2-[4- | intermediate | | | |
| | hydroxy-3- | | | | |
| | (hydroxymethyl)phenyl]ethyl}amino)- | | | | |
| | ethyl]benzyl}oxy)butyl]benzonitrile | | | | |
| | (1:1) | | | | |
| 38 | Formic acid compound with_2- | Commercial | 3.58 | 2.52 | 438 |
| | (hydroxymethyl)-4-{(1R)-1- | intermediate | | | |
| | hydroxy-2-[(2-{3-[(2- | | | | |
| | phenoxyethoxy)methyl]phenyl}ethyl)- | | | | |
| | amino]ethyl}phenol (1:1) | | | | |
| 39 | Formic acid compound with_4- | Commercial | 3.65 | 2.63 | 4.40 |
| | ((1R)-2-{[2-(3-{[2-(3- | Intermediate | | | |
| | fluorophenyl)ethoxy]methyl}phenyl)- | | | | |
| | ethyl]amino}-1-hydroxyethyl)-2- | | | | |
| | (hydroxymethyl)phenol (1:1) | | | | |
| 40 | Formic acid compound with_4- | Commercial | 3.63 | 2.64 | 440 |
| | ((1R)-2-{[2-(3-{[2-(4- | Intermediate | | | |
| | fluorophenyl)ethoxy]methyl}phenyl)- | | | | |
| | ethyl]amino}-1-hydroxyethyl)-2- | | | | |
| | (hydroxymethyl)phenol (1:1) | | | | |
| 41 | Formic acid compound with_4- | Commercial | 3.65 | 2.63 | 440 |
| | ((1R)-2-{[2-(3-{[2-(2- | Intermediate | | | |
| | fluorophenyl)ethoxy]methyl}phenyl)- | | | | |
| | ethyl]amino}-1-hydroxyethyl)-2- | | | | |
| | (hydroxymethyl)phenol (1:1) | | | | |
| 42 | Formic acid compound with_3-[({3- | Commercial | 3.48 | 2.5 | 433 |
| | [2-({(2R)-2-hydroxy-2-[4-hydroxy- | Intermediate | | | |
| | 3- | | | | |
| | (hydroxymethyl)phenyl]ethyl}amino)- | | | | |
| | ethyl]benzyl}oxy)methyl]benzonitrile | | | | |
| | (1:1) | | | | |
| 43 | Formic acid compound with_4-[({3- | Commercial | 3.48 | 2.51 | 433 |
| | [2-({(2R)-2-hydroxy-2-[4-hydroxy- | Intermediate | | | |
| | 3- | | | | |
| | (hydroxymethyl)phenyl]ethyl}amino)- | | | | |
| | ethyl]benzyl}oxy)methyl]benzonitrile | | | | |
| | (1:1) | | | | |
| 44 | Formic acid compound with_2- | Commercial | 3.67 | 2.63 | 422 |
| | (hydroxymethyl)-4-[(1R)-1- | Intermediate | | | |
| | hydroxy-2-({2-[3-({[(1R)-1- | | | | |
| | phenylethyl]oxy}methyl)phenyl]ethyl}- | | | | |
| | amino)ethyl]phenol (1:1) | | | | |
| 45 | Formic acid compound with_2- | Commercial | 3.65 | 2.18 | 422 |
| | (hydroxymethyl)-4-[(1R)-1- | Intermediate | | | |
| | hydroxy-2-({2-[3-({[(1S)-1- | | | | |
| | phenylethyl]oxy}methyl)phenyl]ethyl}- | | | | |
| | amino)ethyl]phenol (1:1) | | | | |
| 46 | Formic acid compound with_4- | Commercial | 3.76 | 2.73 | 436 |
| | ((1R)-2-{[2-(3-{[(3,5- | Intermediate | | | |
| | dimethylbenzyl)oxy]methyl}phenyl)- | | | | |
| | ethyl]amino}-1-hydroxyethyl)-2- | | | | |
| | (hydroxymethyl)phenol (1:1) | | | | |
| 47 | Formic acid compound with_4- | Commercial | 3.78 | 2.72 | 478 |
| | ((1R)-2-{[2-(3-{[(2,6- | Intermediate | | | |
| | dichlorobenzyl)oxy]methyl}phenyl)- | | | | |
| | ethyl]amino}-1-hydroxyethyl)-2- | | | | |
| | (hydroxymethyl)phenol (1:1) | | | | |
| 48 | Formic acid compound with_4- | Commercial | 3.59 | 2.12 | 426 |
| | ((1R)-2-{[2-(3-{[(2- | Intermediate | | | |
| | fluorobenzyl)oxy]methyl}phenyl)ethyl]- | | | | |
| | amino}-1-hydroxyethyl)-2- | | | | |
| | (hydroxymethyl)phenol (1:1) | | | | |
| 49 | Formic acid compound with_4- | Commercial | 3.59 | 2.58 | 4.26 |
| | ((1R)-2-{[2-(3-{[(3- | Intermediate | | | |
| | fluorobenzyl)oxy]methyl}phenyl)ethyl]- | | | | |
| | amino}-1-hydroxyethyl)-2- | | | | |
| | (hydroxymethyl)phenol (1:1) | | | | |
| 50 | Formic acid compound with_4- | Commercial | 3.61 | 2.13 | 426 |
| | ((1R)-2-{[2-(3-{[(4- | Intermediate | | | |
| | fluorobenzyl)oxy]methyl}phenyl)ethyl]- | | | | |
| | amino}-1-hydroxyethyl)-2- | | | | |
| | (hydroxymethyl)phenol (1:1) | | | | |

### Example 51

### Formic acid compound with 3-[4-({3-[2-({(2R)-2-Hydroxy-2-[4-hydroxy-3-(hydroxymethyl)phenyl]ethyl}amino)ethyl]benzyl}oxy)butyl]benzamide (1:1)

### i) 3-{4-[(3-{2-[(5R)-5-(2,2-Dimethyl-4H-1,3-benzodioxin-6-yl)-2-oxo-1,3-oxazolidin-3-yl]ethyl}benzyl)oxy]butyl}benzonitrile

Prepared similarly to Example 13 (i). LCMS RT=2.01 min

### ii) Formic acid compound with 3-[4-({3-[2-({(2R)-2-Hydroxy-2-[4-hydroxy-3-(hydroxymethyl)phenyl]ethyl}amino)ethyl]benzyl}oxy)butyl]benzamide (1:1)

A solution of crude 3-{4-[(3-{2-[(5R)-5-(2,2-dimethyl-4H-1,3-benzodioxin-6-yl)-2-oxo-1,3-oxazolidin-3-yl]ethyl}benzyl)oxy]butyl}benzonitrile in dry THF (2 mL) was treated with potassium trimethylsilanolate (40 mg) and the reaction mixture heated to 150° C. for 2 min in a microwave (150 watts). The resultant solution was applied to the top of an SCX-2 ion exchange cartridge (0.5 g, preconditioned with MeOH). The cartridge was washed with MeOH (2.5 mL) and left for 1 hr. The title compound was eluted with 2N NH₃ in MeOH (2.5 mL). Mass directed preparative HPLC afforded the title compound. LCMS RT=2.47 min ES+ve m/z 493 (MH)⁺

Similarly prepared were:

| | | Step 1 | | |
|---|---|---|---|---|
| Example | | LCMS | LCMS | ES+ve |
| No | Name | RT | RT | m/z |
| 52 | Formic acid compound with_3-{[2-({3-[2-({(2R)-2- | 3.47 | 2.28 | 495 |
| | hydroxy-2-[4-hydroxy-3- | | | |
| | (hydroxymethyl)phenyl]ethyl}amino)ethyl]benzyl} | | | |
| | oxy)ethoxy]methyl}benzamide (1:1) | | | |
| 53 | Formic acid compound with_3-[({3-[2-({(2R)-2- | 3.48 | 2.26 | 451 |
| | hydroxy-2-[4-hydroxy-3- | | | |
| | (hydroxymethyl)phenyl]ethyl}amino)ethyl]benzyl} | | | |
| | oxy)methyl]benzamide (1:1) | | | |
| 54 | Formic acid compound with_4-[({3-[2-({(2R)-2- | 3.48 | 2.26 | 451 |
| | hydroxy-2-[4-hydroxy-3- | | | |
| | (hydroxymethyl)phenyl]ethyl}amino)ethyl]benzyl} | | | |
| | oxy)methyl]benzamide (1:1) | | | |

### Example 55

### Formic acid compound with 3-[2-({3-[2-({(2R)-2-hydroxy-2-[4-hydroxy-3-(hydroxymethyl)(phenyl]ethyl}amino)ethyl]benzyl}oxy)ethyl]benzenesulfonamide (1:1)

### i) 3-{2-{(3-[2-[(5R)-5-(2,2-Dimethyl-4H-1,3-benzodioxin-6-yl)-2-oxo-1,3-oxazolidin-3-yl]ethyl}benzyl)oxy]ethyl}-N,N-bis{[2-(trimethylsilyl)ethoxy]methyl}benzenesulfonamide

A solution of 3-(2-hydroxyethyl)-N,N-bis{[2-(trimethylsilyl)ethoxy]methyl}benzenesulfonamide (86 mg) in DCM (1.5 mL) was treated with NaOH_{(aq)} (40% w/v, 0.5 mL) with rapid stirring. A solution of (5R)-3-{2-[3-(bromomethyl)phenyl]ethyl}-5-(2,2-dimethyl-4H-1,3-benzodioxin-6-yl)-1,3-oxazolidin-2-one (100 mg) in DCM (0.5 mL) was added followed by tetrabutylammonium bromide (6 mg). The reaction mixture was heated at 40° C. for 16 h. the reaction mixture was separated by hydrophobic frit and the organic phase evaporated under nitrogen to give the title compound. LCMS RT=3.35 min

### ii) 3-(2-{[3-(2-{[(2R)-2-(2,2-Dimethyl-4H-1,3-benzodioxin-6-yl)-2-hydroxyethyl]amino}ethyl)benzyl]oxy}ethyl)-N,N-bis{[2-(trimethylsilyl)ethoxy]methyl}benzenesulfonamide

A solution of 3-{2-[(3-{2-[(5R-5-(2,2-dimethyl-4H-1,3-benzodioxin-6-yl)-2-oxo-1,3-oxazolidin-3-yl]ethyl}benzyl)oxy]ethyl}-N,N-bis{[2-(trimethylsilyl)ethoxy]methyl}benzenesulfonamide in dry THF (1 mL) was treated with potassium trimethylsilanolate (215 mg) and the reaction mixture heated to 75° C. for 4 h. After cooling, DCM (1 mL) was added followed with 2N sodium bicarbonate solution (1 mL). The reaction mixture was separated by hydrophobic frit and the organic phase evaporated under nitrogen to give the title compound. LCMS RT=3.61 min

### iii) Formic acid compound with 3-[2-({3-[2-({(2R)-2-hydroxy-2-[4-hydroxy-3-(hydroxymethyl)phenyl]ethyl}amino)ethyl]benzyl}oxy)ethyl]benzenesulfonamide (1:1)

A solution of 3-(2-{[3-(2-{[(2R)-2-(2,2-dimethyl-4H-1,3-benzodioxin-6-yl)-2-hydroxyethyl]amino}ethyl)benzyl]oxy}ethyl)-N,N-bis{[2-(trimethylsilyl)ethoxy]methyl}benzenesulfonamide in acetic acid (1 mL) and water (1 mL) was heated at 70° C. for 10 h. The reaction mixture was evaporated under nitrogen and Mass directed preparative HPLC afforded the title compound. LCMS RT=2.20 min ES+ve 501 (MH)⁺

Similarly prepared were:

### Examples 56-59

For the compounds of Examples 57, 58 and 59 reaction mixtures in acetic acid and water were heated at 70° C. for 45 min.

Similarly prepared were:

| | | | Step | Step | | |
|---|---|---|---|---|---|---|
| | | | (i) | (ii) | | ES |
| Example | | Intermediate | LCMS | LCMS | LCMS | +ve |
| No. | Name | method | RT | RT | RT | m/z |
| 56 | Formic acid compound with 3- | Intermediate | 4.47 | 3.60 | 2.28 | 515 |
| | [3-({3-[2-({(2R)-2-hydroxy-2-[4- | 33 | | | | |
| | hydroxy-3- | | | | | |
| | (hydroxymethyl)phenyl]ethyl}amino)- | | | | | |
| | ethyl]benzyl}oxy)propyl]benzenesulfonamide | | | | | |
| | (1:1) | | | | | |
| 57 | Formic acid compound with 4- | Intermediate | 4.11 | 3.19 | 2.90 | 518 |
| | ((1R)-2-{[2-(3-{[4-(2,6- | 34 | | | | |
| | dichlorophenyl)butoxy]methyl}phenyl)- | | | | | |
| | ethyl]amino}-1- | | | | | |
| | hydroxyethyl)-2- | | | | | |
| | (hydroxymethyl)phenol (1:1) | | | | | |
| 58 | Formic acid compound with N- | Intermediate | 2.98 | 2.40 | 2.12 | 508 |
| | {3-[4-({3-[2-({(2R)-2-hydroxy-2- | 35 | | | | |
| | [4-hydroxy-3- | | | | | |
| | (hydroxymethyl)phenyl]ethyl}amino)- | | | | | |
| | ethyl]benzyl}oxy)butyl]phenyl} | | | | | |
| | urea (1:1) | | | | | |
| 59 | Formic acid compound with 2- | CAS 4799-66-0 | 3.67 | 2.76 | 2.46 | 466 |
| | (hydroxymethyl)-4-((1R)-1- | | | | | |
| | hydroxy-2-{[2-(3-{[2-(1- | | | | | |
| | phenylethoxy)ethoxy]methyl}phenyl)- | | | | | |
| | ethyl]amino}ethyl)phenol | | | | | |
| | (1:1) | | | | | |

### Example 60

### Formic acid compound with 4-[(1R)-2-({2-[3-({2-[3-(cyclopentylsulfonyl)phenyl]ethoxy}methyl)phenyl]ethyl}amino)-1-hydroxyethyl]-2-(hydroxymethyl)phenol (1:1)

### (i) (5R)-3-{2-[3-({2-[3-(Cyclopentylsulfonyl)phenyl]ethoxy}methyl)phenyl]ethyl}-5-(2,2-dimethyl-4H-1,3-benzodioxin-6-yl)-1,3-oxazolidin-2-one

Sodium hydride (9 mg) was added to a solution of 2-[3-(cyclopentylsulfonyl)phenyl]ethanol (41 mg) in dry DMF (0.5 mL). A solution of (5R)-3-{2-[3-(bromomethyl)phenyl]ethyl}-5-(2,2-dimethyl-4H-1,3-benzodioxin-6-yl)-1,3-oxazolidin-2-one (100 mg) in dry DMF (0.5 mL) was added and stirring was continued for 16 h at room temperature. Water (0.5 mL) was added followed by dichloromethane (1 mL). The reaction mixture was separated by hydrophobic frit and the organic phase evaporated under nitrogen to give the title compound. LCMS RT=3.63 min.

### (ii) (5R)-3-{2-[3-({2-[3-(Cyclopentylsulfonyl)phenyl]ethoxy}methyl)phenyl]ethyl}-5-(2,2-dimethyl-4H-1,3-benzodioxin-6-yl)-1,3-oxazolidin-2-one

Prepared similarly to example 55 (ii) LCMS RT=2.82 min

### (iii) Formic acid compound with 4-[(1R)-2-({2-[3-({2-[3-(cyclopentylsulfonyl)phenyl]ethoxy}methyl)phenyl]ethyl}amino)-1-hydroxyethyl]-2-(hydroxymethyl)phenol (1:1)

Prepared similarly to example 55 (iii). LCMS RT=2.56 min. ES+ve m/z 554 (MH)⁺

Similarly prepared were:

| | | | Step (i) | Step (ii) | | ES |
|---|---|---|---|---|---|---|
| Example | | Intermediate | LCMS | LCMS | LCMS | +ve |
| No. | Name | method | RT | RT | RT | m/z |
| 61 | Formic acid compound with | Intermediate | 3.75 | 2.94 | 2.65 | 582 |
| | 4-[(1R)-2-({2-[3-({4-[3- | 38 | | | | |
| | (cyclopentylsulfonyl)phenyl]butoxy}- | | | | | |
| | methyl)phenyl]ethyl}amino)- | | | | | |
| | 1-hydroxyethyl]-2- | | | | | |
| | (hydroxymethyl)phenol (1:1) | | | | | |
| 62 | Formic acid compound with | Intermediate | 3.51 | 2.74 | 2.42 | 528 |
| | 2-(hydroxymethyl)-4-[(1R)-1- | 39 | | | | |
| | hydroxy-2-({2-[3-({4-[3- | | | | | |
| | (methylsulfonyl)phenyl]butoxy}- | | | | | |
| | methyl)phenyl]ethyl}amino)ethyl]- | | | | | |
| | phenol (1:1) | | | | | |

### Example 63

### Formic acid compound with 4-((1R)-2-{[2-(3-{[3-(2,6-dichlorophenyl) propoxy]methyl}phenyl)ethyl]amino}-1-hydroxyethyl)-2-(hydroxymethyl)phenol (1:1 )

### i) (5R)-3-[2-(3-{[3-(2,6-Dichlorophenyl)propoxy]methyl}phenyl)ethyl]-5-(2,2-dimethyl-4H-1,3-benzodioxin-6-yl)-1,3-oxazolidin-2-one

Sodium hydride (7.3 mg) was added to a stirred solution of (5R)-5-(2,2-dimethyl-4H-1,3-benzodioxin-6-yl)-3-{2-[3-(hydroxymethyl)phenyl]ethyl}-1,3-oxazolidin-2-one (50 mg) in anhydrous DMF (2 ml). A solution of 2-(3-bromopropyl)-1,3-dichlorobenzene (CAS 14573-25-2) (48.7 mg) in anhydrous DMF (2 mL) was added and stirring was continued at room temperature, under nitrogen for 60 h. Water was added followed by DCM (1 mL). The reaction mixture was separated by hydrophobic frit and the organic phase evaporated under nitrogen to give the title compound. LCMS RT=4.01 min

### ii) (1R)-2-{[2-(3-{[3-(2,6-Dichlorophenyl)propoxy]methyl}phenyl)ethyl]amino}-1-(2,2-dimethyl-4H-1,3-benzodioxin-6-yl)ethanol

Prepared using similar methods to those in General Method B ii) LCMS RT=3.09 min

### iii) Formic acid compound with 4-((1R)-2-{[2-(3-{[3-(2,6-dichlorophenyl)propoxy]methyl}phenyl)ethyl]amino}-1-hydroxyethyl)-2-(hydroxymethyl)phenol (1:1)

Prepared using similar methods to those in Example 55 iii) LCMS RT=2.79 min ES+ve m/z 504

### Example 64

### 3-[({3-[2-({(2R)-2-Hydroxy-2-[4-hydroxy-3-(hydroxymethyl)phenyl]ethyl}amino)ethyl]benzyl}oxy)methyl]benzenesulfonamide acetate

### i) 3-{[(3-{2-[(5R)-5-(2,2-Dimethyl-4H-1,3-benzodioxin-6-yl)-2-oxo-1,3-oxazolidin-3-yl]ethyl}benzyl)oxy]methyl}-N,N-bis{[2-(trimethylsilyl)ethoxy]methyl}benzenesulfonamide

Prepared with Intermediate 32 and CAS 503068-53-9 using similar methods to those in Example 55 i) LCMS RT=4.42 min

### ii) 3-({[3-(2-{[(2R)-2-(2,2-Dimethyl-4H-1,3-benzodioxin-6-yl)-2-hydroxyethyl]amino}ethyl)benzyl]oxy}methyl)-N,N-bis{[2-(trimethylsilyl)ethoxy]methyl}benzenesulfonamide

Prepared using similar methods to those in Example 55 ii) LCMS RT=3.57 min

### iii) 3-[({3-[2-({(2R)-2-Hydroxy-2-[4-hydroxy-3-(hydroxymethyl)phenyl]ethyl}amino)ethyl]benzyl}oxy)methyl]benzenesulfonamide acetate

A solution of 3-({[3-(2-{[(2R)-2-(2,2-dimethyl-4H-1,3-benzodioxin-6-yl)-2-hydroxyethyl]amino}ethyl)benzyl]oxy}methyl-N,N-bis{[2-(trimethylsilyl)ethoxy]methyl}benzenesulfonamide (100 mg) in acetic acid (6 mL) and water (2 mL) was heated at 70° C., under nitrogen for 5 h. The reaction was then concentrated in vacuo and the residue chromatographed on a Biotage cartridge (12 g) eluting with dichloromethane-ethanol-ammonia solution (100:8:1, then 50:8:1) to give the title compound (3 mg) LCMS RT=2.20 min ES+ve 487 (MH)⁺

Biological Activity

In Vitro Measurements of Compound Potency and Intrinsic Activity at the Human Beta 1, 2 and 3 Receptors.

Method 1

The potencies of the compounds of Examples 1-11 were determined using frog melanophores transfected with the human beta 2 adrenoreceptor. The cells were incubated with melatonin to induce pigment aggregation. Pigment dispersal was induced by compounds acting on the human beta 2 adrenoreceptor. The beta 2 agonist activity of test compounds was assessed by their ability to induce a change in light transmittance across a melanophore monolayer (a consequence of pigment dispersal). At the human beta 2 adrenoreceptor, compounds of said examples had EC₅₀ values below 1 μM.

Method 2

Potency of compounds of the invention at the human beta 2, 1 and 3 receptors was also determined using Chinese hamster ovary cells co-expressing the human receptor with a reporter gene. Studies were performed using either whole cells or membranes derived from those cells.

The three beta-receptors are coupled via the Gs G-protein to cause a simulation of adenylate cyclase resulting in increased levels of cAMP in the cell. For direct cAMP measurements either membranes or cells have been used with either the HitHunter enzyme fragment complementation kit (DiscoveRx) or the FP² fluorescence polarisation kit (Perkin Elmer) to quantify the levels of cAMP present. These assays provide a measure of agonist potency and intrinsic activity of the compounds at the various receptors.

The reporter gene in the cells has also been used to quantify potency at the beta 1 and 3 receptors. This is a reporter of cAMP levels using the cAMP response element upstream of a firefly luciferase gene. After stimulation of the receptor with an agonist an increase in the level of luciferase is measured as a quantification of the level of cAMP in the cell.

In this assay the potency of compounds at the human beta-2 receptor is expressed as a pEC₅₀ value. Compounds of examples 12-26, 28-50 and 52-64 had pEC₅₀ values greather than 6. The compound example 27 had a pEC₅₀ of less than 6. No result is available for the compound of example 51.

What is claimed is:

1. A compound of formula (I): 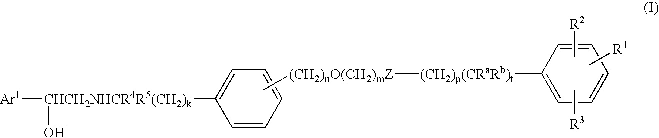
or a salt, solvate, or physiologically functional derivative thereof, wherein:
R¹ is selected from hydrogen, C₁₋₆alkyl, hydroxy, cyano, nitro, halo, C₁₋₆haloalkyl, XCO₂R⁸, —XC(O)NR⁷R⁸, —XNR⁶C(O)R⁷, —XNR⁶C(O)NR⁷R⁸, —XNR⁶C(O)NC(O)NR⁷R⁸, —XNR⁶SO₂R⁷, —XSO₂NR⁹R¹⁰, XSR⁶, XSOR⁶, XSO₂R⁶, —XNR⁷R⁸, —XNR⁶C(O)OR⁷,
or R¹ is selected from -X-aryl, -X-hetaryl, or -X-(aryloxy), each optionally substituted by 1 or 2 groups independently selected from hydroxy, C₁₋₆alkoxy, halo, C₁₋₆alkyl, C₁₋₆haloalkyl, —NR⁶C(O)R⁷, SR⁶, SOR⁶, —SO₂R⁶, —SO₂NR⁹R¹⁰, —CO₂R⁸, —NR⁷R⁸, or hetaryl optionally substituted by 1 or 2 groups independently selected from hydroxy, C₁₋₆alkoxy, halo, C₁₋₆alkyl, or C₁₋₆haloalkyl;
X is —(CH₂)_{q}— or C₂₋₆ alkenylene;
q is an integer from 0 to 6;
R⁶ and R⁷ are independently selected from hydrogen, C₁₋₆alkyl, C₃₋₇cycloalkyl, aryl, hetaryl, hetaryl(C₁₋₆alkyl)- and aryl(C₁₋₆alkyl)- and R⁶ and R⁷ are each independently optionally substituted by 1 or 2 groups independently selected from halo, C₁₋₆alkyl, C₃₋₇ cycloalkyl, C₁₋₆ alkoxy, C₁₋₆haloalkyl, —NHC(O)(C₁₋₆alkyl), —SO₂(C₁₋₆alkyl), —SO₂(aryl), —CO₂H, and —CO₂(C₁₋₄alkyl), —NH₂, —NH(C₁₋₆alkyl), aryl(C₁₋₆alkyl)-, aryl(C₂₋₆alkenyl)-, aryl(C₂₋₆alkynyl)-, hetaryl(C₁₋₆alkyl)-, —NHSO₂aryl, —NH(hetarylC₁₋₆alkyl), —NHSO₂hetaryl, —NHSO₂(C₁₋₆alkyl), —NHC(O)aryl, or —NHC(O)hetaryl:
R⁸ is selected from hydrogen, C₁₋₆alkyl and C₃₋₇ cycloalkyl;
or R⁷ and R⁸, together with the nitrogen atom to which they are bonded, form a 5-, 6- or 7-membered nitrogen-containing ring;
R⁹ and R¹⁰ are independently selected from hydrogen, C₁₋₆alkyl, C₃₋₇cycloalkyl, aryl, hetaryl, hetaryl(C₁₋₆alkyl)- and aryl(C₁₋₆alkyl)-, or R⁹ and R¹⁰, together with the nitrogen to which they are bonded, form a 5-, 6-, or 7-membered nitrogen containing ring;
and R⁹ and R¹⁰ are each optionally substituted by one or two groups independently selected from halo, C₁₋₆alkyl, and C₃₋₇cycloalkyl, C₁₋₆haloalkyl;
R² is selected from hydrogen, hydroxy, C₁₋₆alkyl, C₁₋₆alkoxy, halo, aryl, aryl(C₁₋₆alkyl)-, C₁₋₆haloalkoxy, and C₁₋₆haloalkyl;
R³ is selected from hydrogen, hydroxy, C₁₋₆alkyl, C₁₋₆alkoxy, halo, aryl, aryl(C₁₋₆alkyl)-, C₁₋₆haloalkoxy, and C₁₋₆haloalkyl; and
R⁴ and R⁵ are independently selected from hydrogen and C₁₋₄ alkyl with the proviso that the total number of carbon atoms in R⁴ and R⁵ is not more than 4;
R^{a} and R^{b} each independently represent hydrogen or C₁₋₄alkyl;
Ar¹ is a group selected from 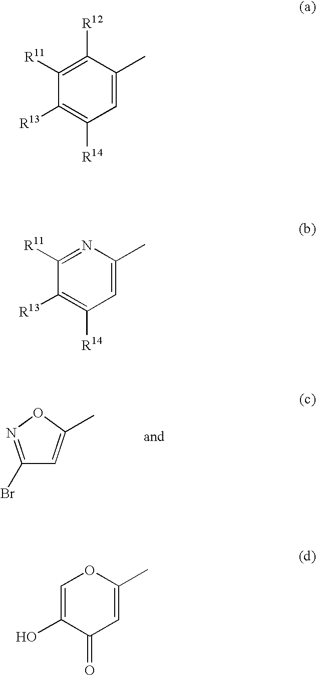
wherein R¹¹ represents hydrogen, halogen, —(CH₂)ᵣOR¹⁵, —NR¹⁵C(O)R¹⁶, —NR¹⁵SO₂R¹⁶, —SO₂NR¹⁵R¹⁶, —NR¹⁵R¹⁶, —OC(O)R¹⁷ or OC(O)NR¹⁵R¹⁶, and R¹² represents hydrogen, halogen or C₁₋₄ alkyl;
or R¹¹ represents —NHR¹⁸ and R¹² and —NH R¹⁸ together form a 5- or 6-membered heterocyclic ring;
R¹³ represents hydrogen, halogen, —OR¹⁵ or —NR¹⁵R¹⁶;
R¹⁴ represents hydrogen, halogen, haloC₁₋₄ alkyl, —OR¹⁵, —NR¹⁵R¹⁶, —OC(O)R¹⁷ or OC(O)NR¹⁵R¹⁶;
R¹⁵ and R¹⁶ each independently represents hydrogen or C₁₋₄ alkyl, or in the groups
—NR¹⁵R¹⁶, —SO₂NR¹⁵R¹⁶ and —OC(O)NR¹⁵R¹⁶, R¹⁵ and R¹⁶ independently represent hydrogen or C₁₋₄ alkyl or together with the nitrogen atom to which they are attached form a 5-, 6- or 7-membered nitrogen-containing ring,
R¹⁷ represents an aryl group which may be unsubstituted or substituted by one or more substituents selected from halogen, C₁₋₄ alkyl, hydroxy, C₁₋₄ alkoxy or halo C₁₋₄ alkyl; and
r is zero or an integer from 1 to 4;
Z is O, CH₂— or a single bond;
n is an integer of from 1 to 4;
m is zero or an integer of from 1 to 4;
p is zero or an integer of from 1 to 3;
k is an integer from 1 to 3; and
t is zero or 1.

2. A compound of formula (Ia): 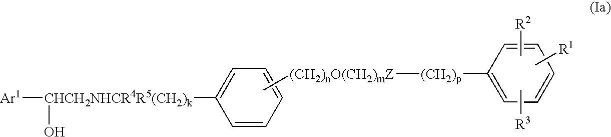
or a salt, solvate, or physiologically functional derivative thereof, wherein:
k is an integer from 1 to 3;
n is an integer of from 1 to 4;
m is an integer of from 2 to 4;
p is an integer of from 1 to 4;
Z is O or CH₂—;
R¹ is selected from hydrogen, C₁₋₆alkyl, hydroxy, cyano, nitro, halo, C₁₋₆haloalkyl, XCO₂R⁸, —XC(O)NR⁷R⁸, —XNR⁶C(O)R⁷, —XNR⁶C(O)NR⁷R⁸, —XNR⁶C(O)NC(O)NR⁷R⁸, —XNR⁶SO₂R⁷, —XSO₂NR⁹R¹⁰, XSR⁶, XSOR⁶, XSO₂R⁶, —XNR⁷R⁸, —XNR⁶C(O)OR⁷,
or R¹ is selected from -X-aryl, -X-hetaryl, or -X-(aryloxy), each optionally substituted by 1 or 2 groups independently selected from hydroxy, C₁₋₆alkoxy, halo, C₁₋₆alkyl, C₁₋₆haloalkyl, —NR⁶C(O)R⁷, SR⁶, SOR⁶, —SO₂R⁶, —SO₂NR⁹R¹⁰, —CO₂R⁸, —NR⁷R⁸, or hetaryl optionally substituted by 1 or 2 groups independently selected from hydroxy, C₁₋₆alkoxy, halo, C₁₋₆alkyl, or C₁₋₆haloalkyl;
X is —(CH₂)_{q}— or C₂₋₆ alkenylene;
q is an integer from 0 to 6;
R⁶ and R⁷ are independently selected from hydrogen, C₁₋₆alkyl, C₃₋₇cycloalkyl, aryl, hetaryl, hetaryl(C₁₋₆alkyl)- and aryl(C₁₋₆alkyl)- and R⁶ and R⁷ are each independently optionally substituted by 1 or 2 groups independently selected from halo, C₁₋₆alkyl, C₃₋₇ cycloalkyl, C₁₋₆ alkoxy, C₁₋₆haloalkyl, —NHC(O)(C₁₋₆alkyl), —SO₂(C₁₋₆alkyl), —SO₂(aryl), —CO₂H, and —CO₂(C₁₋₄alkyl), —NH₂, —NH(C₁₋₆alkyl), aryl(C₁₋₆alkyl)-, aryl(C₂₋₆alkenyl)-, aryl(C₂₋₆alkynyl)-, hetaryl(C₁₋₆alkyl)-, —NHSO₂aryl, —NH(hetarylC₁₋₆alkyl), —NHSO₂hetaryl, —NHSO₂(C₁₋₆alkyl), —NHC(O)aryl, or —NHC(O)hetaryl:
R⁸ is selected from hydrogen, C₁₋₆alkyl and C₃₋₇ cycloalkyl;
or R⁷ and R⁸, together with the nitrogen atom to which they are bonded, form a 5-, 6- or 7-membered nitrogen-containing ring;
R⁹ and R¹⁰ are independently selected from hydrogen, C₁₋₆alkyl, C₃₋₇cycloalkyl, aryl, hetaryl, hetaryl(C₁₋₆alkyl)- and aryl(C₁₋₆alkyl)-, or R⁹ and R¹⁰, together with the nitrogen to which they are bonded, form a 5-, 6-, or 7-membered nitrogen containing ring;
and R⁹ and R¹⁰ are each optionally substituted by one or two groups independently selected from halo, C₁₋₆alkyl, and C₃₋₇cycloalkyl, C₁₋₆haloalkyl;
R² is selected from hydrogen, hydroxy, C₁₋₆alkyl, C₁₋₆alkoxy, halo, aryl, aryl(C₁₋₆alkyl)-, C₁₋₆haloalkoxy, and C₁₋₆haloalkyl;
R³ is selected from hydrogen, hydroxy, C₁₋₆alkyl, C₁₋₆alkoxy, halo, aryl, aryl(C₁₋₆alkyl)-, C₁₋₆haloalkoxy, and C₁₋₆haloalkyl; and
R⁴ and R⁵ are independently selected from hydrogen and C₁₋₄ alkyl with the proviso that the total number of carbon atoms in R⁴ and R⁵ is not more than 4;
Ar¹ is a group selected from 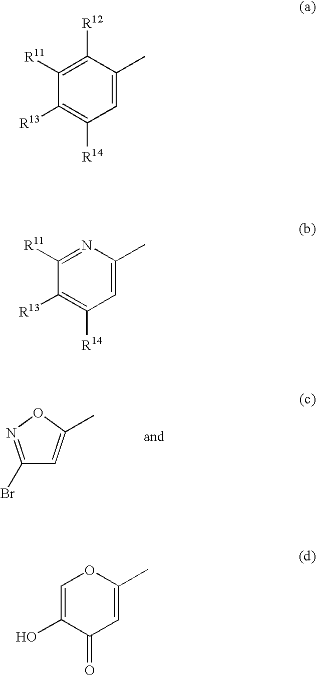
wherein R¹¹ represents halogen, —(CH₂)ᵣOR¹⁵, —NR¹⁵C(O)R¹⁶, —NR¹⁵SO₂R¹⁶, —SO₂NR¹⁵R¹⁶, —NR¹⁵R¹⁶, —OC(O)R¹⁷ or OC(O)NR¹⁵R¹⁶. and R¹² represents hydrogen, halogen or C₁₋₄ alkyl;
or R¹¹ represents —NHR¹⁸ and R¹² and —NHR¹⁸ together form a 5- or 6-membered heterocyclic ring;
R¹³ represents hydrogen, halogen, —OR¹⁵ or —NR¹⁵R¹⁶;
R¹⁴ represents hydrogen, halogen, haloC₁₋₄ alkyl, —OR¹⁵, —NR¹⁵R¹⁶, —OC(O)R¹⁷ or OC(O)NR¹⁵R¹⁶
R¹⁵ and R¹⁶ each independently represents hydrogen or C₁₋₄ alkyl, or in the groups —NR¹⁵R¹⁶, —SO₂NR¹⁵R¹⁶ and —OC(O)NR¹⁵R¹⁶, R¹⁵ and R¹⁶ independently represent hydrogen or C₁₋₄ alkyl or together with the nitrogen atom to which they are attached form a 5-, 6- or 7-membered nitrogen-containing ring,
R¹⁷ represents an aryl group which may be unsubstituted or substituted by one or more substituents selected from halogen, C₁₋₄ alkyl, hydroxy, C₁₋₄ alkoxy or halo C₁₋₄ alkyl; and
r is zero or an integer from 1 to 4.

3. A compound according to claim 1 wherein the group R¹ is selected from hydrogen, C₁₋₄alkyl, hydroxy, halo, —NR⁶C(O)NR⁷R⁸, —NR⁶C(O)R⁷, —SO₂NR⁹R¹⁰, —SOR⁶, —SO₂R⁶, and —NR⁶SO₂R⁷ wherein R⁶ and R⁷ are as defined in claim 1 or claim 2.

4. A compound according to claim 1 wherein R² and R³ are independently selected from hydrogen, hydroxyl, halogen, haloC₁₋₆alkyl, C₁₋₆alkyl, C₁₋₆alkoxy and haloC₁₋₆alkoxy.

5. A compound according to claim 1 wherein R⁴ and R⁵ each represent hydrogen.

6. A compound according to claim 1 wherein R^{a} and R^{b} each represent hydrogen.

7. A compound according to claim 1 wherein the group Ar¹ is selected from groups (a) and (b).

8. A compound according to claim 7 wherein the group (a) is a group of formula (i):

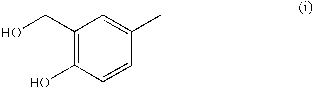

9. A compound according to claim 1 selected from the group consisting of:
4-((1R)-2-{[2-(3-{[2-(Benzyloxy)ethoxy]methyl}phenyl)ethyl]amino}-1-hydroxyethyl)-2-(hydroxymethyl)phenol;
4-{(1R)-2-[(2-{3-[(Benzyloxy)methyl]phenyl}ethyl)amino]-1-hydroxyethyl}-2-(hydroxymethyl)phenol;
2-(Hydroxymethyl)-4-{(1R)-1-hydroxy-2-[(2-{3-[(3-phenylpropoxy)methyl]phenyl}ethyl)amino]ethyl}phenol;
2-(Hydroxymethyl)-4-{(1R)-1-hydroxy-2-[(2-{3-[(4-phenylbutoxy)methyl]phenyl}ethyl)amino]ethyl}phenol;
4-((1R)-2-{[2-(3-{[3-(Benzyloxy)propoxy]methyl}phenyl)ethyl]amino}-1-hydroxyethyl)-2-(hydroxymethyl)phenol;
4-((1R)-2-{[2-(4-{[2-(Benzyloxy)ethoxy]methyl}phenyl)ethyl]amino}-1-hydroxyethyl)-2-(hydroxymethyl)phenol;
2-(Hydroxymethyl)-4-{(1R)-1-hydroxy-2-[(2-{3-[(2-phenylethoxy)methyl]phenyl}ethyl)amino]ethyl}phenol;
4-((1R)-2-{[2-(3-{[(2,6-Dichlorobenzyl)oxy]methyl}phenyl)ethyl]amino}-1-hydroxyethyl)-2-(hydroxymethyl)phenol;
4-((1R)-1-Hydroxy-2-{[2-(3-{[2-(2-methoxyphenyl)ethoxy]methyl}phenyl)ethyl]amino}ethyl)-2-(hydroxymethyl)phenol;
4-((1R)-1-Hydroxy-2-{[2-(3-{[2-(3-methoxyphenyl)ethoxy]methyl}phenyl)ethyl]amino}ethyl)-2-(hydroxymethyl)phenol;
4-((1R)-1-Hydroxy-2-{[2-(3-{[2-(4-methoxyphenyl)ethoxy]methyl}phenyl)ethyl]amino}ethyl)-2-(hydroxymethyl)phenol;
3-[4-({3-[2-({(2R)-2-Hydroxy-2-[4-hydroxy-3-(hydroxymethyl)phenyl]ethyl}amino)ethyl]benzyl}oxy)butyl]benzenesulfonamide;
3-{[2-({3-[2-({(2R)-2-hydroxy-2-[4-hydroxy-3-(hydroxymethyl)phenyl]ethyl}amino)ethyl]benzyl}oxy)ethoxy]methyl}benzonitrile;
4-[(1R)-2-({2-[3-({2-[(2,6-dichlorobenzyl)oxy]ethoxy}methyl)phenyl]ethyl}amino)-1-hydroxyethyl]-2-(hydroxymethyl)phenol;
4-[(1R)-2-({2-[3-({2-[(3-fluorobenzyl)oxy]ethoxy}methyl)phenyl]ethyl}amino)-1-hydroxyethyl]-2-(hydroxymethyl)phenol;
4-[(1R)-2-({2-[3-({2-[(3,5-dimethylbenzyl)oxy]ethoxy}methyl)phenyl]ethyl}amino)-1-hydroxyethyl]-2-(hydroxymethyl)phenol;
4-[(1R)-1-hydroxy-2-({2-[3-({2-[(3-methoxybenzyl)oxy]ethoxy}methyl)phenyl]ethyl}amino)ethyl]-2-(hydroxymethyl)phenol;
2-(hydroxymethyl)-4-{(1R)-1-hydroxy-2-[(2-{3-[(2-{[3-(trifluoromethoxy)benzyl]oxy}ethoxy)methyl]phenyl}ethyl)amino]ethyl}phenol;
4-((1R)-1-hydroxy-2-{[2-(3-{[4-(3-hydroxyphenyl)butoxy]methyl}phenyl)ethyl]amino}ethyl)-2-(hydroxymethyl)phenol;
4-[3-({3-[2-({(2R)-2-hydroxy-2-[4-hydroxy-3-(hydroxymethyl)phenyl]ethyl}amino)ethyl]benzyl}oxy)propyl]benzonitrile;
4-[4-({3-[2-({(2R)-2-hydroxy-2-[4-hydroxy-3-(hydroxymethyl)phenyl]ethyl}amino)ethyl]benzyl}oxy)butyl]benzonitrile;
3-[3-({3-[2-({(2R)-2-hydroxy-2-[4-hydroxy-3-(hydroxymethyl)phenyl]ethyl}amino)ethyl]benzyl}oxy)propyl]benzonitrile;
2-(hydroxymethyl)-4-[(1R)-1-hydroxy-2-({2-[3-({3-[4-(methylsulfonyl)phenyl]propoxy}methyl)phenyl]ethyl}amino)ethyl]phenol;
2-(hydroxymethyl)-4-[(1R)-1-hydroxy-2-({2-[3-({[4-(methylsulfonyl)benzyl]oxy}methyl)phenyl]ethyl}amino)ethyl]phenol;
4-((1R)-1-hydroxy-2-{[2-(3-{[2-(2-hydroxyphenyl)ethoxy]methyl}phenyl)ethyl]amino}ethyl)-2-(hydroxymethyl)phenol;
4-((1R)-1-hydroxy-2-{[2-(3-{[(4-hydroxybenzyl)oxy]methyl}phenyl)ethyl]amino}ethyl)-2-(hydroxymethyl)phenol;
4-((1R)-1-hydroxy-2-{[2-(3-{[3-(3-hydroxyphenyl)propoxy]methyl}phenyl)ethyl]amino}ethyl)-2-(hydroxymethyl)phenol;
4-[(1R)-2-({2-[3-({4-[4-(cyclopentylsulfonyl)phenyl]butoxy}methyl)phenyl]ethyl}amino)-1-hydroxyethyl]-2-(hydroxymethyl)phenol;
4-[(1R)-2-({2-[3-({3-[4-(cyclopentylsulfonyl)phenyl]propoxy}methyl)phenyl]ethyl}amino)-1-hydroxyethyl]-2-(hydroxymethyl)phenol;
4-[(1R)-2-({2-[3-({3-[3-(cyclopentylsulfonyl)phenyl]propoxy}methyl)phenyl]ethyl}amino)-1-hydroxyethyl]-2-(hydroxymethyl)phenol;
4-[(1R)-1-hydroxy-2-({2-[3-({2-[(3-hydroxybenzyl)oxy]ethoxy}methyl)phenyl]ethyl}amino)ethyl]-2-(hydroxymethyl)phenol;
4-{(1R)-2-[(2-{3-[(2-{[3-(cyclopentylsulfonyl)benzyl]oxy}ethoxy)methyl]phenyl}ethyl)amino]-1-hydroxyethyl}-2-(hydroxymethyl)phenol;
4-{(1R)-2-[(2-{3-[(2-{[3-(cyclopentylsulfinyl)benzyl]oxy}ethoxy)methyl]phenyl}ethyl)amino]-1-hydroxyethyl}-2-(hydroxymethyl)phenol;
4-[(1R)-2-({2-[3-({[3-(cyclopentylsulfonyl)benzyl]oxy}methyl)phenyl]ethyl}amino)-1-hydroxyethyl]-2-(hydroxymethyl)phenol;
4-[(1R)-2-({2-[3-({4-[3-(cyclopentylsulfinyl)phenyl]butoxy}methyl)phenyl]ethyl}amino)-1-hydroxyethyl]-2-(hydroxymethyl)phenol;
3-[4-({3-[2-({(2R)-2-hydroxy-2-[4-hydroxy-3-(hydroxymethyl)phenyl]ethyl}amino)ethyl]benzyl}oxy)butyl]benzonitrile;
2-(hydroxymethyl)-4-{(1R)-1-hydroxy-2-[(2-{3-[(2-phenoxyethoxy)methyl]phenyl}ethyl)amino]ethyl}phenol;
4-((1R)-2-{[2-(3-{[2-(3-fluorophenyl)ethoxy]methyl}phenyl)ethyl]amino}-1-hydroxyethyl)-2-(hydroxymethyl)phenol;
4-((1R)-2-{[2-(3-{[2-(4-fluorophenyl)ethoxy]methyl}phenyl)ethyl]amino}-1-hydroxyethyl)-2-(hydroxymethyl)phenol;
4-((1R)-2-{[2-(3-{[2-(2-fluorophenyl)ethoxy]methyl}phenyl)ethyl]amino}-1-hydroxyethyl)-2-(hydroxymethyl)phenol;
3-[({3-[2-({(2R)-2-hydroxy-2-[4-hydroxy-3-(hydroxymethyl)phenyl]ethyl}amino)ethyl]benzyl}oxy)methyl]benzonitrle;
4-[({3-[2-({(2R)-2-hydroxy-2-[4-hydroxy-3-(hydroxymethyl)phenyl]ethyl}amino)ethyl]benzyl}oxy)methyl]benzonitrile;
2-(hydroxymethyl)-4-[(1R)-1-hydroxy-2-({2-[3-({[(1R)-1-phenylethyl]oxy}methyl)phenyl]ethyl}amino)ethyl]phenol;
2-(hydroxymethyl)-4-[(1R)-1-hydroxy-2-({2-[3-({[(1S)-1-phenylethyl]oxy}methyl)phenyl]ethyl}amino)ethyl]phenol;
4-((1R)-2-{[2-(3-{[(3,5-dimethylbenzyl)oxy]methyl}phenyl)ethyl]amino}-1-hydroxyethyl)-2-(hydroxymethyl)phenol;
4-((1R)-2-{[2-(3-{[(2,6-dichlorobenzyl)oxy]methyl}phenyl)ethyl]amino}-1-hydroxyethyl)-2-(hydroxymethyl)phenol;
4-((1R)-2-{[2-(3-{[(2-fluorobenzyl)oxy]methyl}phenyl)ethyl]amino}-1-hydroxyethyl)-2-(hydroxymethyl)phenol;
4-((1R)-2-{[2-(3-{[(3-fluorobenzyl)oxy]methyl}phenyl)ethyl]amino}-1-hydroxyethyl)-2-(hydroxymethyl)phenol;
4-((1R)-2-{[2-(3-{[(4-fluorobenzyl)oxy]methyl}phenyl)ethyl]amino}-1-hydroxyethyl)-2-(hydroxymethyl)phenol;
3-[4-({3-[2-({(2R)-2-Hydroxy-2-[4-hydroxy-3-(hydroxymethyl)phenyl]ethyl}amino)ethyl]benzyl}oxy)butyl]benzamide;
3-{[2-({3-[2-({(2R)-2-hydroxy-2-[4-hydroxy-3-(hydroxymethyl)phenyl]ethyl}amino)ethyl]benzyl}oxy)ethoxy]methyl}benzamide;
3-[({3-[2-({(2R)-2-hydroxy-2-[4-hydroxy-3-(hydroxymethyl)phenyl]ethyl}amino)ethyl]benzyl}oxy)methyl]benzamide;
4-[({3-[2-({(2R)-2-hydroxy-2-[4-hydroxy-3-(hydroxymethyl)phenyl]ethyl}amino)ethyl]benzyl}oxy)methyl]benzamide;
3-[2-({3-[2-({(2R)-2-hydroxy-2-[4-hydroxy-3-(hydroxymethyl)phenyl]ethyl}amino)ethyl]benzyl}oxy)ethyl]benzenesulfonamide;
3-[3-({3-[2-({(2R)-2-hydroxy-2-[4-hydroxy-3-(hydroxymethyl)phenyl]ethyl}amino)ethyl]benzyl}oxy)propyl]benzenesulfonamide;
4-((1R)-2-{[2-(3-{[4-(2,6-dichlorophenyl)butoxy]methyl}phenyl)ethyl]amino}-1-hydroxyethyl)-2-(hydroxymethyl)phenol;
N-{3-[4-({3-[2-({(2R)-2-hydroxy-2-[4-hydroxy-3-(hydroxymethyl)phenyl]ethyl}amino)ethyl]benzyl}oxy)butyl]phenyl}urea;
2-(hydroxymethyl)-4-((1R)-1-hydroxy-2-{[2-(3-{[2-(1-phenylethoxy)ethoxy]methyl}phenyl)ethyl]amino}ethyl)phenol;
4-[(1R)-2-({2-[3-({2-[3-(cyclopentylsulfonyl)phenyl]ethoxy}methyl)phenyl]ethyl}amino)-1-hydroxyethyl]-2-(hydroxymethyl)phenol;
4-[(1R)-2-({2-[3-({4-[3-(cyclopentylsulfonyl)phenyl]butoxy}methyl)phenyl]ethyl}amino)-1-hydroxyethyl]-2-(hydroxymethyl)phenol;
2-(hydroxymethyl)-4-[(1R)-1-hydroxy-2-({2-[3-({4-[3-(methylsulfonyl)phenyl]butoxy}methyl)phenyl]ethyl}amino)ethyl]phenol;
4-((1R)-2-{[2-(3-{[3-(2,6-dichlorophenyl) propoxy]methyl}phenyl)ethyl]amino}-1-hydroxyethyl)-2-(hydroxymethyl)phenol;
3-[({3-[2-({(2R)-2-Hydroxy-2-[4-hydroxy-3-(hydroxymethyl)phenyl]ethyl}amino)ethyl]benzyl}oxy)methyl]benzenesulfonamide, salts thereof, solvates thereof, and physiologically functional derivatives thereof.

10. A method for the prophylaxis or treatment of a clinical condition in a mammal for which a selective β₂-adrenoreceptor agonist is indicated, which comprises administering a therapeutically effective amount of a compound of formula (I) according to claim 1, or a pharmaceutically acceptable salt, solvate, or physiologically functional derivative thereof.

11-12. (canceled)

13. A pharmaceutical formulation comprising a compound of formula (I), according to claim 1, or a pharmaceutically acceptable salt, solvate, or physiologically functional derivative thereof, and a pharmaceutically acceptable carrier or excipient, and optionally one or more other therapeutic ingredients.

14. (canceled)

15. A process for the preparation of a compound of formula (I), according to claim 1, or a salt, solvate, or physiologically functional derivative thereof, which comprises
deprotecting a protected intermediate of formula (II): 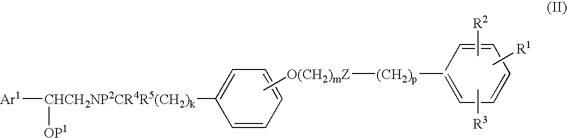
or a salt or solvate thereof, wherein R¹, R², R³, R⁴, R⁵, Z, k, m, n and p are as defined for the compound of formula (I), and P¹ and P² each independently represents hydrogen or a protecting group provided that the compound of formula (II) contains at least one protecting group 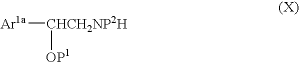 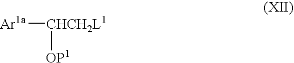 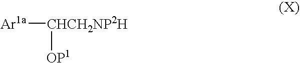 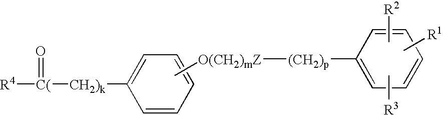
wherein said deprotecting step is optionally followed by one or more of the following steps in any order selected from the group consisting of:
(i) removing any protecting groups;
(ii) separating an enantiomer from a mixture of enantiomers; and
(iii) converting the product to a corresponding salt, solvate,
or physiologically functional derivative thereof.

16. A process for the preparation of a compound of formula (I), according to claim 1, or a salt, solvate, or physiologically functional derivative thereof, which comprises
alkylating an amine of formula (X) 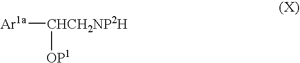
wherein Ar^{1a} is Ar¹ or a protected form thereof, and P² and P¹ are each independently either hydrogen or a protecting group,
with a compound of formula (XI): 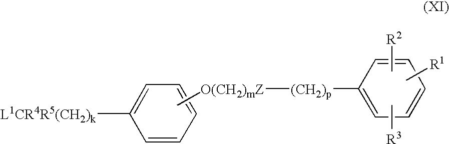
wherein R¹, R², R³, R⁴, R⁵, Z, k, m, n and p are as defined for the compound of formula (I) and L¹ is a leaving group;
wherein said alkylating step is optionally followed by one or more of the following steps in any order selected from the group consisting of:
(i) removing any protecting groups;
(ii) separating an enantiomer from a mixture of enantiomers; and
(iii) converting the product to a corresponding salt, solvate, or physiologically functional derivative thereof.

17. A process for the preparation of a compound of formula (I), according to claim 1, or a salt, solvate, or physiologically functional derivative thereof, which comprises
reacting a compound of formula (XII): 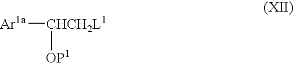
wherein Ar^{1a} is Ar¹ or a protected form thereof, P¹ is either hydrogen or a protecting group and L¹ is a leaving group, with an amine of formula (XIII): 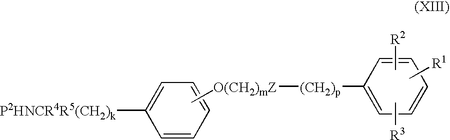
wherein P² is either hydrogen or a protecting group
wherein said reacting step is optionally followed by one or more of the following steps in any order selected from the group consisting of:
(i) removing any protecting groups;
(ii) separating an enantiomer from a mixture of enantiomers; and
(iii) converting the product to a corresponding salt, solvate, or physiologically functional derivative thereof.

18. A process for the preparation of a compound of formula (I), according to claim 1, or a salt, solvate, or physiologically functional derivative thereof, which comprises
reacting a compound of formula (X): 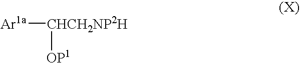
wherein Ar^{1a} is Ar¹ or a protected form thereof, and P¹ and P² are each independently either hydrogen or a protecting group,
with a compound of formula (XIV): 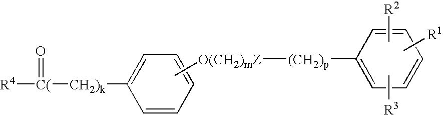
under conditions suitable to effect reductive amination;
wherein said reacting step is optionally followed by one or more of the following steps in any order selected from the group consisting of:
(i) removing any protecting groups;
(ii) separating an enantiomer from a mixture of enantiomers; and
(iii) converting the product to a corresponding salt, solvate, or physiologically functional derivative thereof.

19. The method according to claim 10, wherein the mammal is a human.

20. The method according to claim 10, wherein the clinical condition is asthma.

21. The method according to claim 10, wherein the clinical condition is COPD.
